(19) United States
(12) Patent Application Publication
(10) Pub. No.: US 2024/0297408 A1
(43) Pub. Date: Sep. 5, 2024

(54) Safer Batteries and Separators for Batteries; Solutions on Li-Ion Edv/Ess Battery Safety; Solutions on Anode/Electrolyte/Cathode Reduction and/or Oxidation Issues; and, Improved Batteries, Anodes, and/or Separators

(71) Applicant: Celgard, LLC, Charlotte, NC (US)

(72) Inventor: Zhengming Zhang, Rock Hill, SC (US)

(21) Appl. No.: 17/263,849

(22) PCT Filed: Aug. 13, 2020
(86) PCT No.: PCT/US2020/046167

§ 371 Date: Jan. 27, 2021

Related U.S. Application Data
(60) Provisional application No. 62/887,001, filed on Aug. 15, 2019.
(60) Provisional application No. 62/942,376, filed on Dec. 2, 2019.

(51) Int. Cl. H01M 50/434; H01M 50/383

(52) U.S. Cl. CPC H01M 50/434; H01M 50/383

(57) ABSTRACT

Equipment or methods are provided for addressing the failure mode that thermal runaway cell emits flammable smoke, igniting the flammable smoke causes an EDV fire and providing new or proprietary solutions, components, materials or chemicals, to achieve the following: non-flammable smoke can be generated during cell thermal runaway resulting in smoke only, cell reaction strength is reduced by dropping Tmax for the reaction, and/or thermal-propagation can be prevented, whereby many EDV and ESS fires may be prevented and safe EDVs and ESSs may be possible. Novel or improved batteries, anodes, separators, solutions on li ion battery fires, and/or fire suppression systems, chemicals, etc.; in addition, exemplary embodiments disclosed herein are directed to novel or improved lithium ion batteries, cells, electrodes, separators, and/or similar batteries incorporating the same, and/or related methods of manufacturing and/or of using the same, and/or combinations thereof; improvements or solutions as shown and/or described herein.

Equipment or methods are provided for addressing the failure mode that
Thermal runaway cell emits flammable smoke
Igniting the flammable smoke causes an EDV fire
and providing new or proprietary solutions, components, materials or chemicals, to achieve the following: Non-flammable smoke can be generated during cell thermal runaway resulting in smoke only. Cell reaction strength is reduced by dropping Tmax for the reaction, and/or thermal-propagation can be prevented, whereby many EDV and ESS fires may be prevented and safe EDVs and ESSs may be possible.

### FIELD

The present disclosure relates to novel or improved LI-ION POROUS SYSTEM, SAFETY, NAIL ABUSE AND CERAMIC COATED SEPARATORS; DISCUSSIONS AND SOLUTIONS ON LI-ION EDV/ESS EXPLOSIONS AND FIRES; AND, ANODE/ELECTROLYTE/CATHODE, REDUCTION AND/OR OXIDATION ISSUES. In addition, exemplary embodiments disclosed herein are directed to novel or improved lithium ion batteries, cells, electrodes, separators, and/or similar batteries incorporating the same, and/or related methods of manufacturing and/or of using the same, and/or combinations thereof.

The present disclosure also relates to novel or improved BATTERIES, ANODES, SEPARATORS, SOLUTIONS ON LI-ION BATTERY FIRES, AND/OR FIRE SUPPRESSION SYSTEMS. In addition, exemplary embodiments disclosed herein are directed to novel or improved lithium ion batteries, cells, electrodes, separators, and/or similar batteries incorporating the same, and/or related methods of manufacturing and/or of using the same, and/or combinations thereof.

### DESCRIPTION

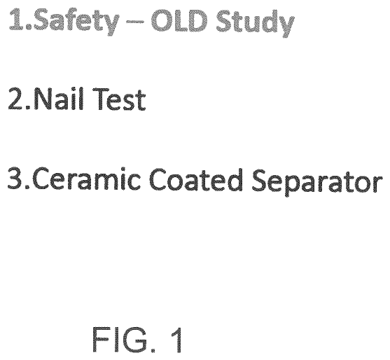

FIG. 1 schematically illustrates the topics covered in the ensuing figures.

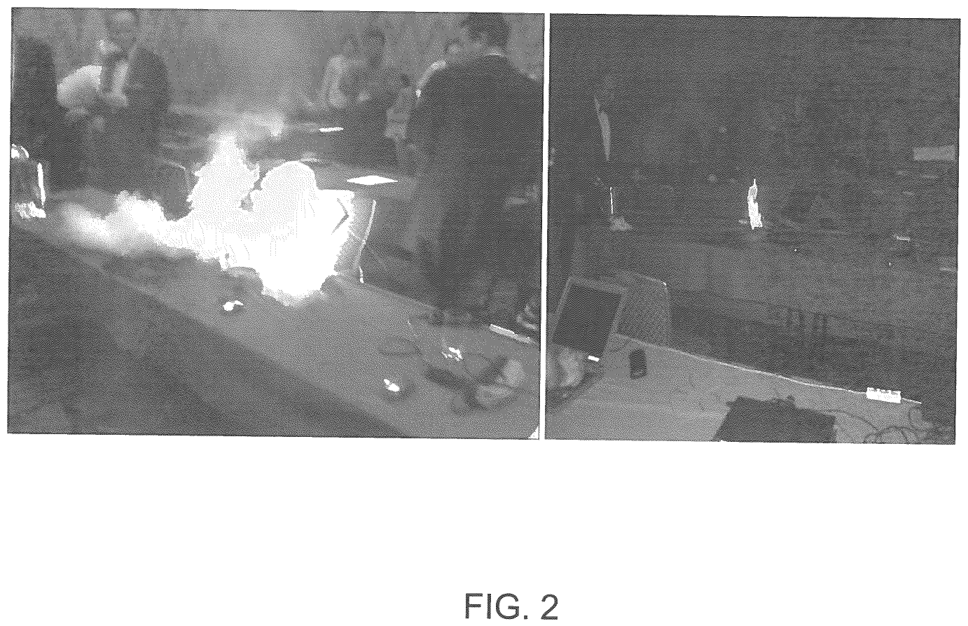

FIG. 2 are photos illustrating a laptop which exploded and caught on fire from a faulty Lithium ion battery at a conference.

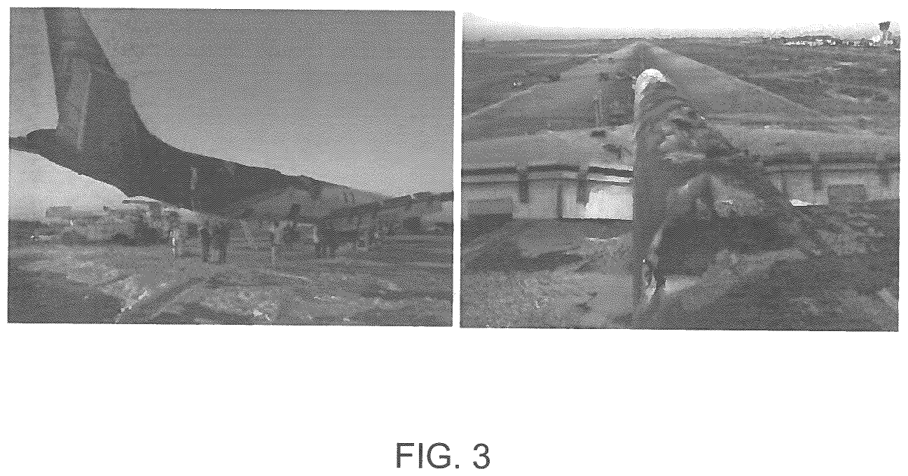

FIG. 3 are photos illustrating a UPS plane in Philadelphia which caught on fire wherein the fire may have been ignited by a faulty Lithium ion battery.

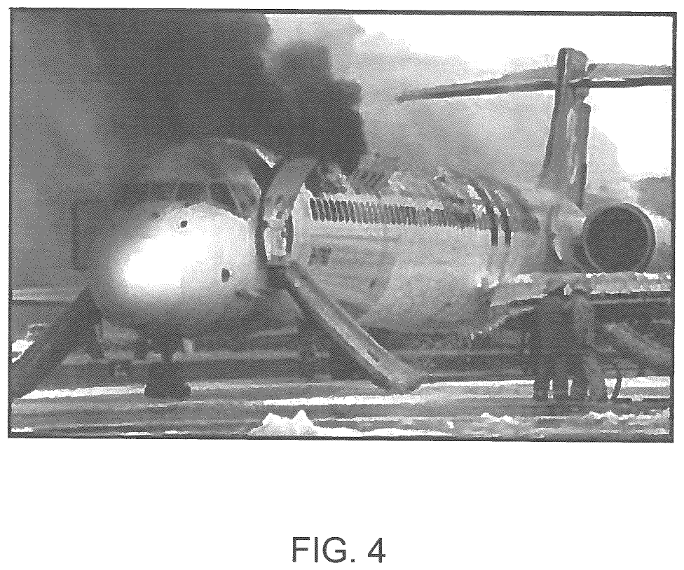

FIG. 4 is a photo of a plane on fire.

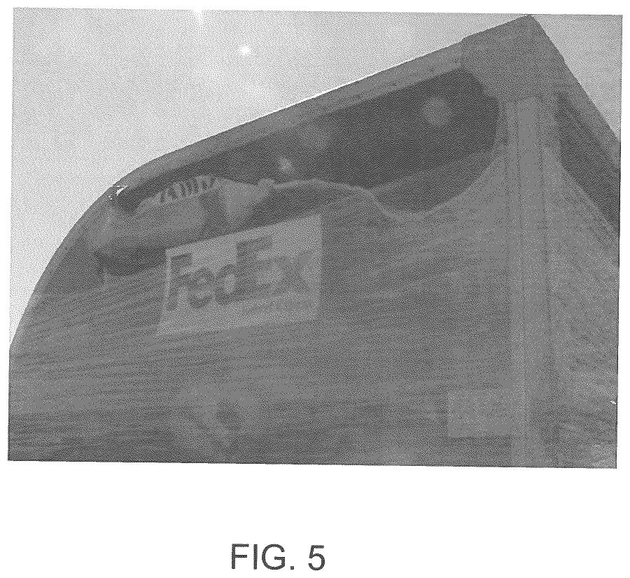

FIG. 5 is a photo of a damages unit load device (ULD) which may have been damages by a faulty Lithium ion battery.

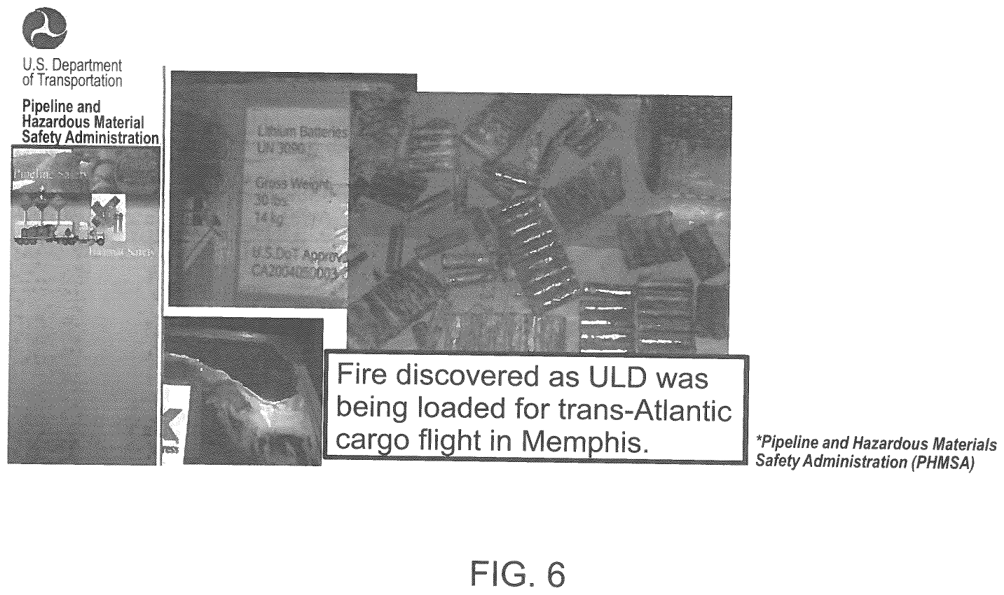

FIG. 6 is a photo illustrating damaged Lithium ion batteries in the ULD of FIG. 5, wherein a fire in the ULD which contained Lithium ion batteries was discovered as the ULD was being loaded for a trans-Atlantic cargo flight in Memphis, Tennessee, and wherein the shipper was a Pipeline and Hazardous Materials Safety Administration (PHMSA) approval holder.

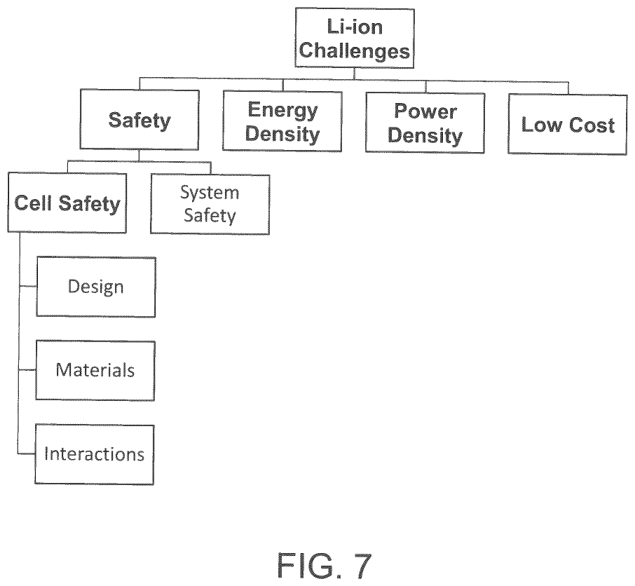

FIG. 7 is a chart partially illustrating Lithium ion battery challenges.

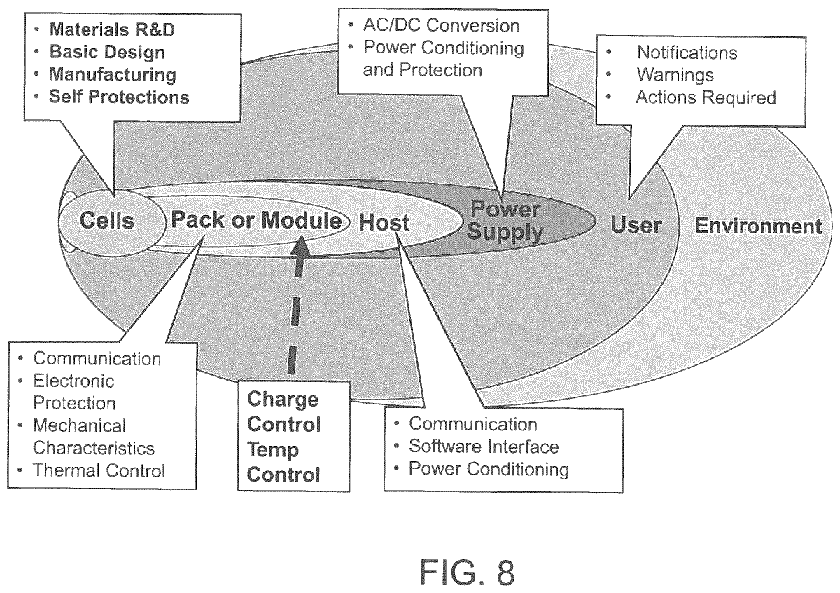

FIG. 8 is a graphic illustrating a system approach to Lithium-ion design and use (IEEE).

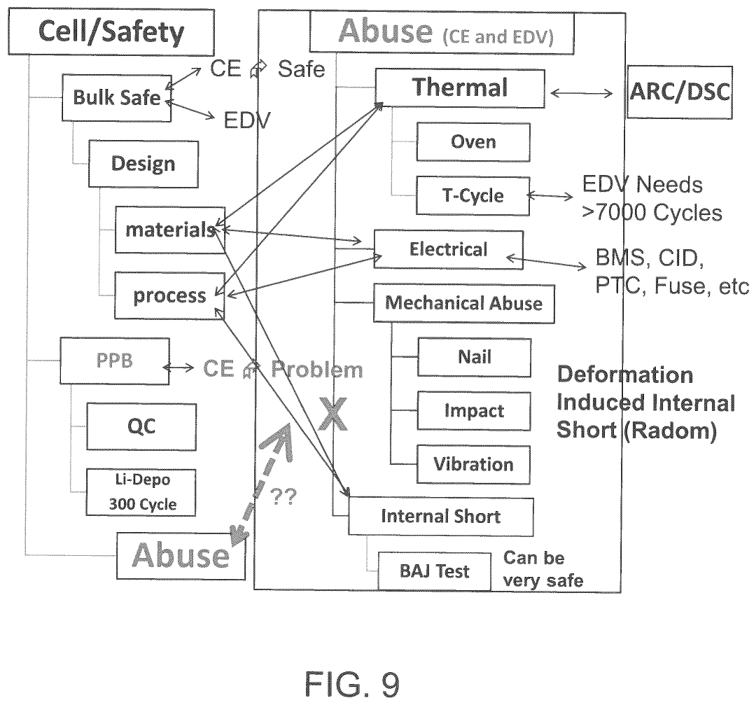

FIG. 9 is a flow chart illustrating the interplay between the Cell Safety prong of FIG. 7 with the types of abuse to which such batteries may be subjected.

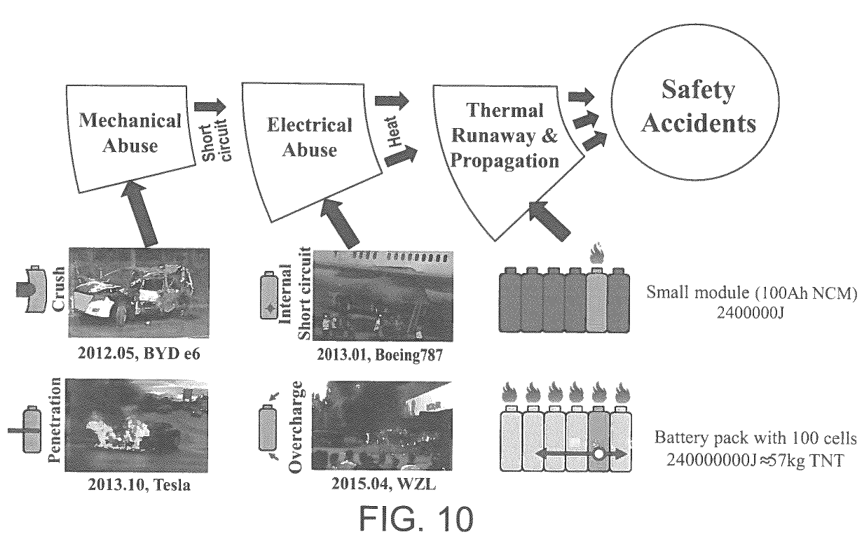

FIG. 10 is a graphic illustrating that the core problem of electric vehicle (EV) or electric drive vehicle (EDV) safety accidents involve battery thermal runaway.

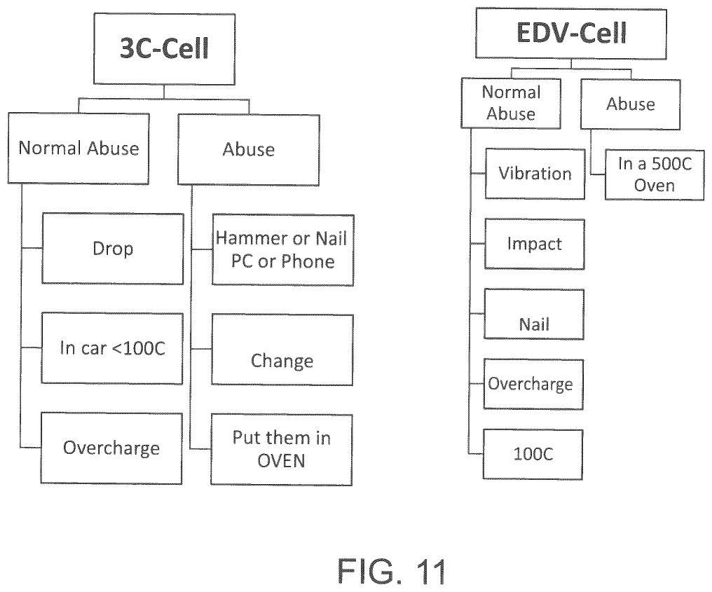

FIG. 11 is a graphic illustrating safety concerns for 3C Cell batteries and EDV batteries.

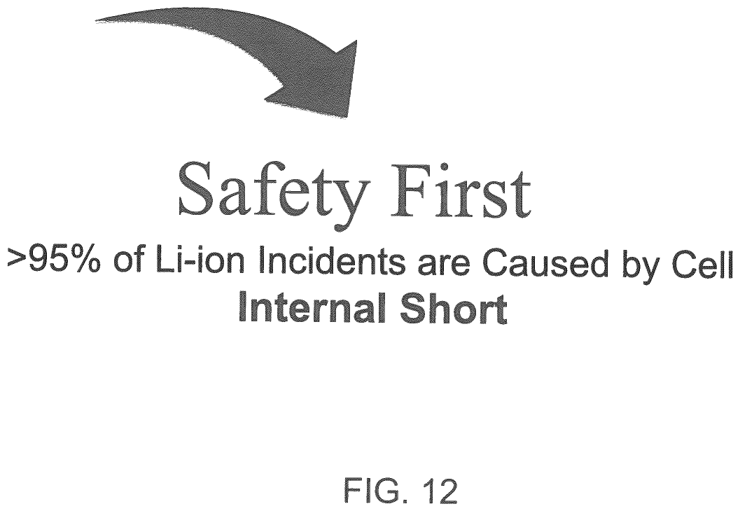

FIG. 12 schematically illustrates the predominant cause of Li-ion incidents.

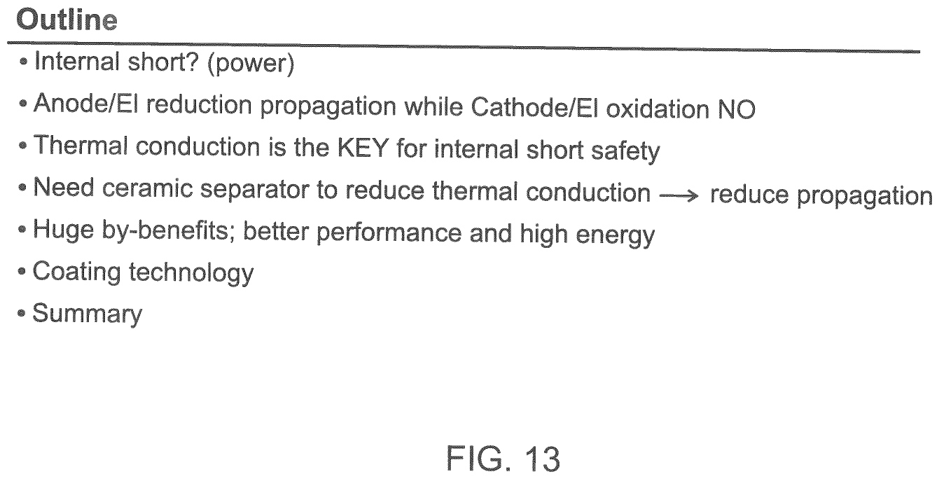

FIG. 13 schematically illustrates considerations in minimizing internal shorts.

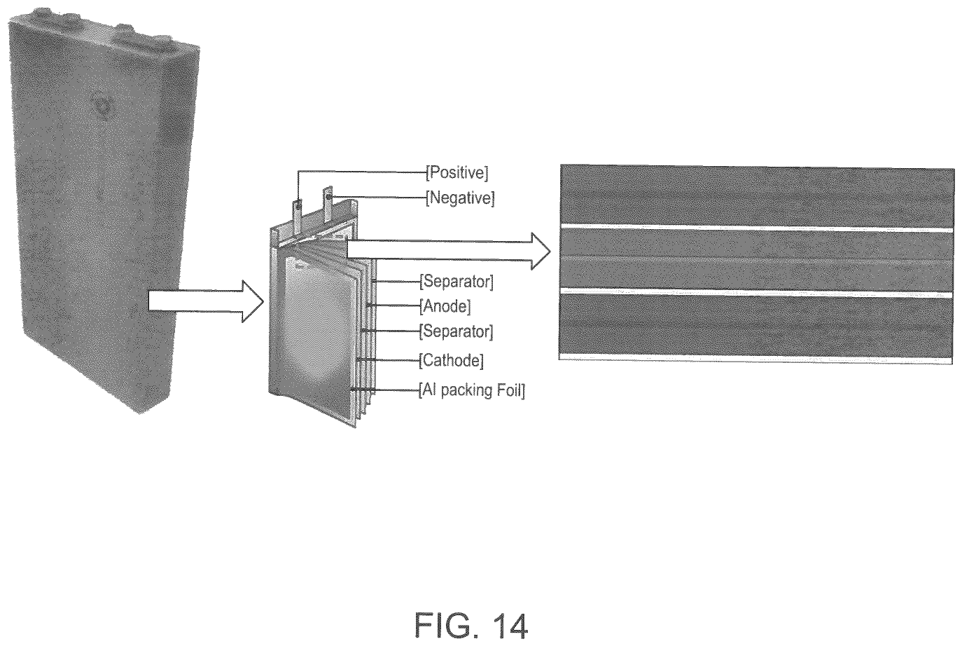

FIG. 14 is a graphic illustrating the internal structure of an EDV battery.

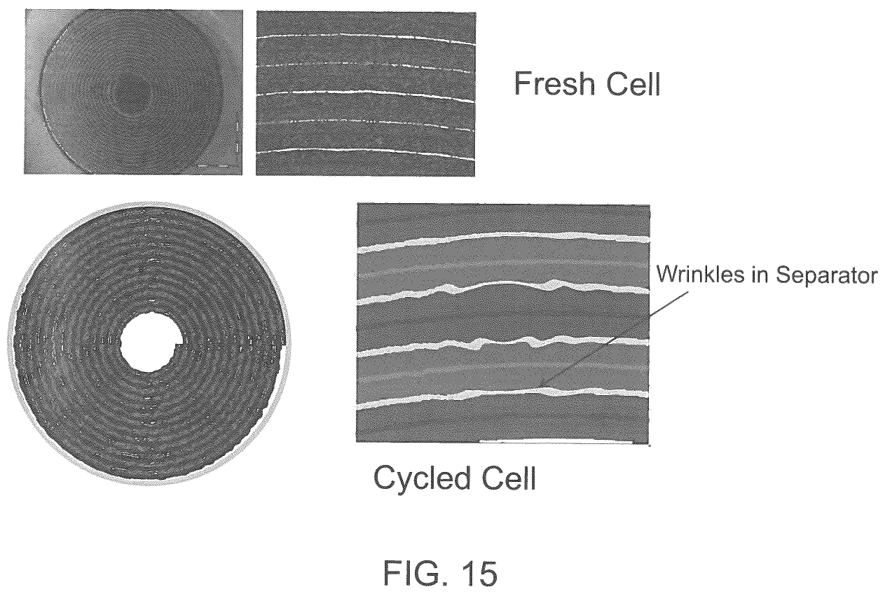

FIG. 15 is a graphic illustrating the internal structure of a new 3C battery and following cycling illustrating wrinkles in the battery separator.

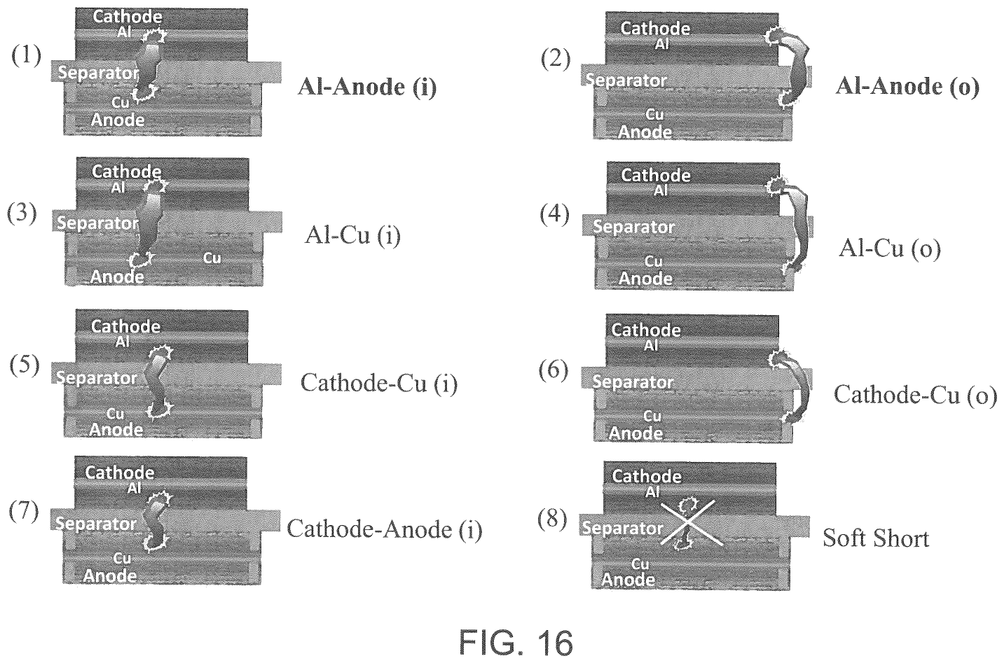

FIG. 16 is a graphic illustrating various cases of internal shorts in a lithium ion battery.

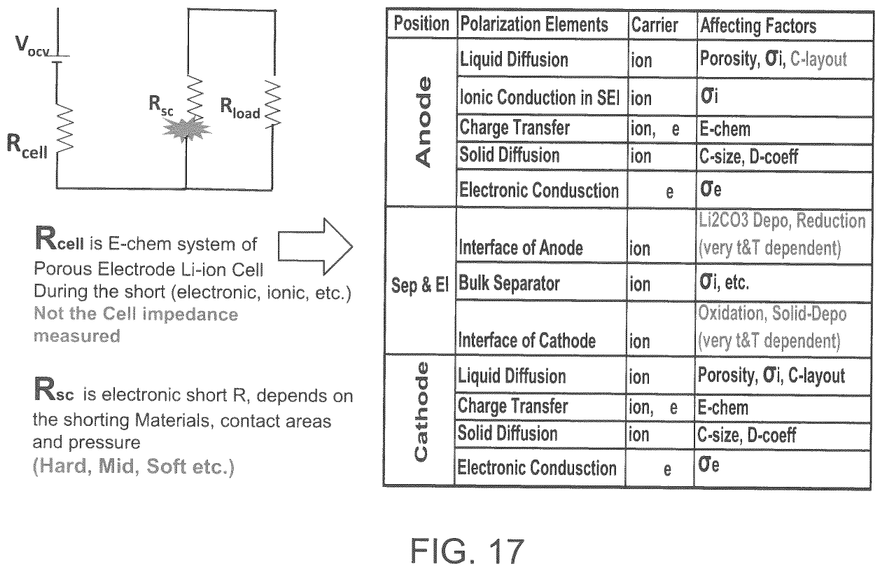

FIG. 17 is a graphic describing what an internal short in a lithium ion battery is and factors affecting internal shorts.

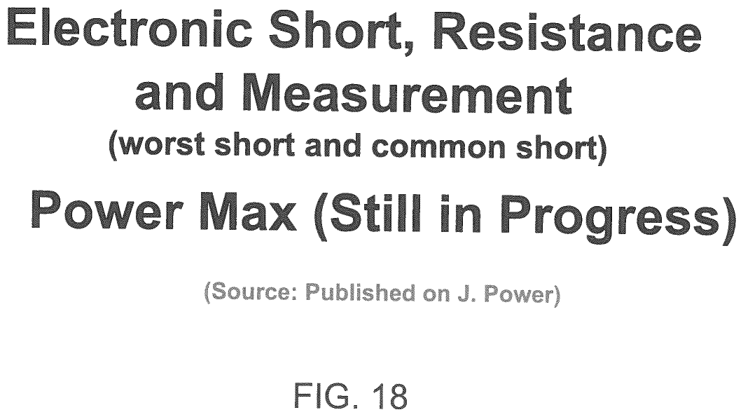

FIG. 18 schematically references certain Journal of Power publications.

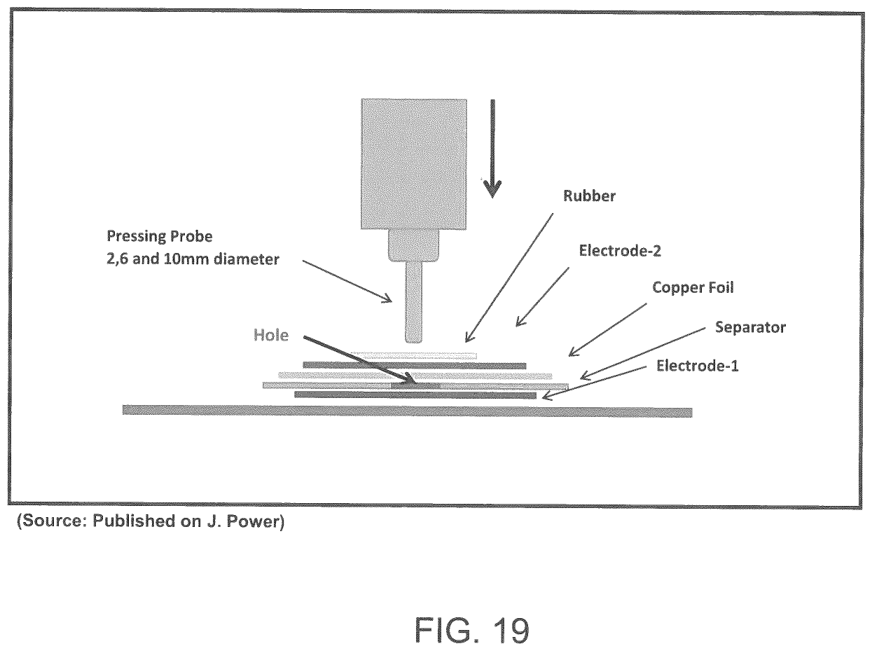

FIG. 19 is a graphic illustrating Rsc setup (Wet Charged Electrodes).

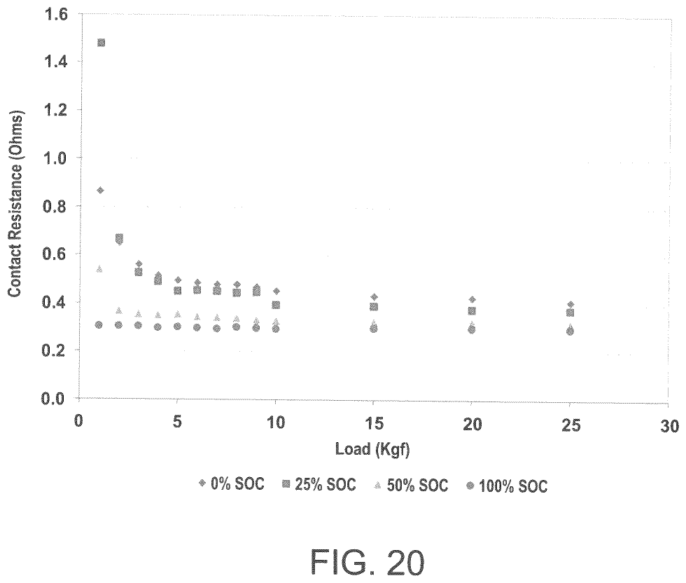

FIG. 20 is a graph of contact resistance versus load for an Anode-Cu (Al Rev to Li) battery at various states of charge (SOC).

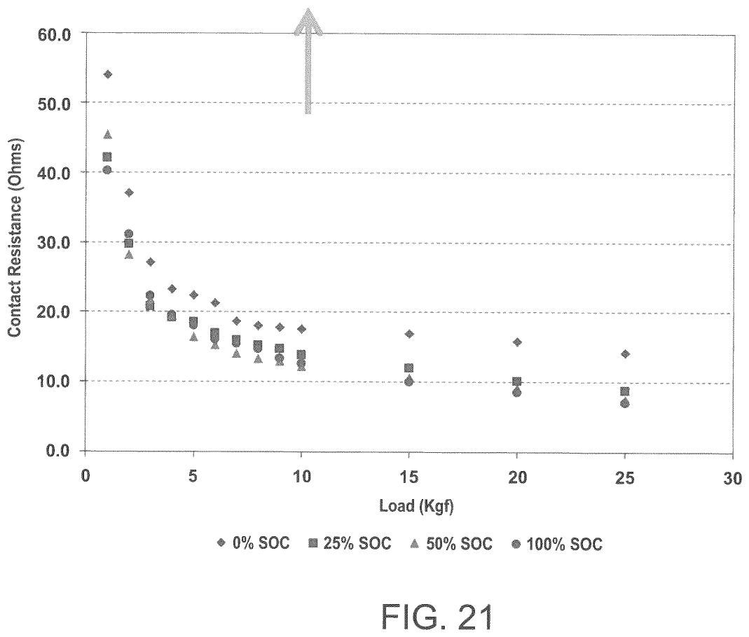

FIG. 21 is a graph of contact resistance versus load for an Anode-Cu-Cathode battery at various SOC.

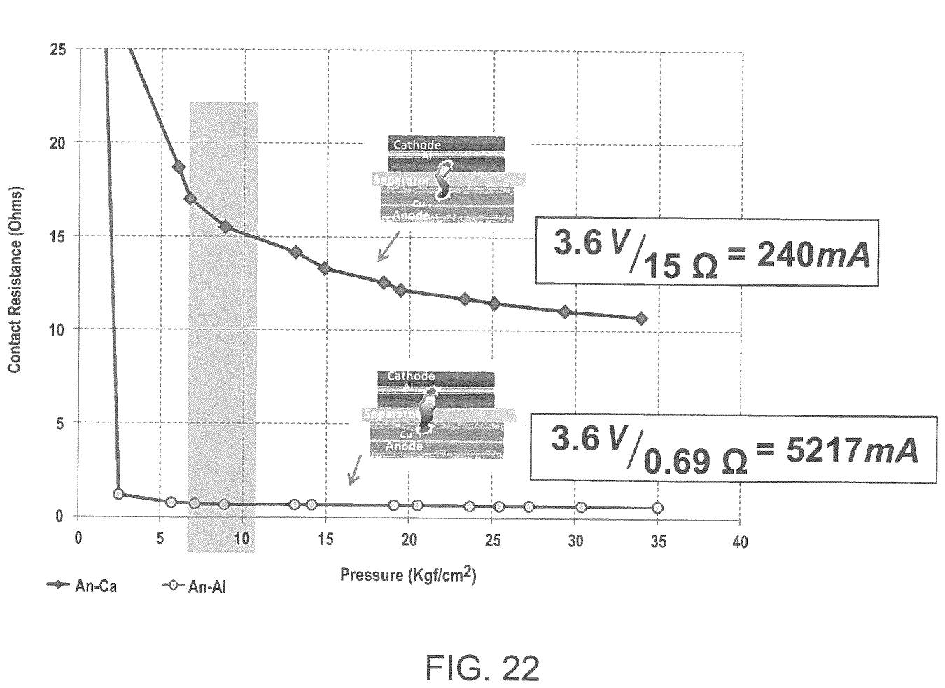

FIG. 22 is a graph of contact resistance versus pressure and possible short results for An-Ca and An-Al batteries.

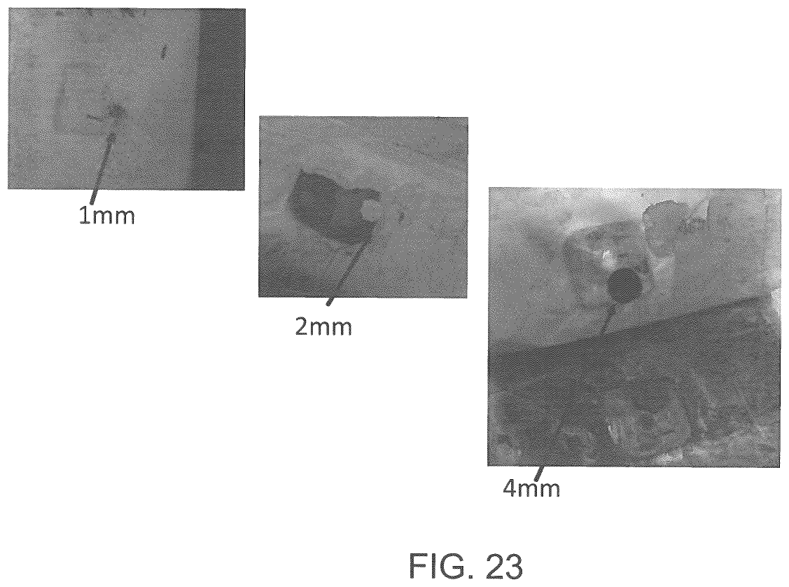

FIG. 23 are photos showing the growth of an Anode/Cathode Direct Short.

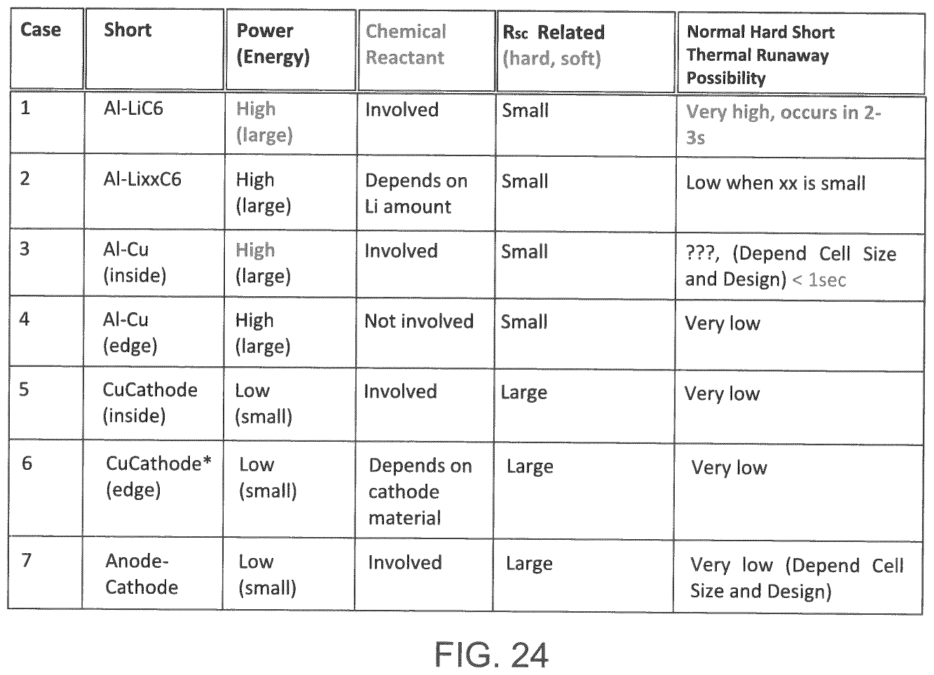

FIG. 24 is a table illustrating risk of a short for several different scenarios.

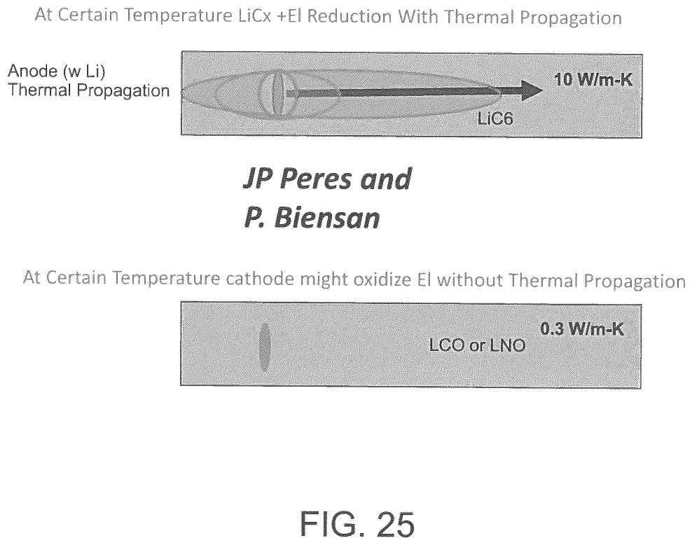

FIG. 25 is a graphic illustrating the use of laser induced point heat on electrodes to simulate an internal short (anode vs. cathode).

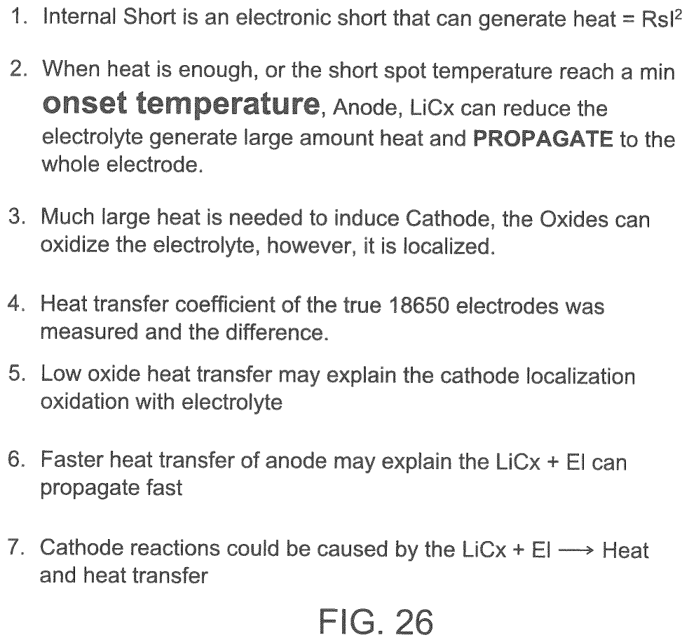

FIG. 26 schematically illustrates considerations of results from process illustrated in FIG. 25.

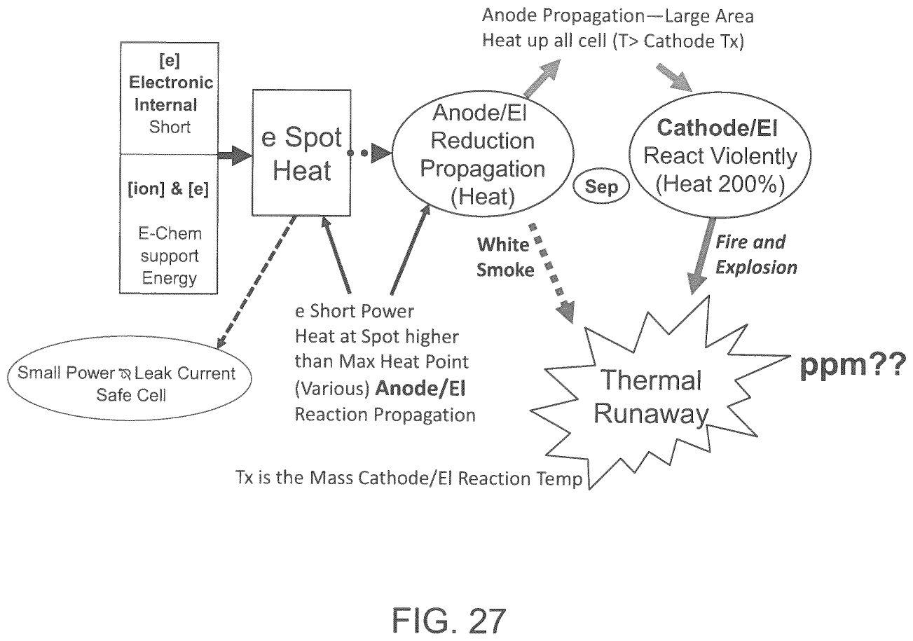

FIG. 27 is a graphic illustrating how an internal short can lead to thermal runaway.

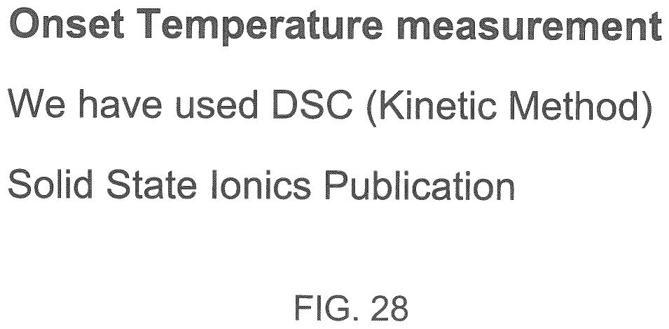

FIG. 28 schematically illustrates measurement options for onset temperature.

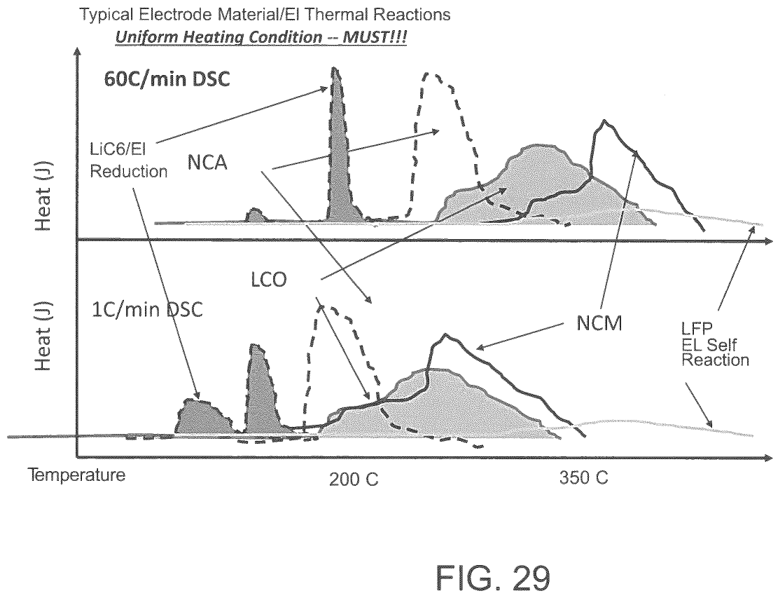

FIG. 29 illustrates Typical Electrode Material versus EI Thermal Reactions.

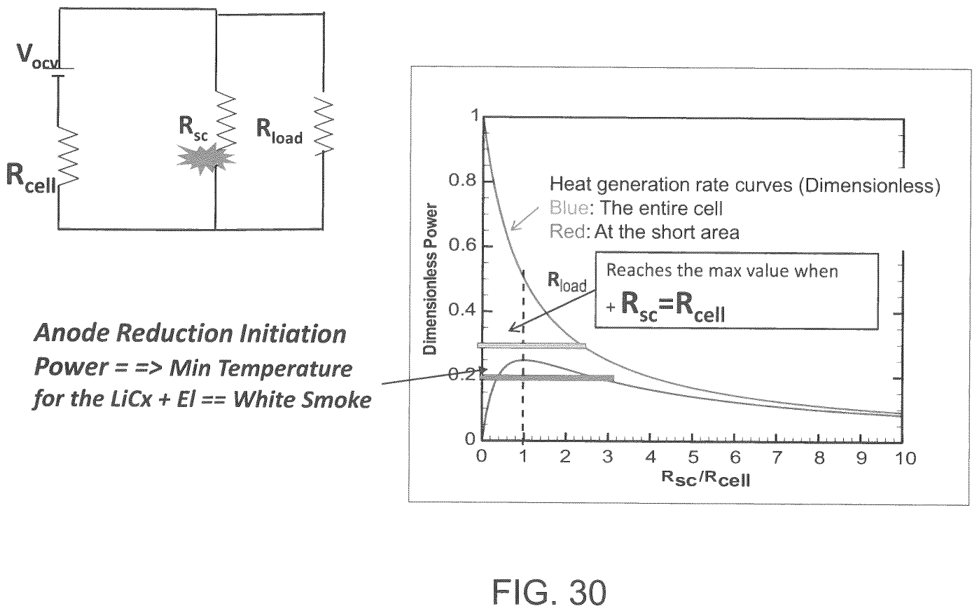

FIG. 30 illustrates heat generation at an internal short area or potential highest T at short spot.

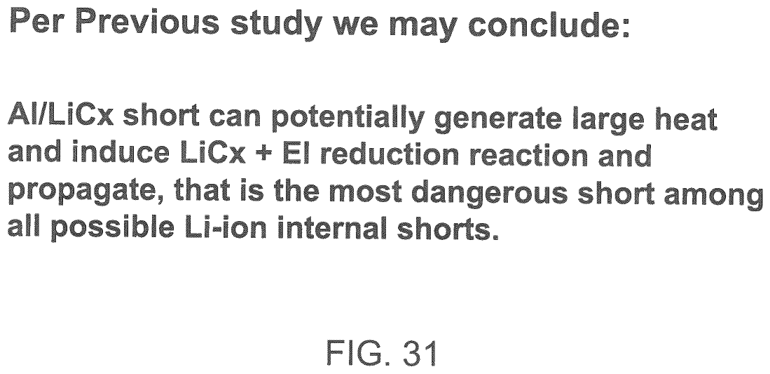

FIG. 31 schematically illustrates conclusions from previous studies.

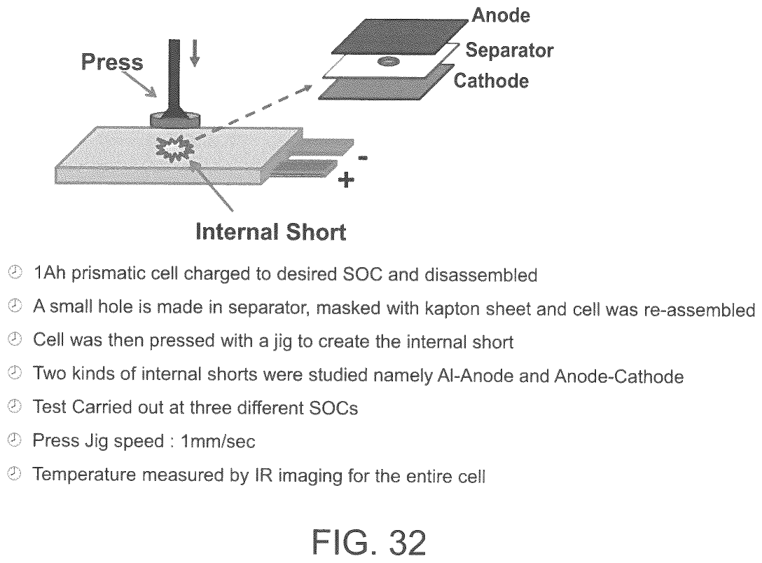

FIG. 32 illustrates a Controlled Internal Short test.

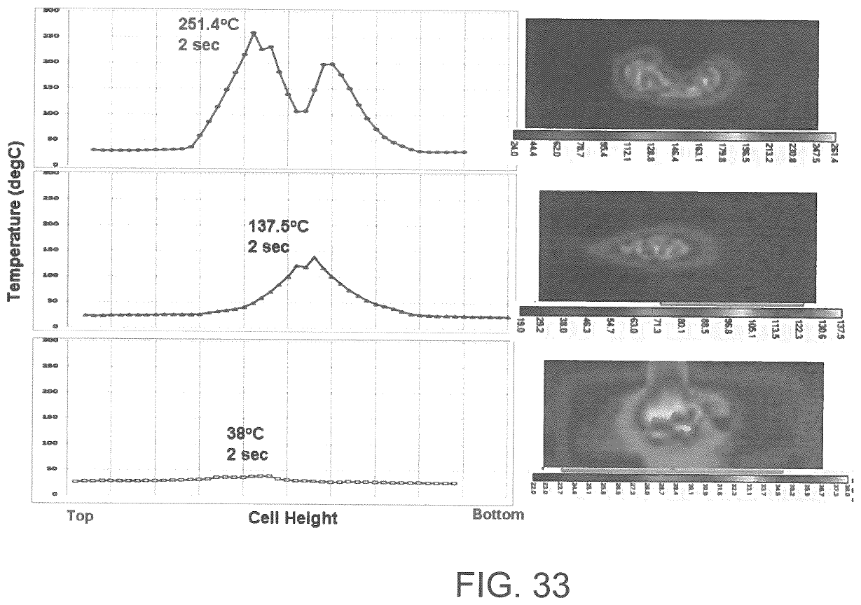

FIG. 33 illustrates thermal conduction across the cell (2 sec after internal short) by use of temperature versus cell height graphs.

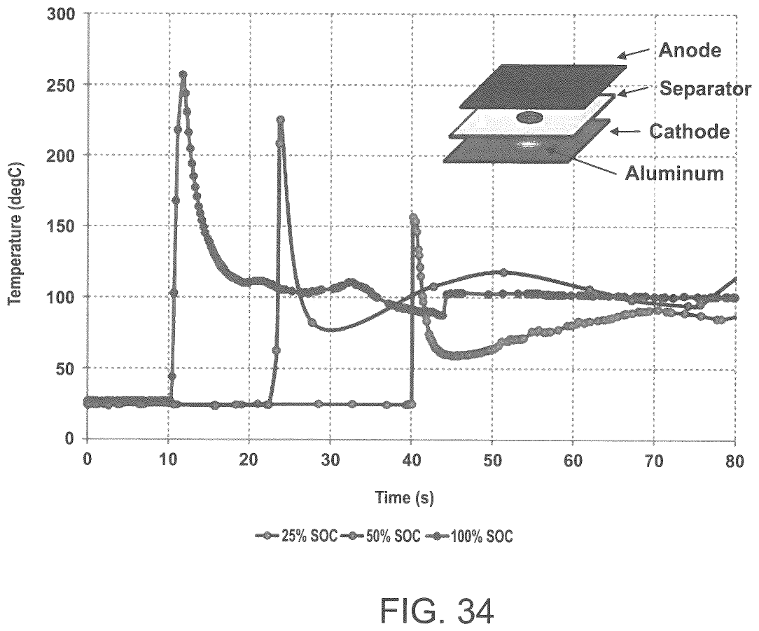

FIG. 34 is a graph of temperature versus time for an aluminum-anode battery short at different SOCs.

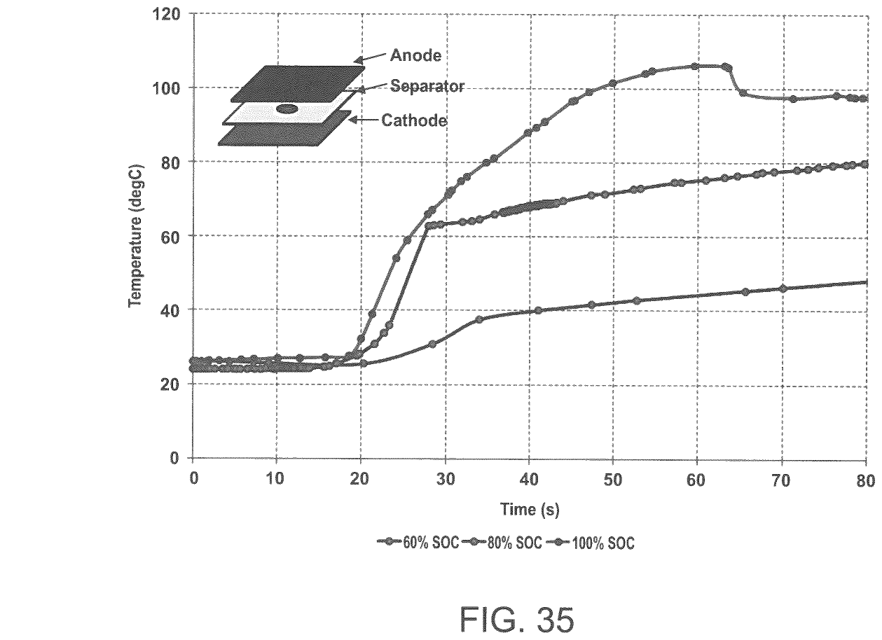

FIG. 35 is a graph of temperature versus time for an anode-cathode short at different SOCs.

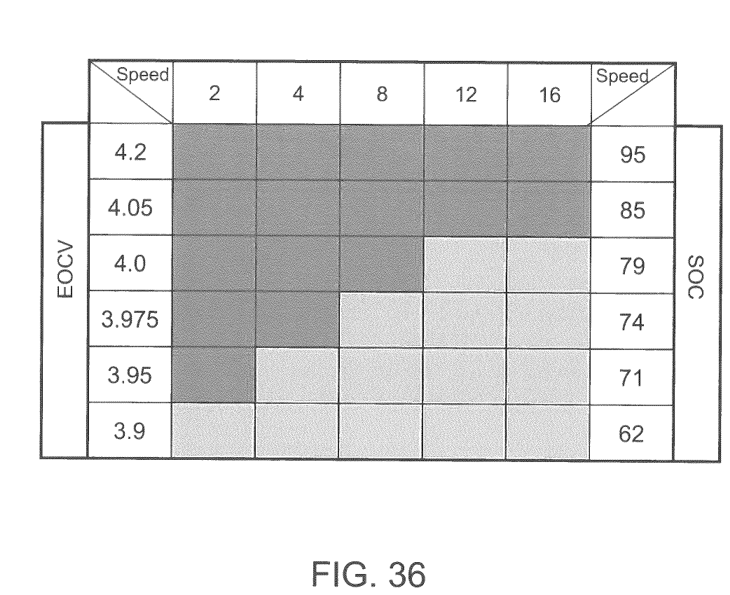

FIG. 36 is a graph illustrating 2.2Ah 18650 Cell Ball Test (EOCV, SOC vs Speed).

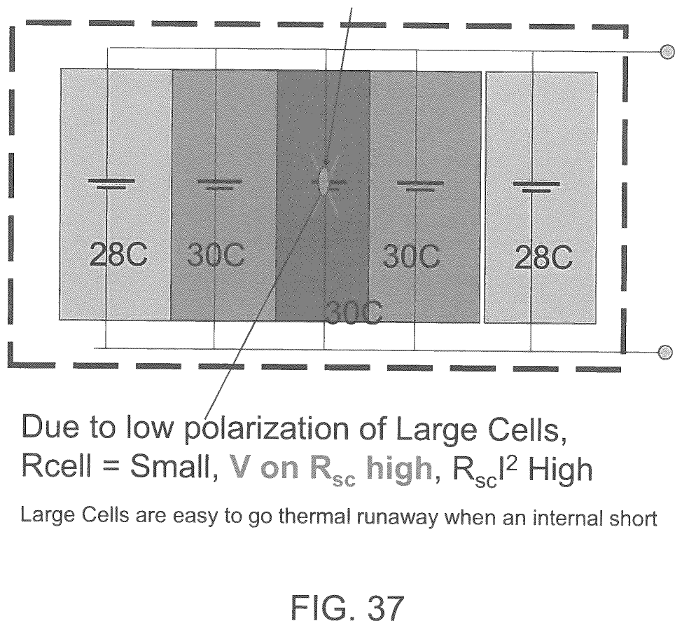

FIG. 37 is a graph illustrating internal e-Hard-SHORTED Large Cells.

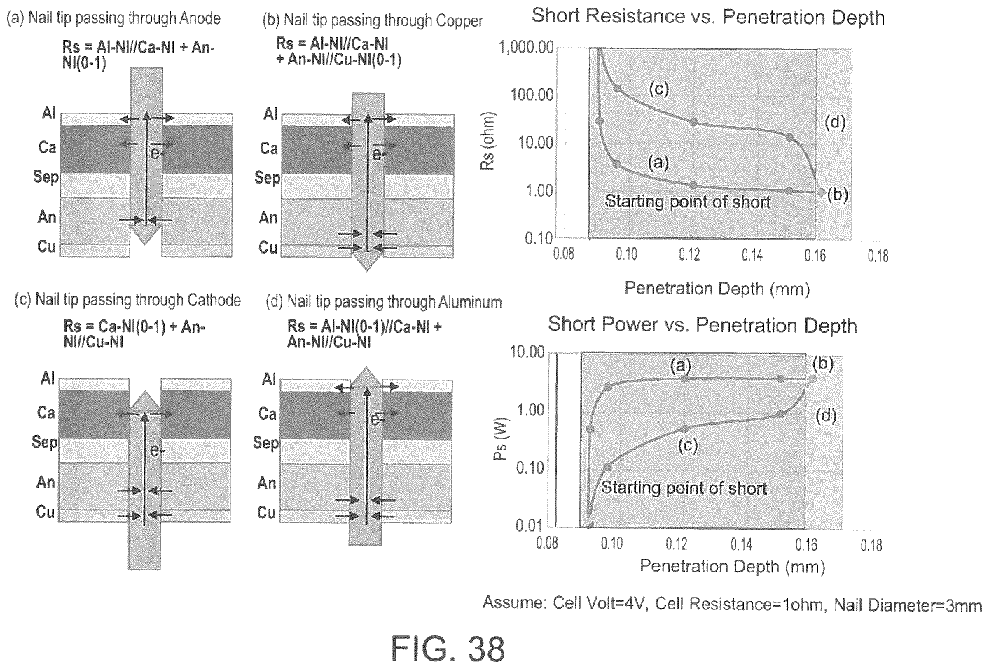

FIG. 38 is a graphic illustrating four basic modes of nail penetration.

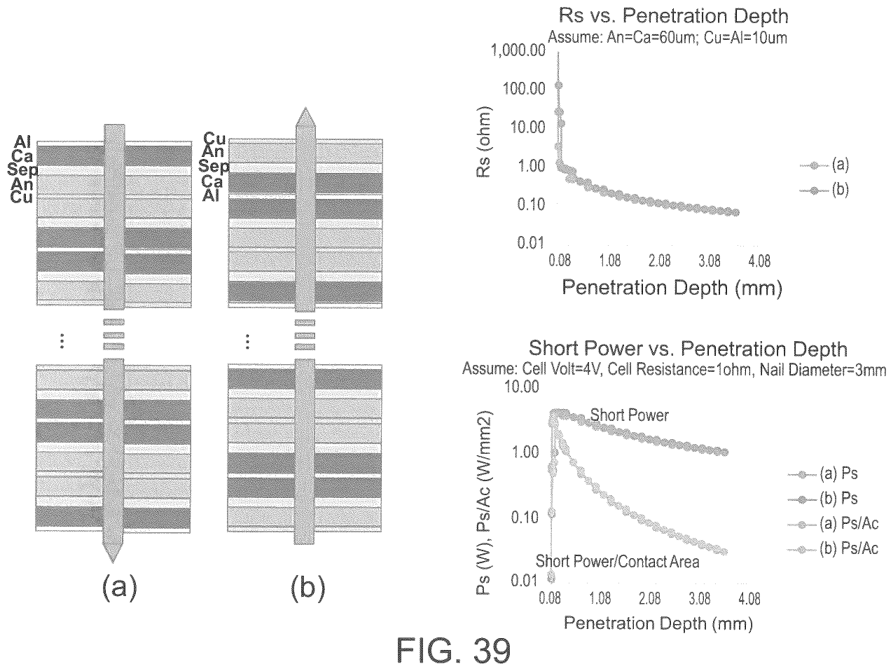

FIG. 39 is a graphic illustrating effects of nail penetration depth.

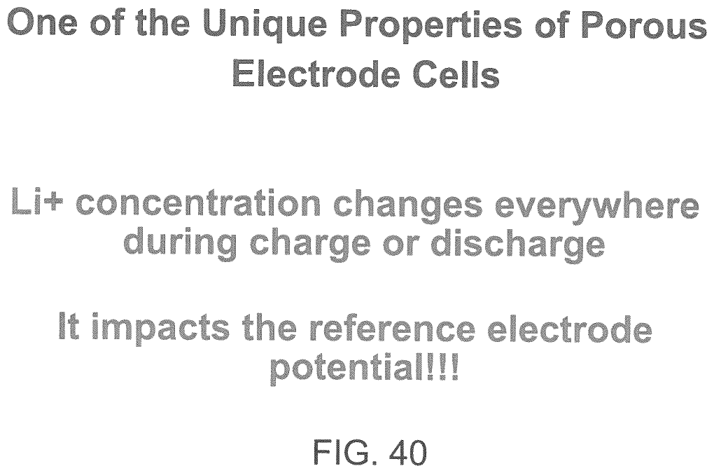

FIG. 40 discuss a unique property of porous electrode cells.

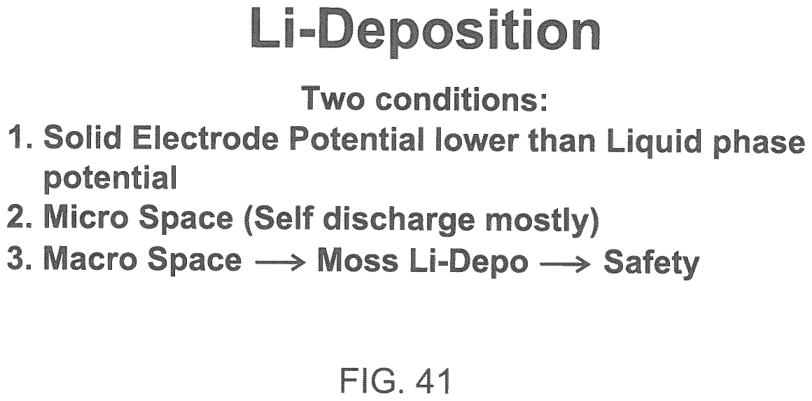

FIG. 41 discusses conditions of Li deposition.

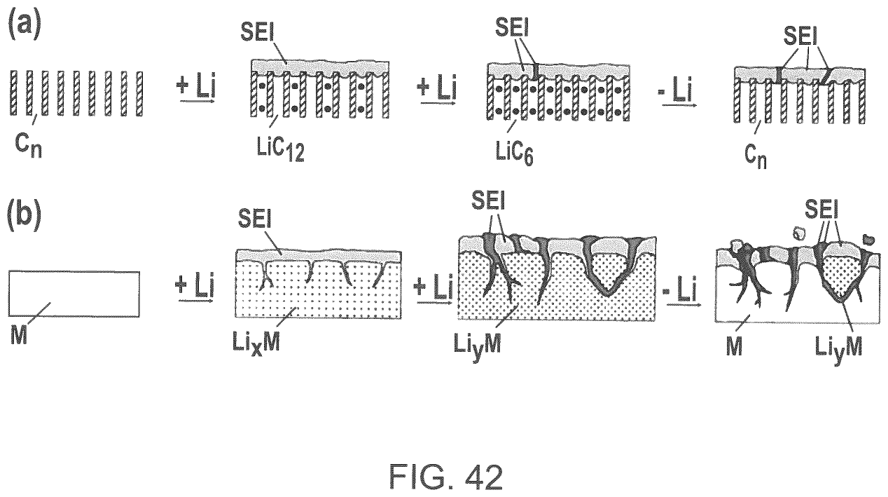

FIG. 42 is a graphic illustrating effects of lithium deposition.

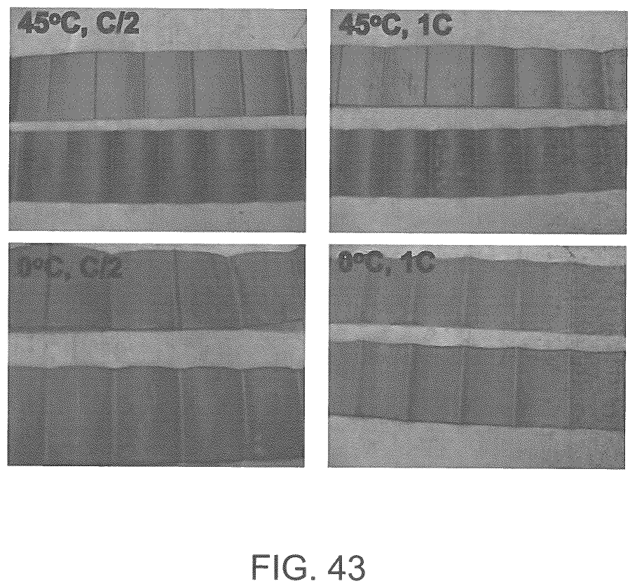

FIG. 43 are photos illustrating the effect of charge rate (cycling) and temperature on battery separators.

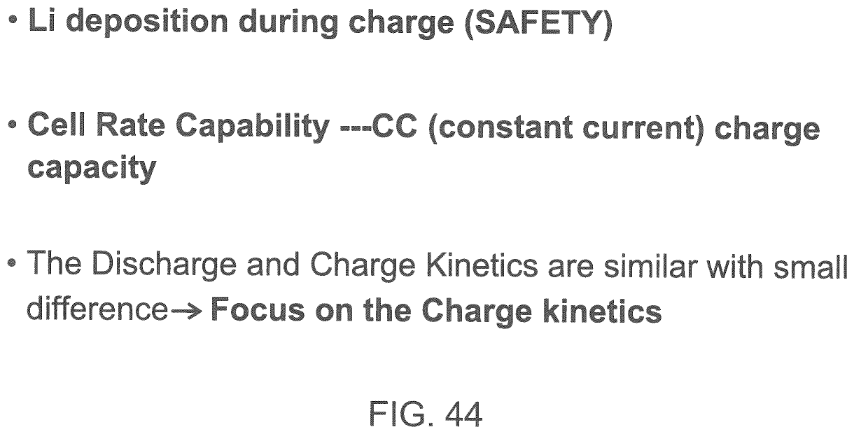

FIG. 44 discusses cell rate capability.

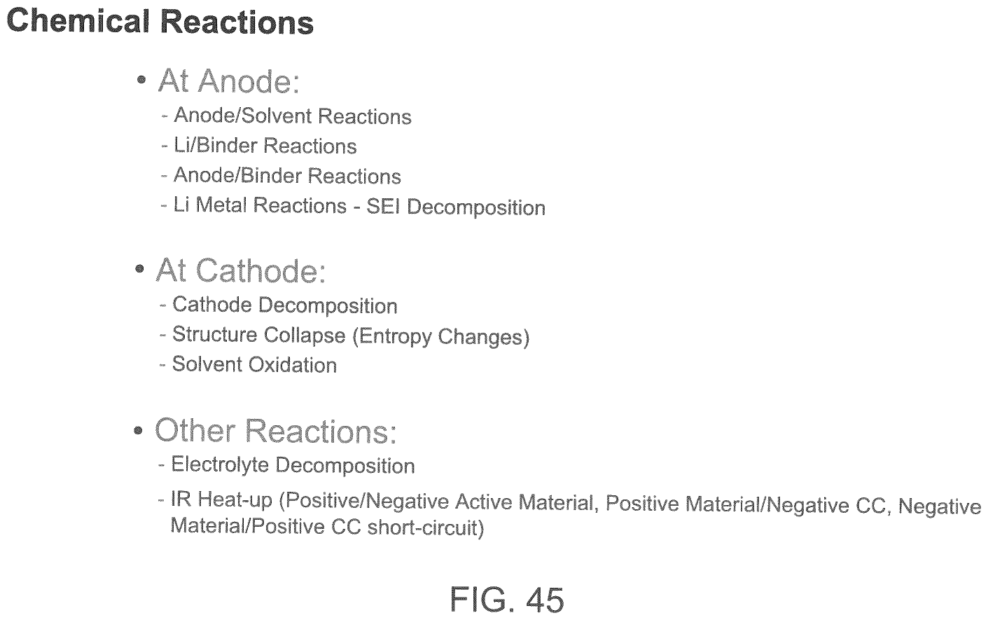

FIG. 45 discusses chemical reactions in a cell.

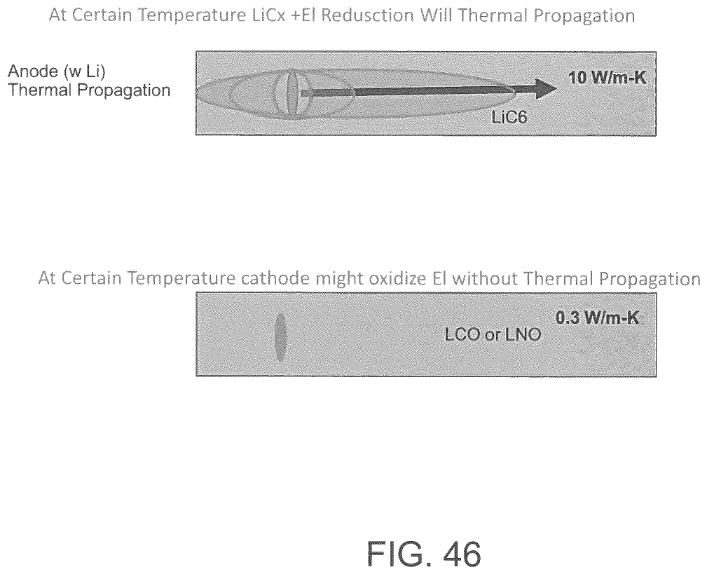

FIG. 46 is a graphic illustrating laser induced point heat on electrodes to simulate internal short (anode vs. cathode).

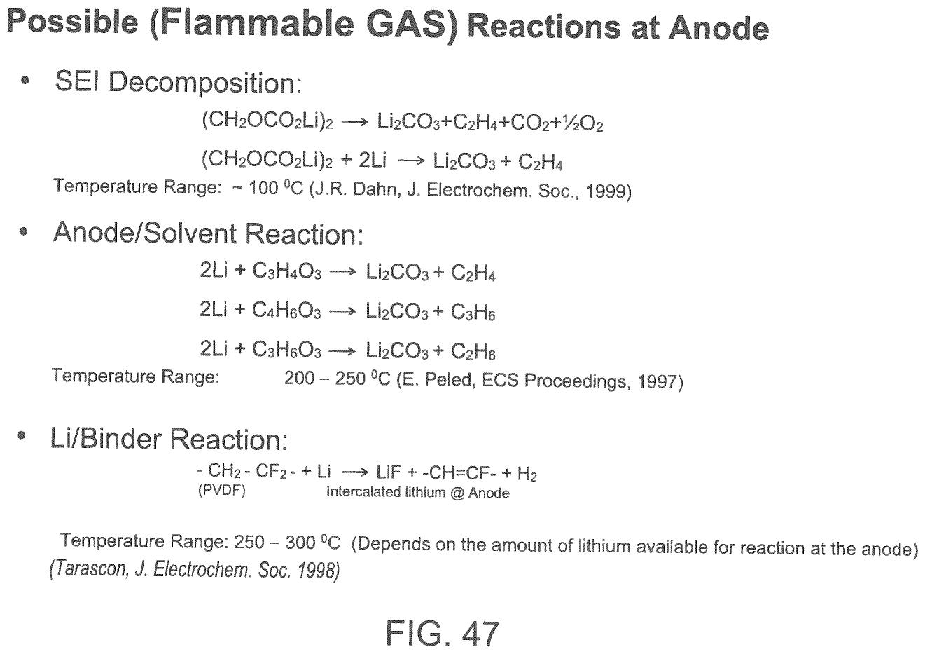

FIG. 47 lists possible reactions at an anode.

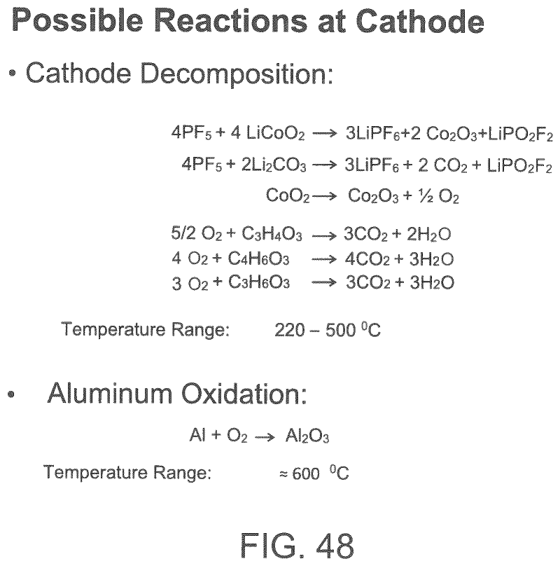

FIG. 48 lists possible reactions at a cathode.

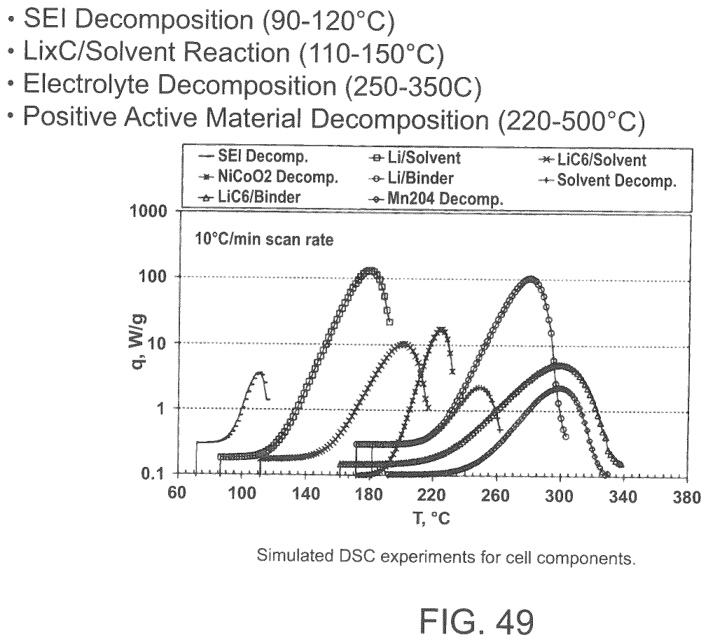

FIG. 49 is a graphic illustrating exothermic reactions considered in the simulation of FIG. 46.

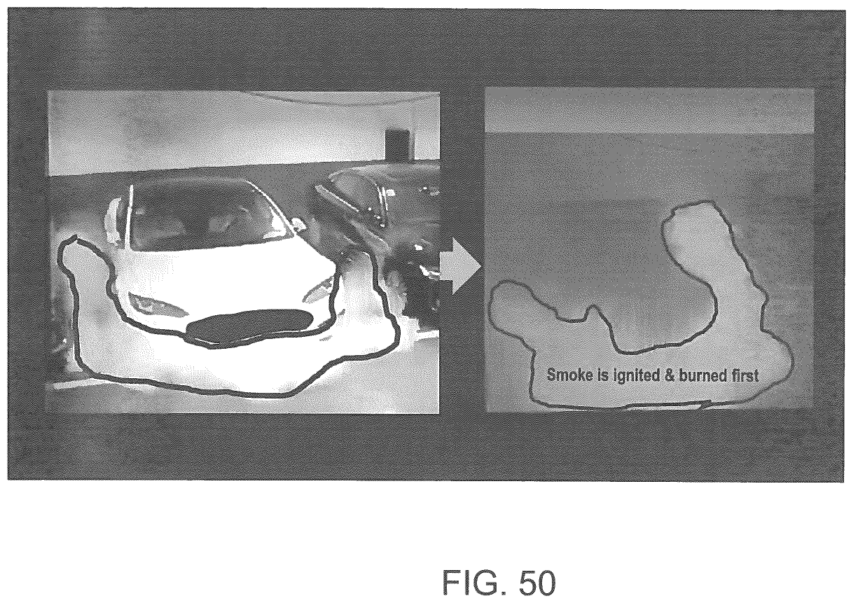

FIG. 50 includes a photo and temperature scan illustrating results of flammable smoke wherein the smoke is ignited and burned first.

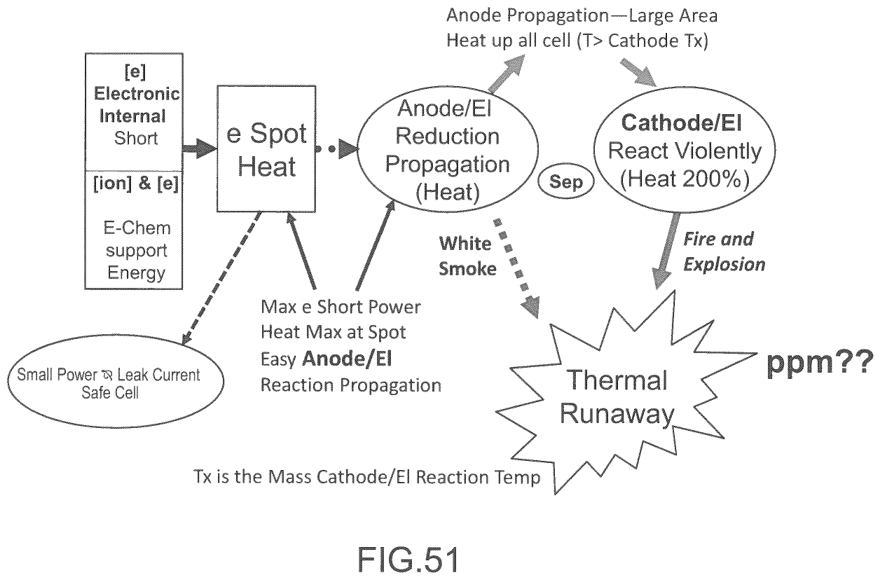

FIG. 51 is a graphic illustrating how an internal short can lead to thermal runaway.

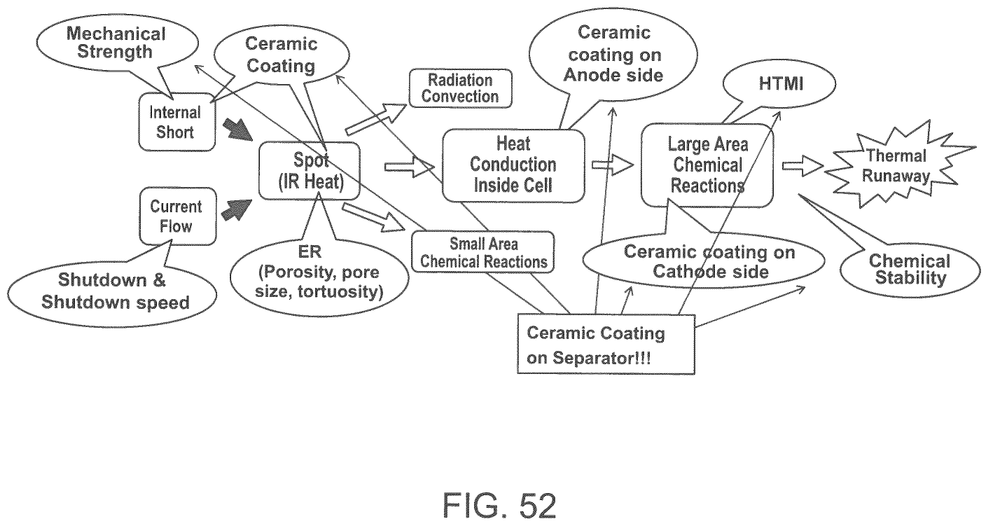

FIG. 52 is a graphic illustrating ceramic coated separator and internal short scenarios.

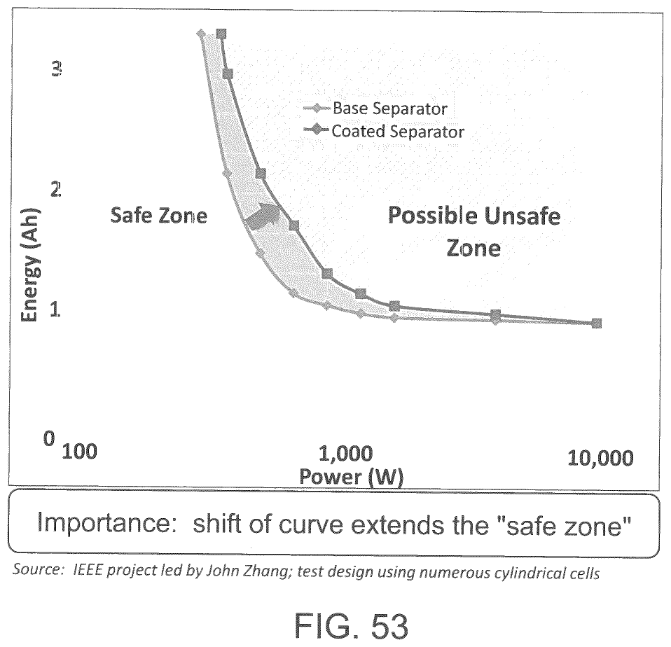

FIG. 53 is a graph of energy versus power showing BAJ test simulates nail tests on ceramic coated separator.

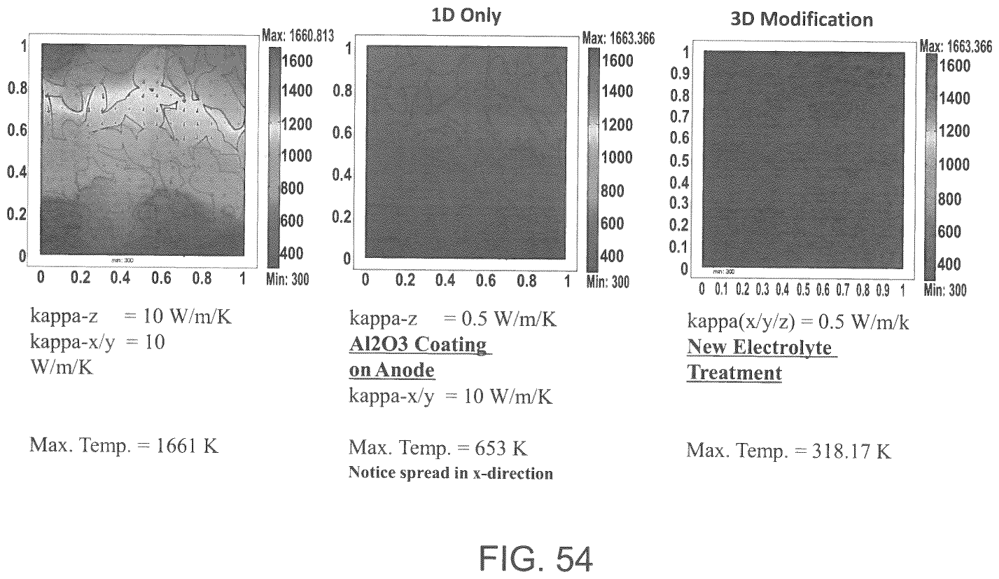

FIG. 54 is a graphic illustrating whether thermal conduction can reduce thermal propagation.

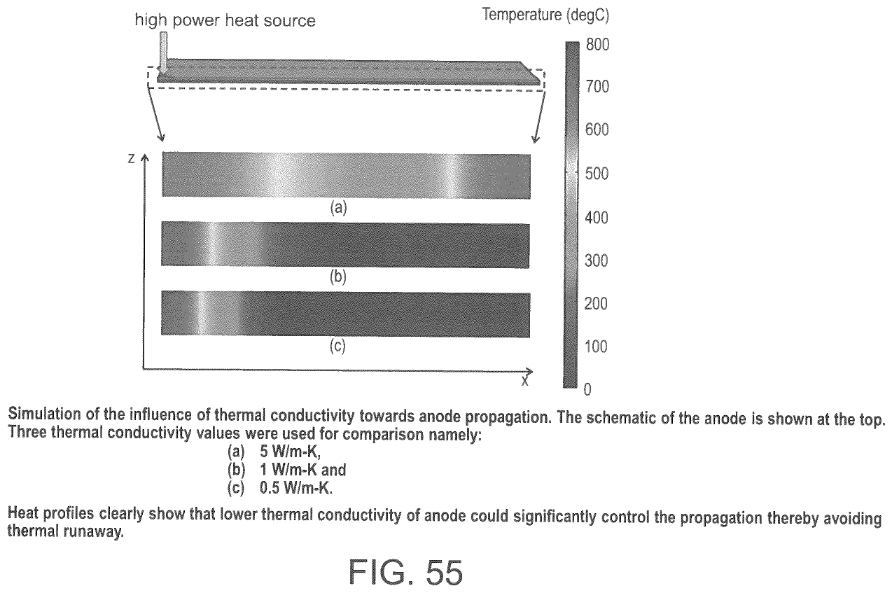

FIG. 55 is a graphic illustrating that ceramic coating on a separator is a much easier way to reduce anode propagation (facing anode or cathode). Simulation of the influence of thermal conductivity towards anode propagation. The schematic of the anode is shown at the top. Three thermal conductivity values were used for comparison namely: (a) 5 W/m-K, (b) 1 W/m-K and (c) 0.5 W/m-K. Heat profiles clearly show that lower thermal conductivity of anode could significantly control the propagation thereby avoiding thermal runaway.

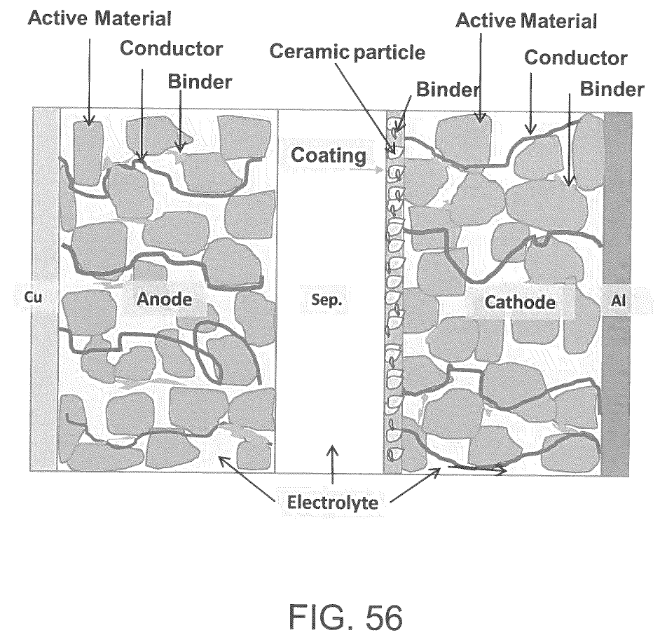

FIG. 56 is a graphic showing ceramic coating on separator/cathode-thin and oxidation resistive to cathode/separator interface.

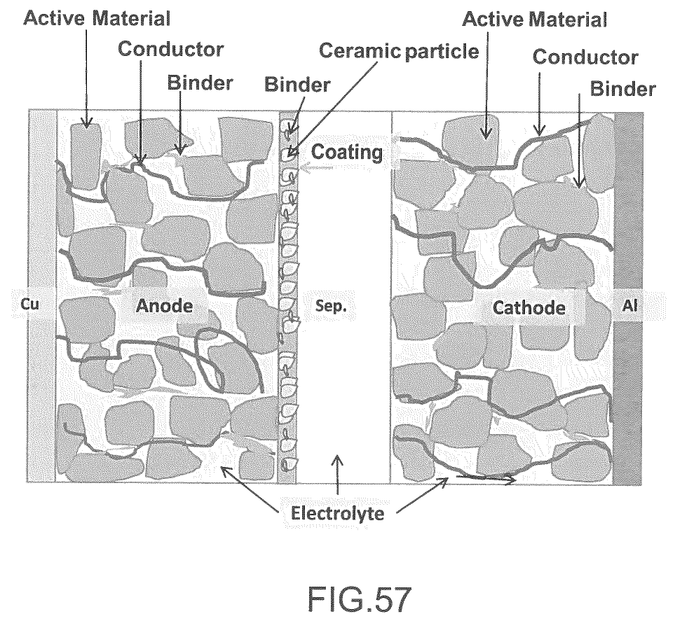

FIG. 57 is a graphic showing ceramic coating on separator/cathode-thin and lesser possibility of anode thermal propagation.

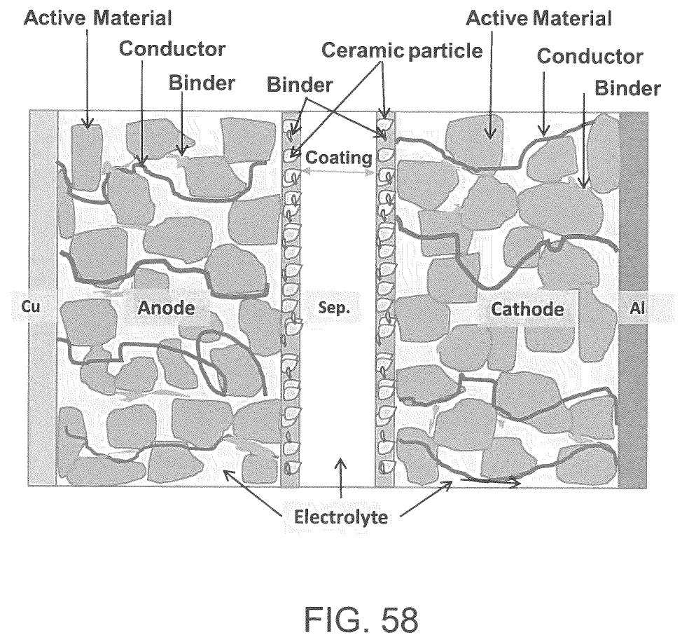

FIG. 58 is a graphic showing ceramic coating on both interfaces-oxidation resistance to cathode/separator interface and lesser anode propagation and possibly higher thickness and high ceramic cost.

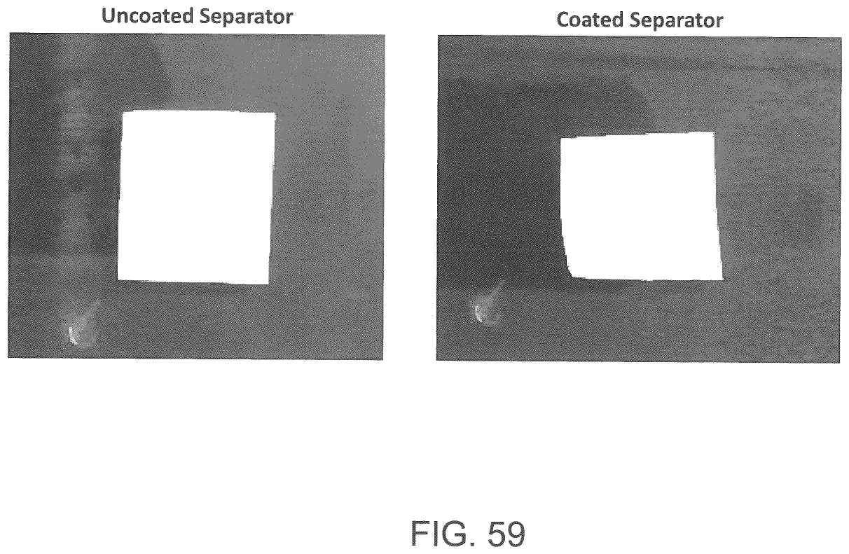

FIG. 59 includes photos illustrating the wettability of an uncoated separator versus a ceramic coated separator.

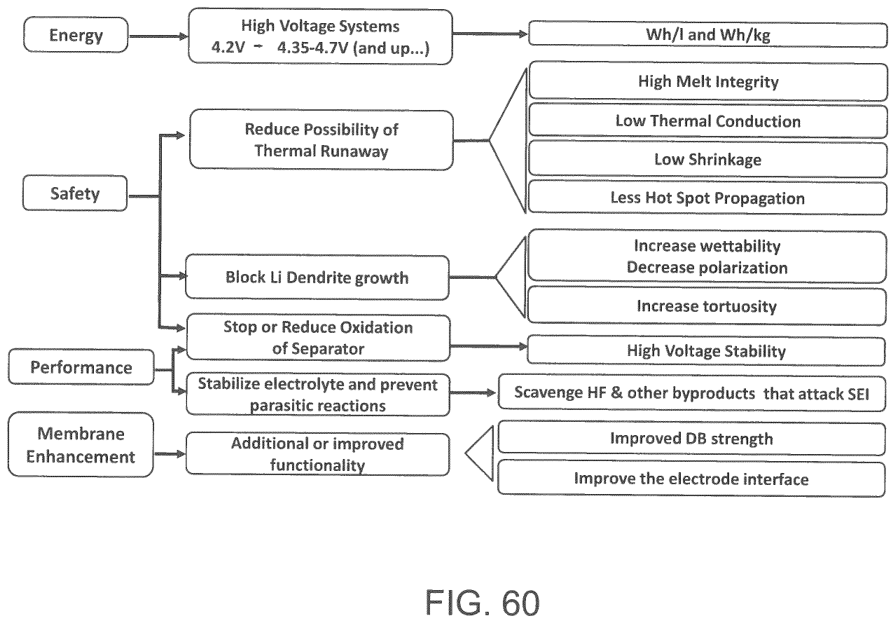

FIG. 60 illustrates the benefits on energy, safety, performance and membrane enhancement of ceramic coating on separators.

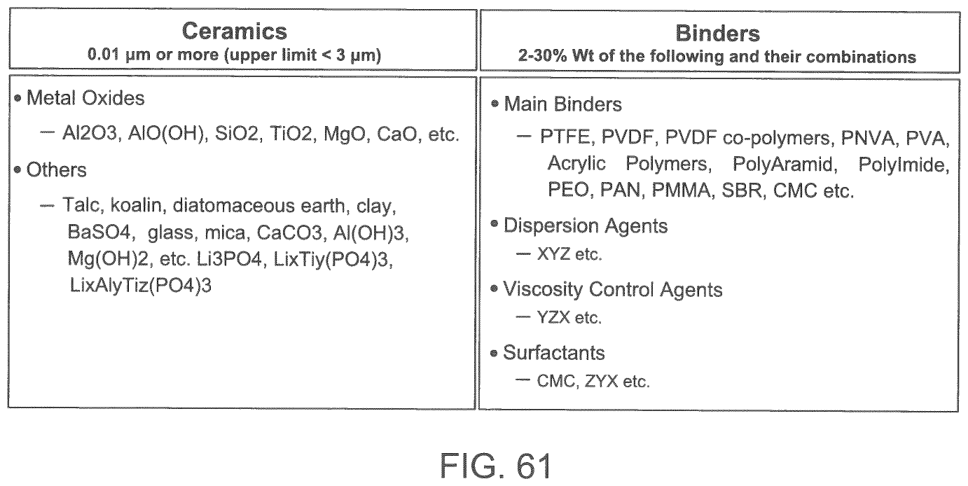

FIG. 61 is a chart listing ceramics and binders.

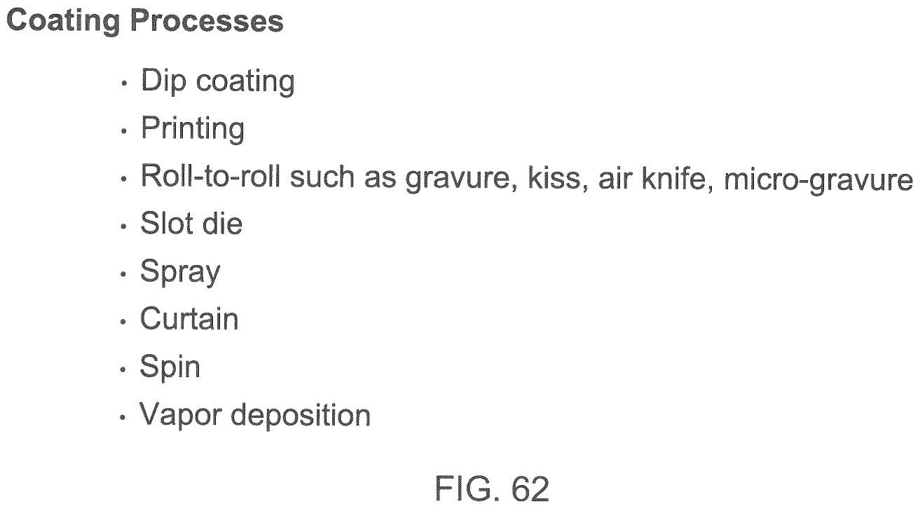

FIG. 62 lists coating processes.

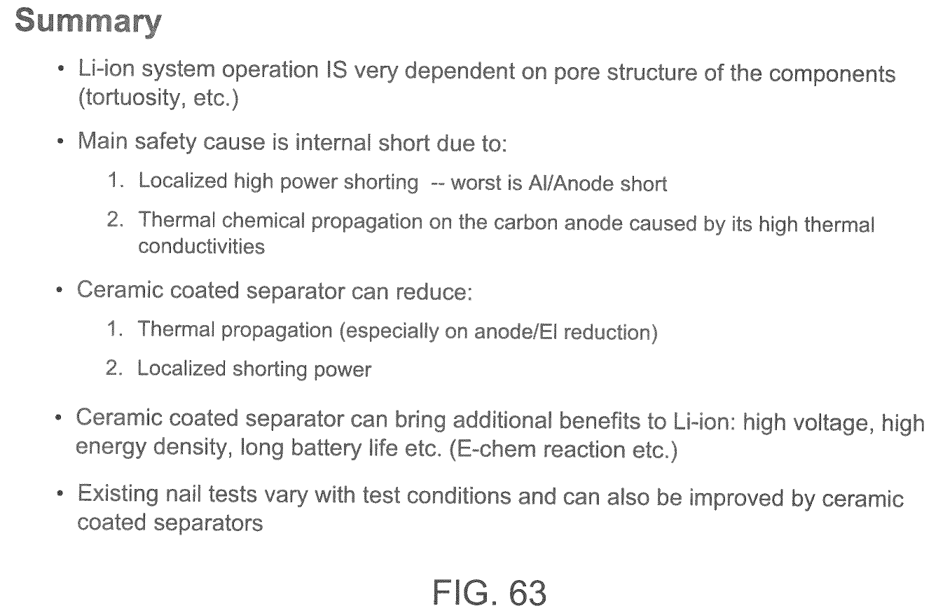

FIG. 63 discusses internal shorts of Li ion systems and possible solutions.

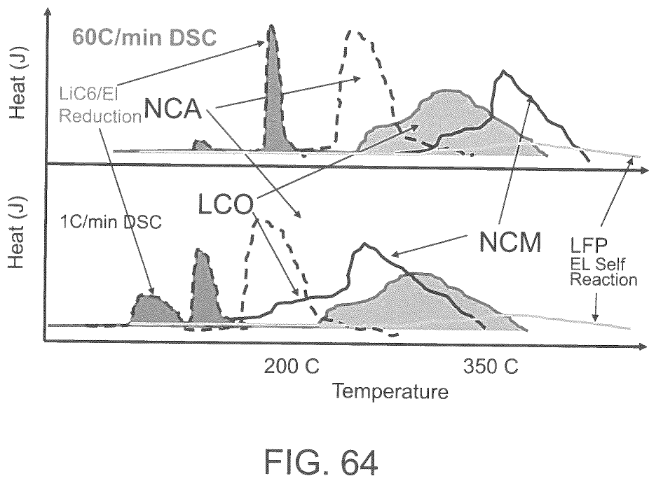

FIG. 64 are heat versus temperature graphs of typical electrode material E1 thermal reactions DSC or ARC showing uniform heating is required to prevent an internal short.

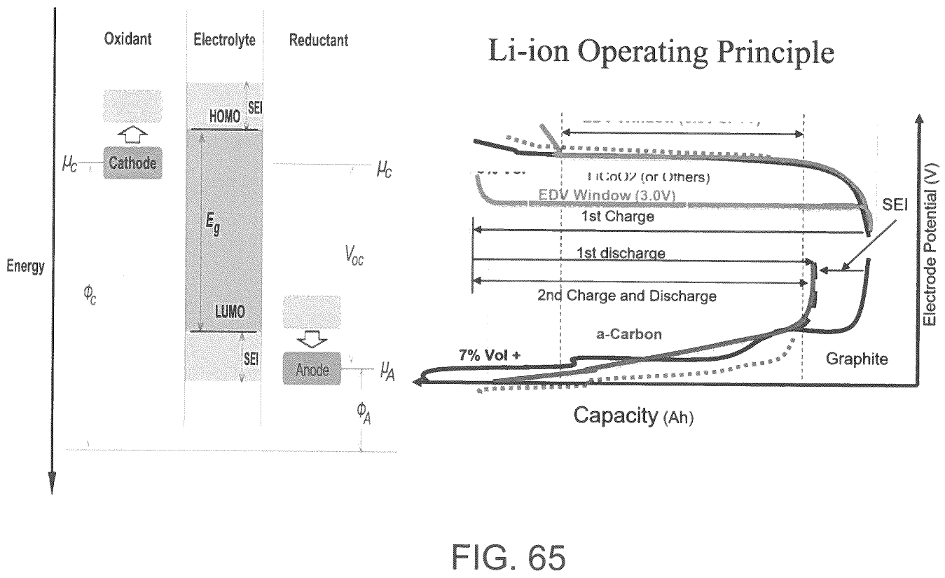

FIG. 65 illustrates the Li ion operating principle.

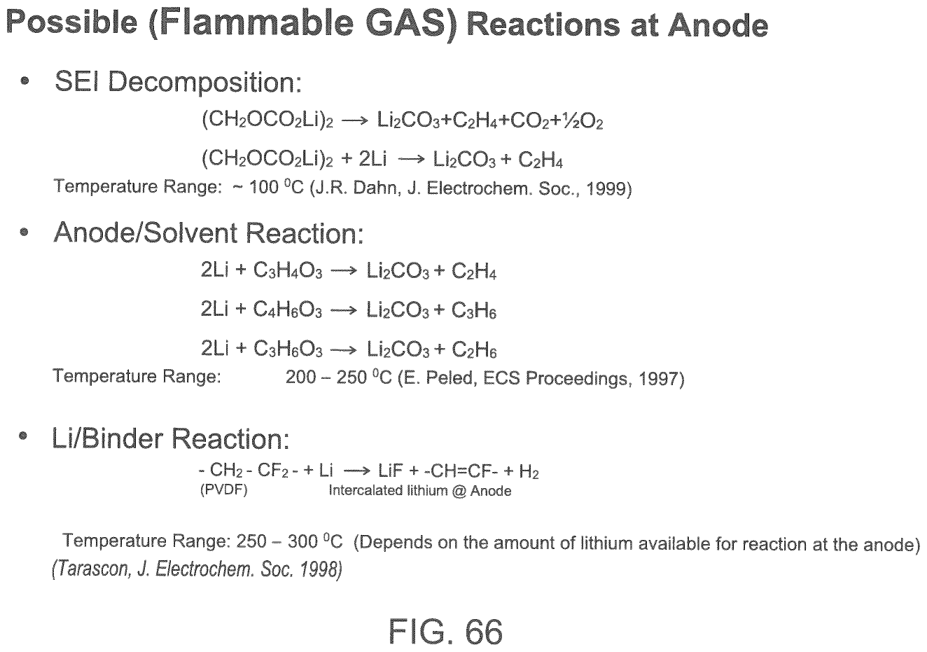

FIG. 66 lists possible reactions at an anode.

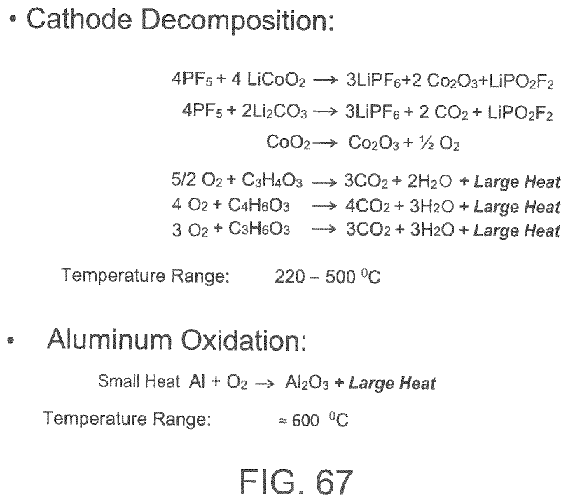

FIG. 67 illustrates reactions involved in cathode decomposition and aluminum oxidation.

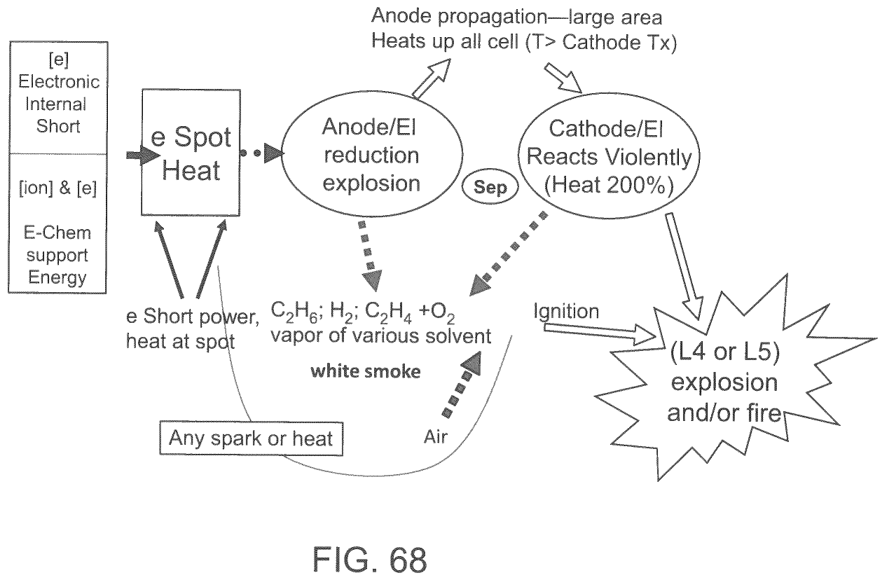

FIG. 68 is a graphic illustrating how an Internal Short of Normal Cell can lead to (L4 or L5) explosion and/or fire.

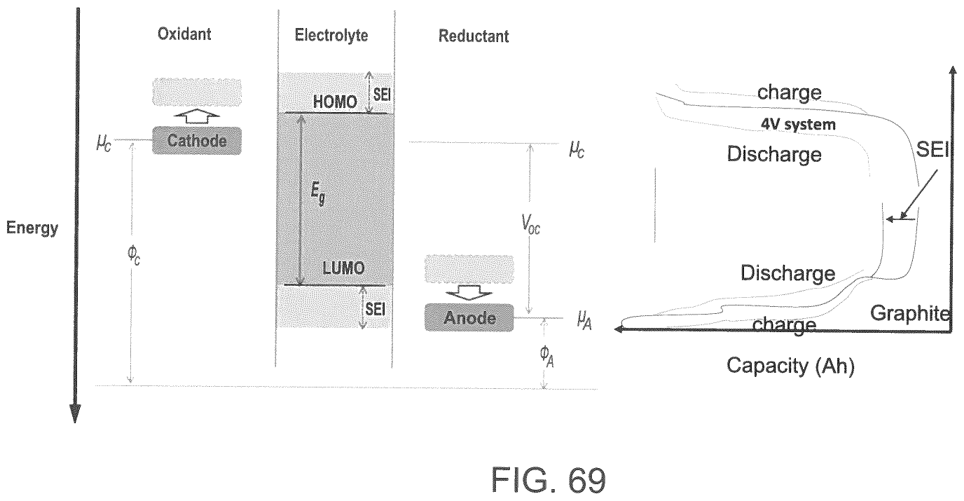

FIG. 69 illustrates a charge and discharge cycle.

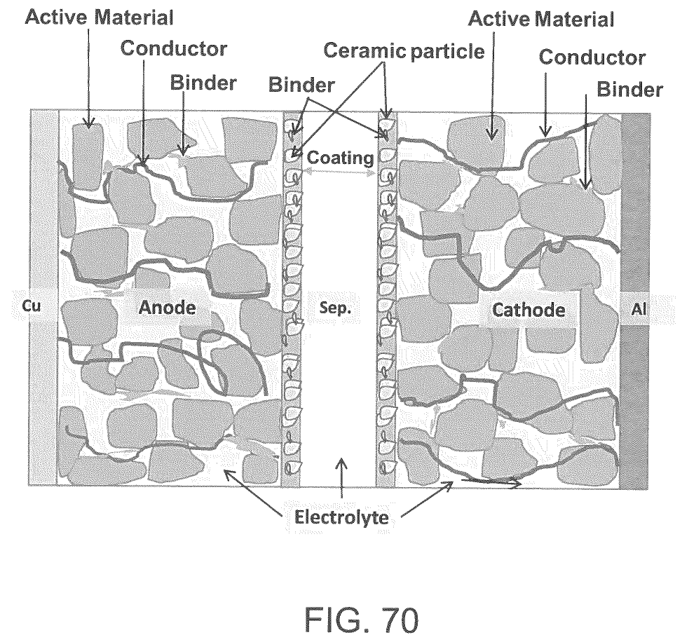

FIG. 70 is a graphic showing ceramic coating on both interfaces-oxidation resistance to cathode/separator interface and lesser anode propagation and possibly higher thickness and high ceramic cost.

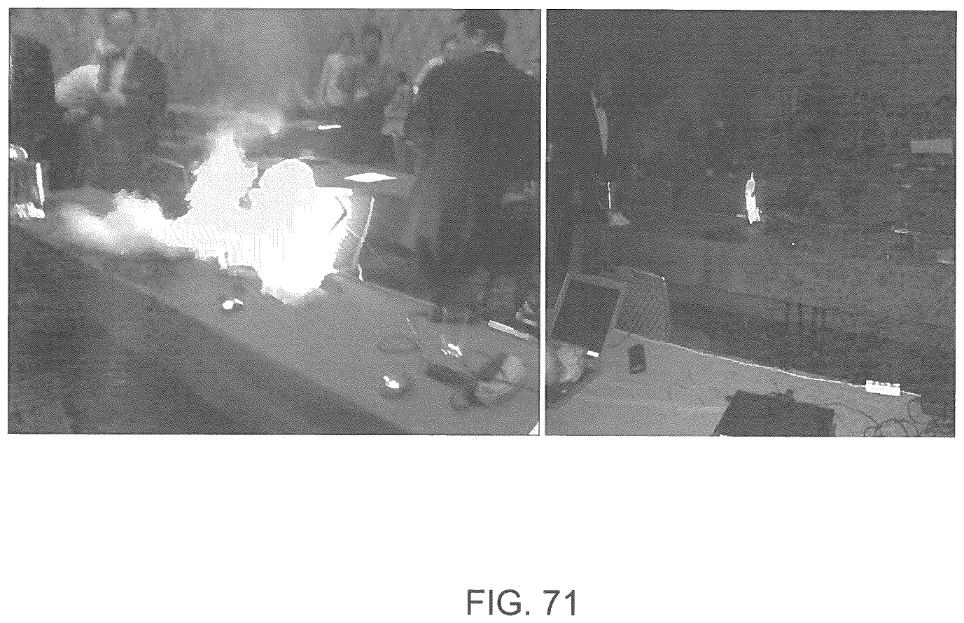

FIG. 71 are photos illustrating a laptop which exploded and caught on fire from a faulty Lithium ion battery at a conference.

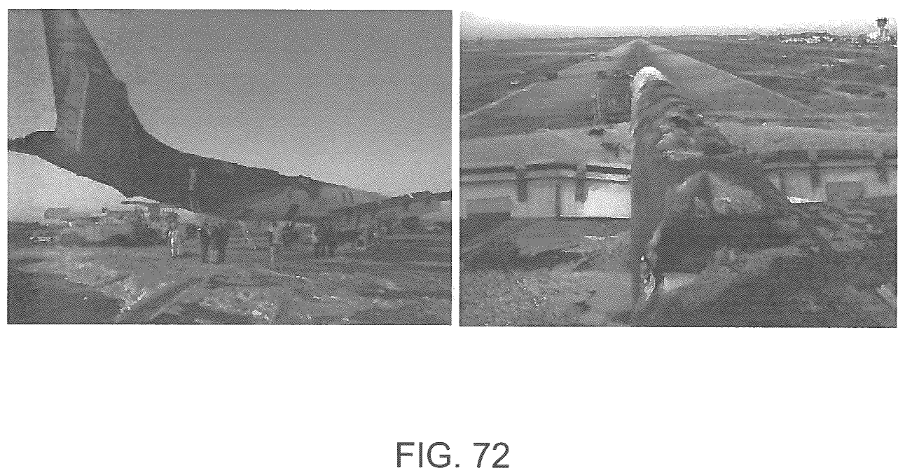

FIG. 72 are photos illustrating a UPS plane in Philadelphia which caught on fire wherein the fire may have been ignited by a faulty Lithium ion battery.

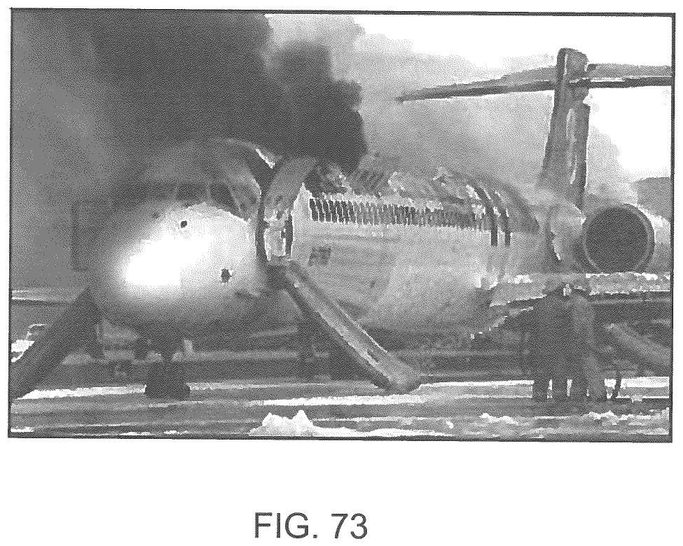

FIG. 73 is a photo of a plane on fire.

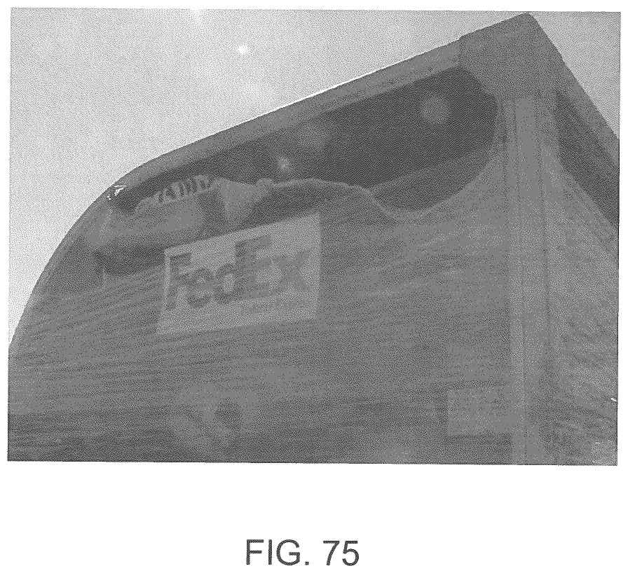

FIG. 74 is a photo of a damages unit load device (ULD) which may have been damages by a faulty Lithium ion battery.

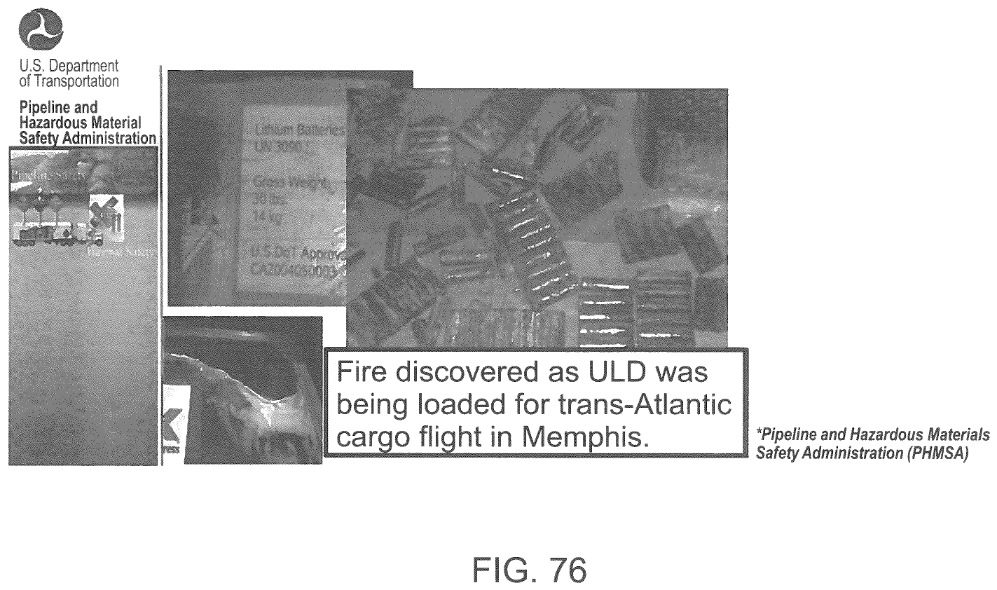

FIG. 75 is a photo illustrating damaged Lithium ion batteries in the ULD of FIG. 74, wherein a fire in the ULD which contained Lithium ion batteries was discovered as the ULD was being loaded for a trans-Atlantic cargo flight in Memphis, Tennessee, and wherein the shipper was a Pipeline and Hazardous Materials Safety Administration (PHMSA) approval holder.

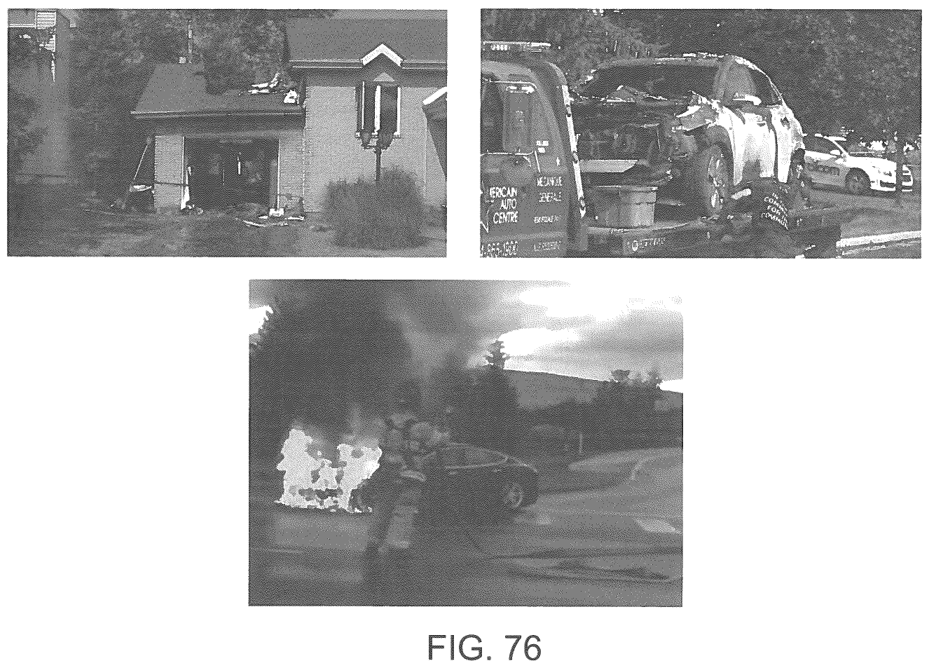

FIG. 76 are photos showing Canadian Kona explosion in a garage due to an XYZ Li-ion battery.

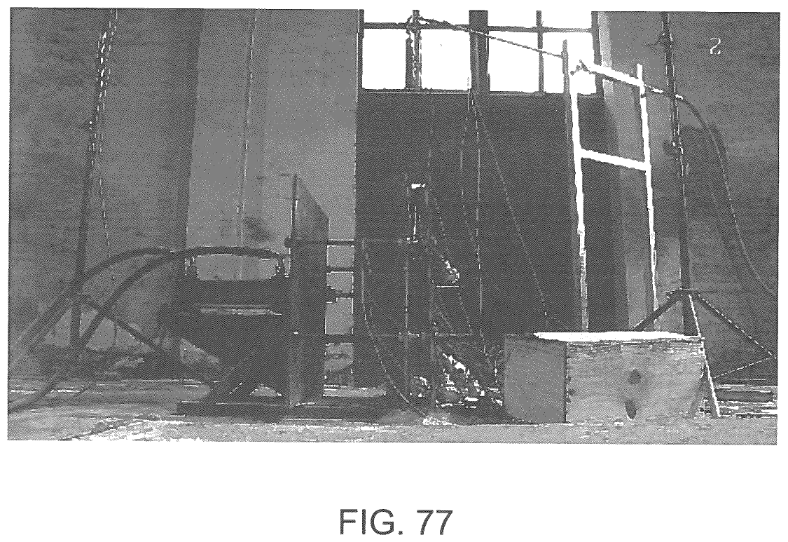

FIG. 77 is a photo of battery abuse test apparatus.

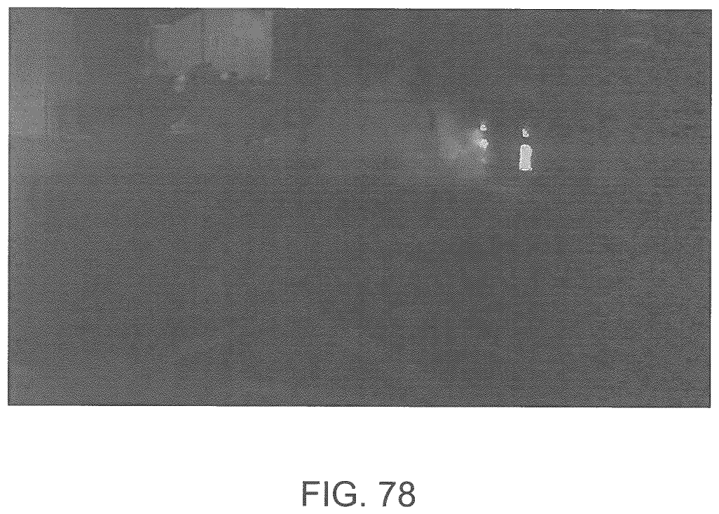

FIG. 78 is a photo of a vehicle charging battery fire.

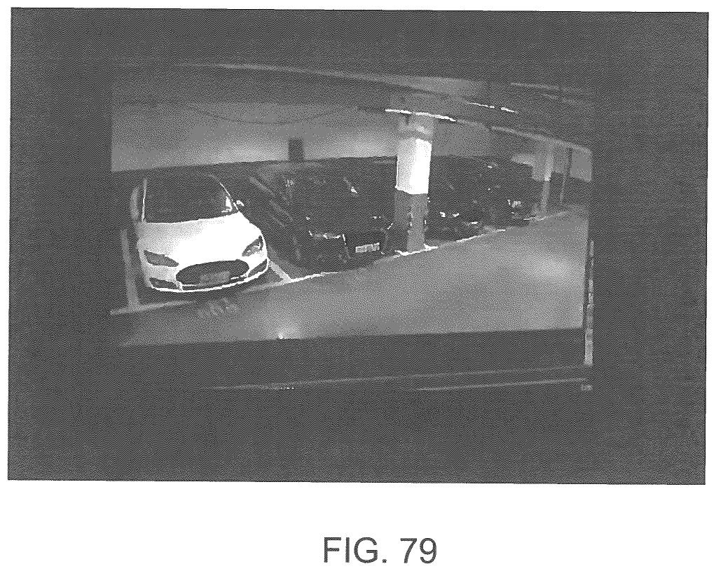

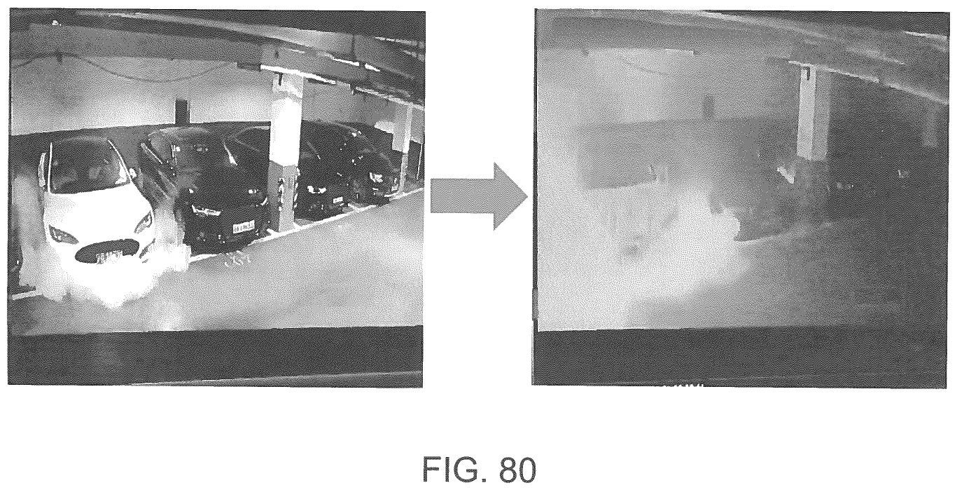

FIGS. 79 and 80 are photos and a temperature scan showing EDV self-explosion and fire with white smoke-explosion and fire are located in the same area with white smoke.

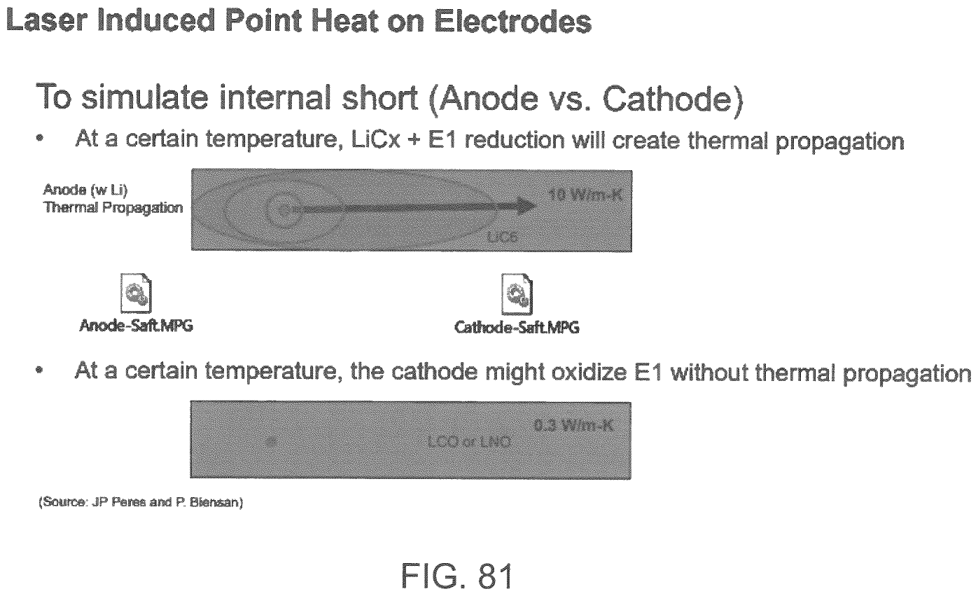

FIG. 81 schematically illustrates laser induced point heat on electrodes to simulate internal short.

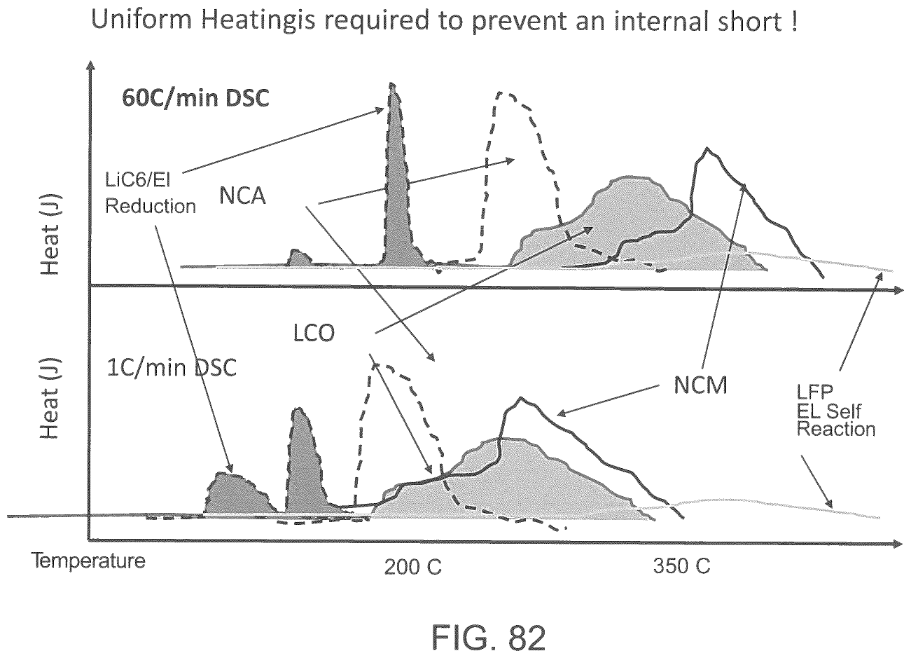

FIG. 82 is a graph illustrating that uniform heating is required to prevent an internal short.

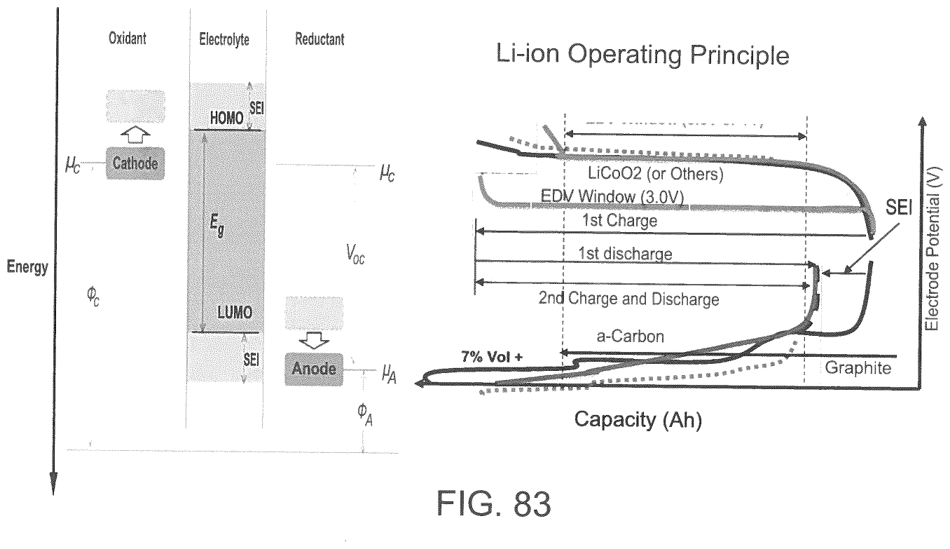

FIG. 83 is a graph illustrating a Li ion operating principle.

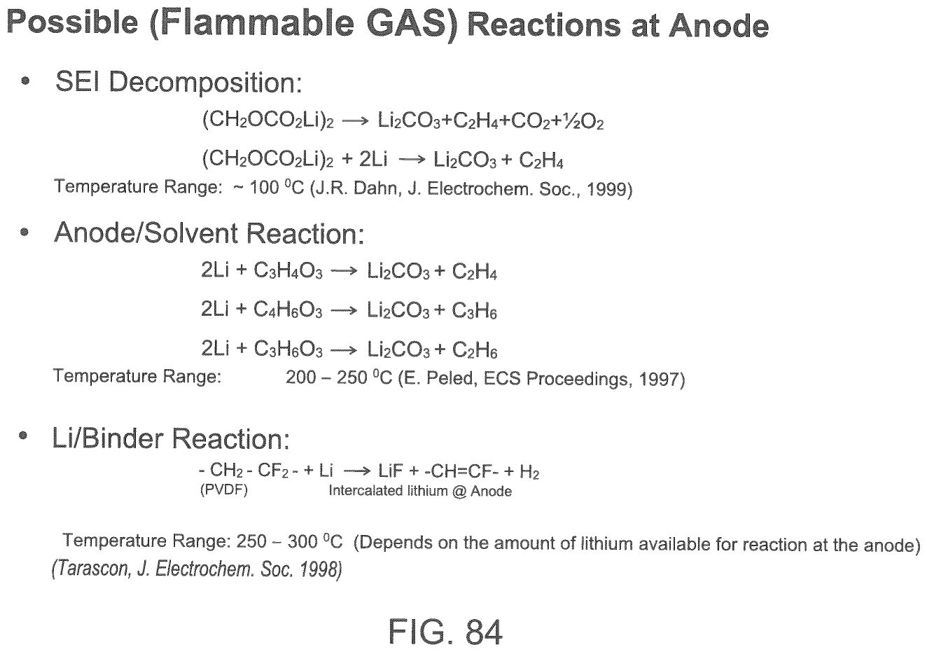

FIG. 84 illustrates possible reactions at an anode.

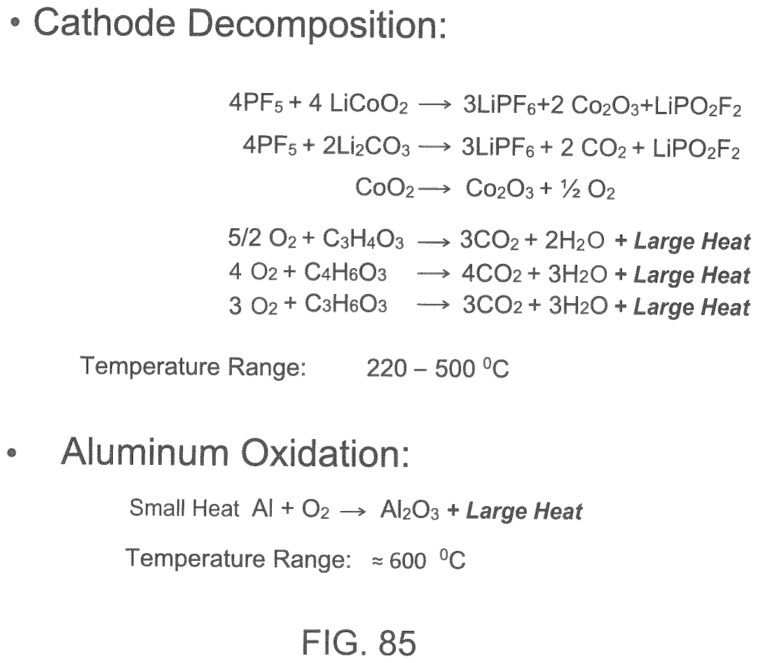

FIG. 85 shows reactions involved in cathode decomposition and aluminum oxidation.

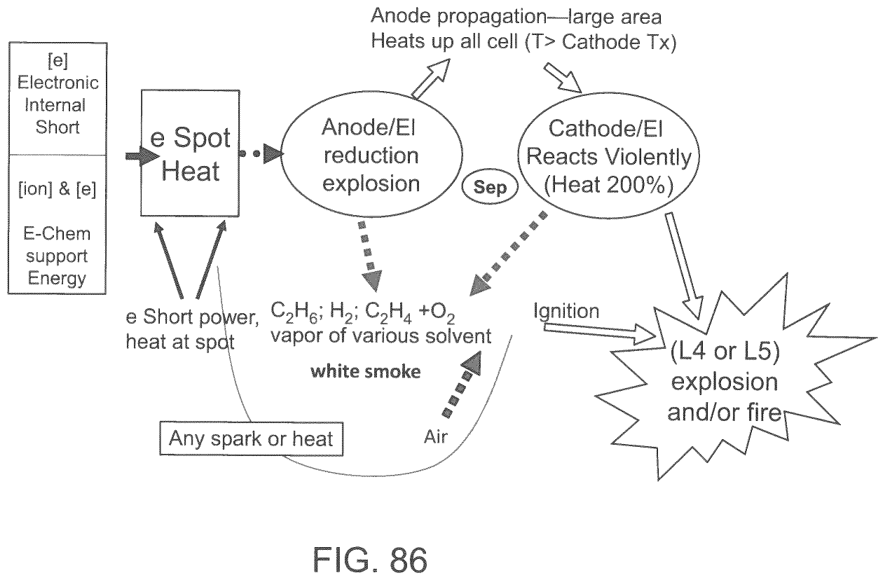

FIG. 86 is a graphic illustrating how an Internal Short of Normal Cell can lead to (L4 or L5) explosion and/or fire.

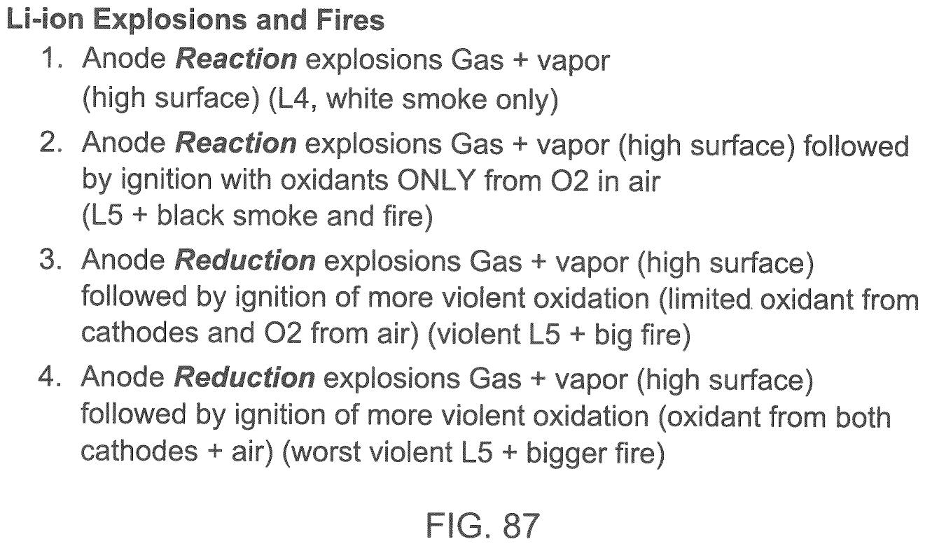

FIG. 87 discusses different types of Li ion explosions and fires.

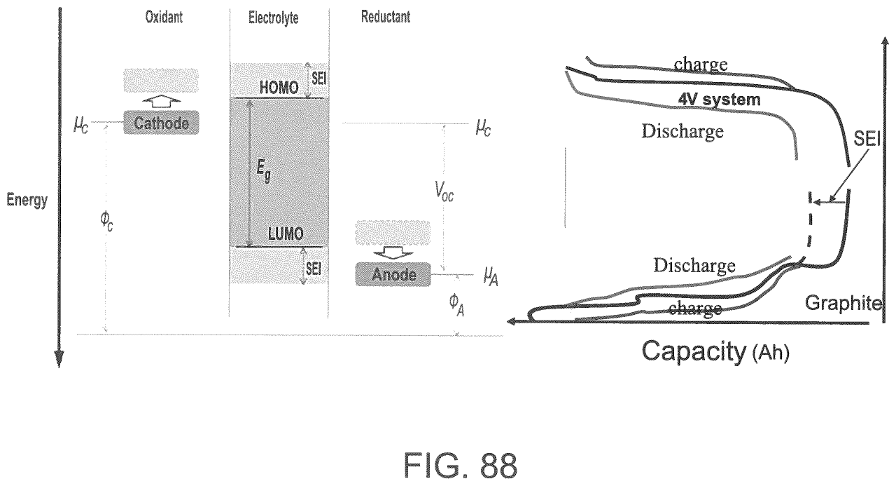

FIG. 88 illustrates a charge and discharge cycle.

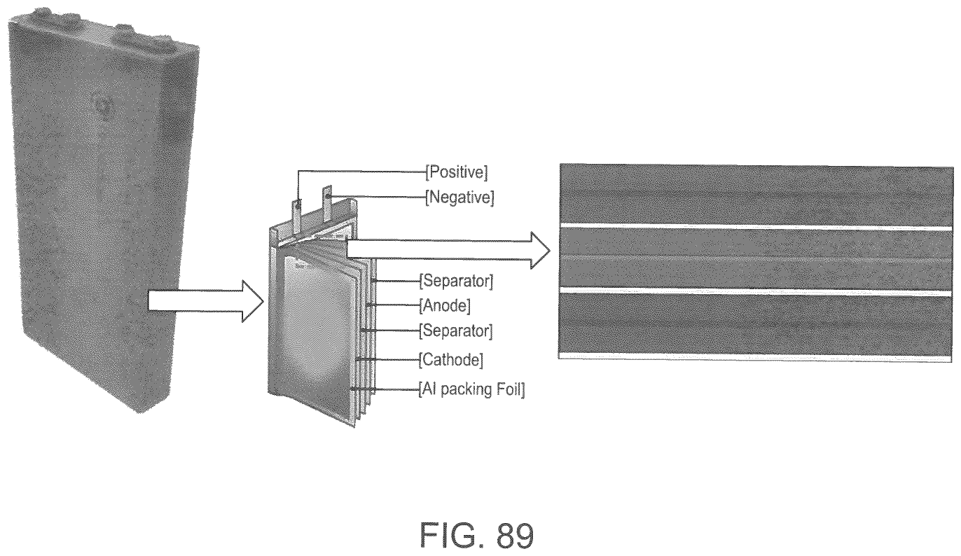

FIG. 89 is a graphic illustrating the internal structure of an EDV battery.

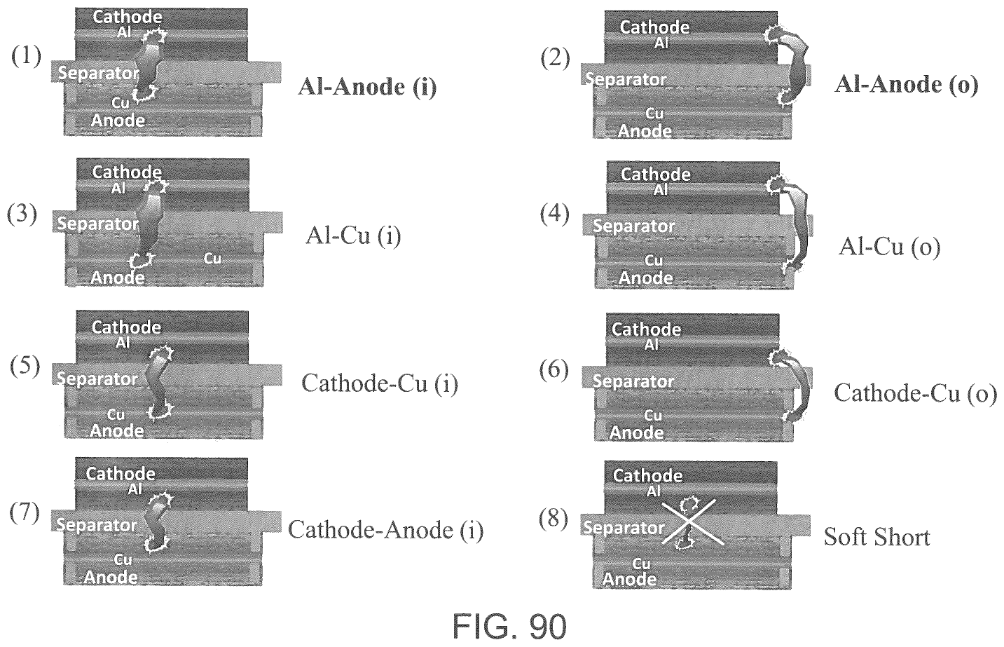

FIG. 90 is a graphic illustrating various cases of internal shorts in a lithium ion battery.

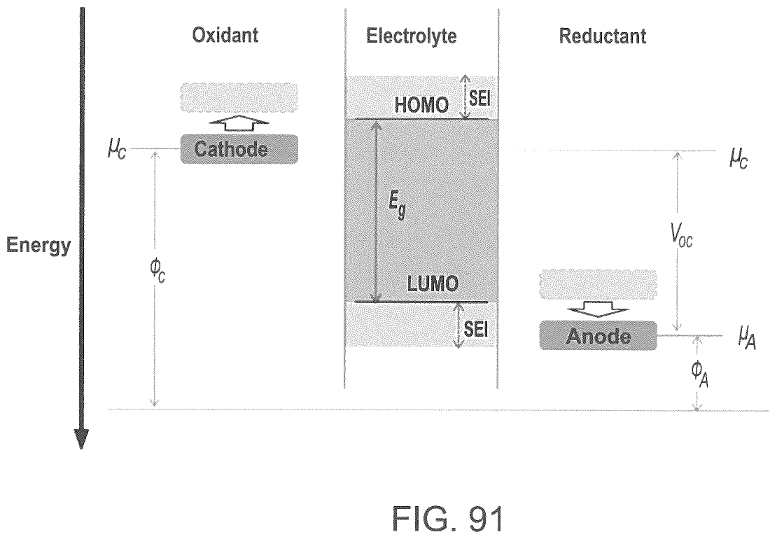

FIG. 91 illustrates a Li ion operating principle.

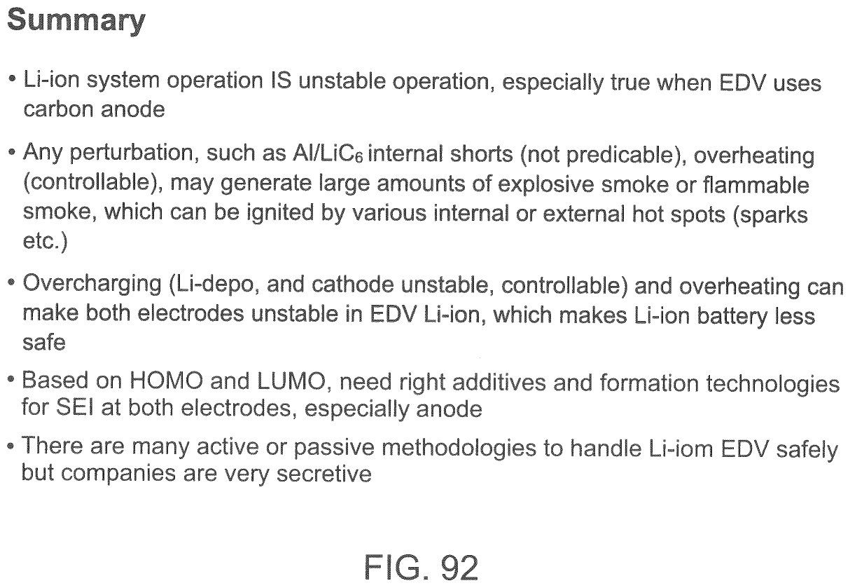

FIG. 92 discusses safety issues with Li ion systems.

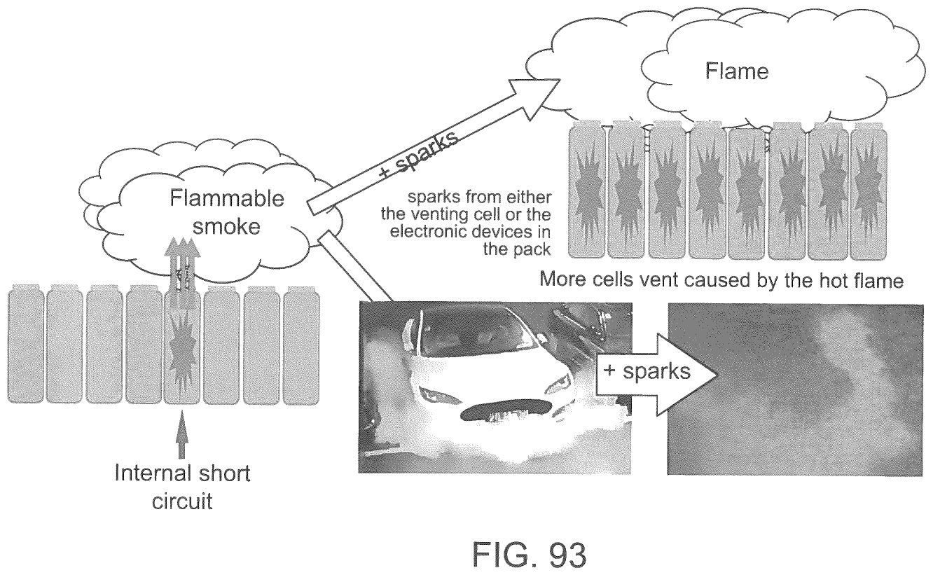

FIG. 93 schematically illustrates progression of fire or explosion from an internal short.

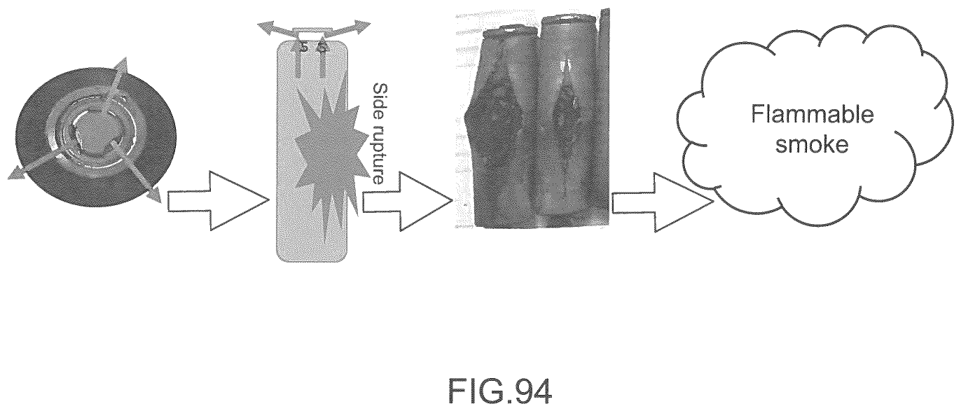

FIG. 94 includes photos and graphics illustrating smoke production in an 18650 battery.

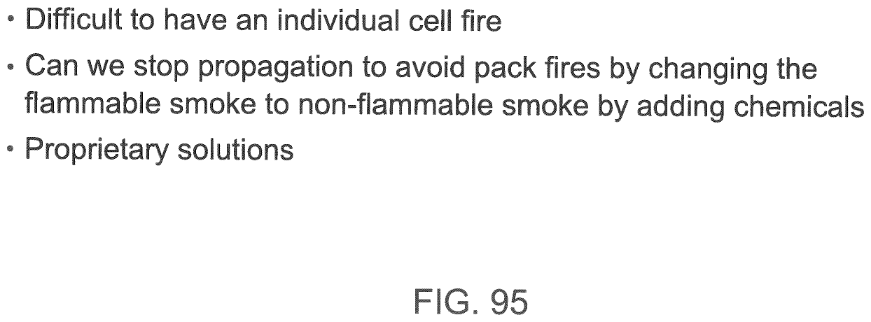

FIG. 95 discusses cell pack fires.

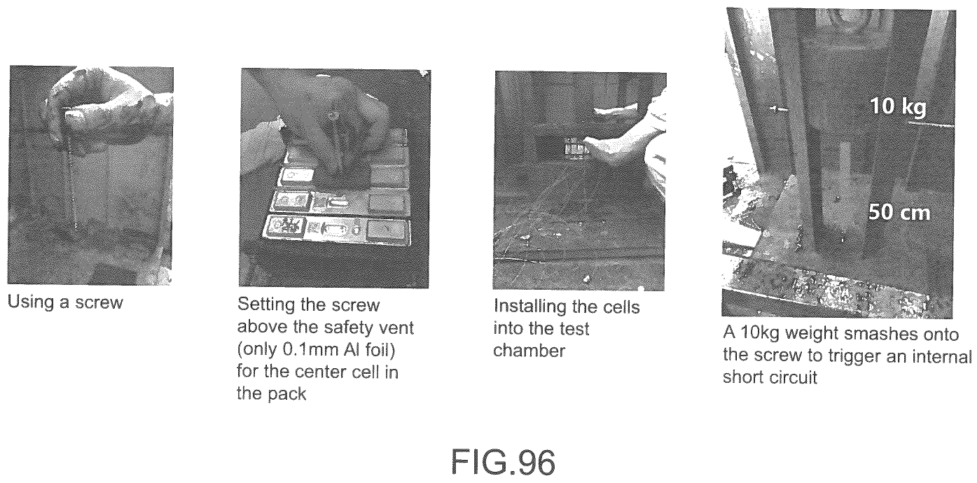

FIG. 96 illustrates use of a screw trigger to create an internal short circuit in a 5-cell pack.

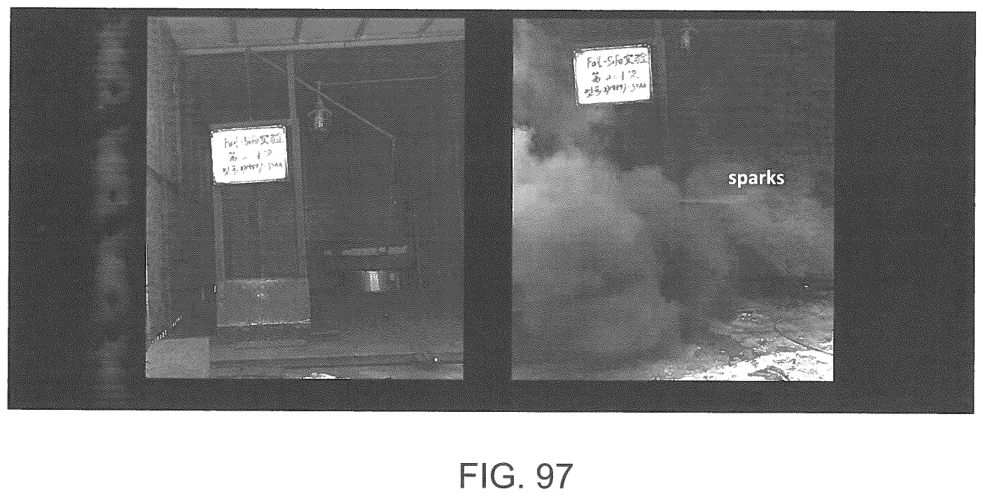

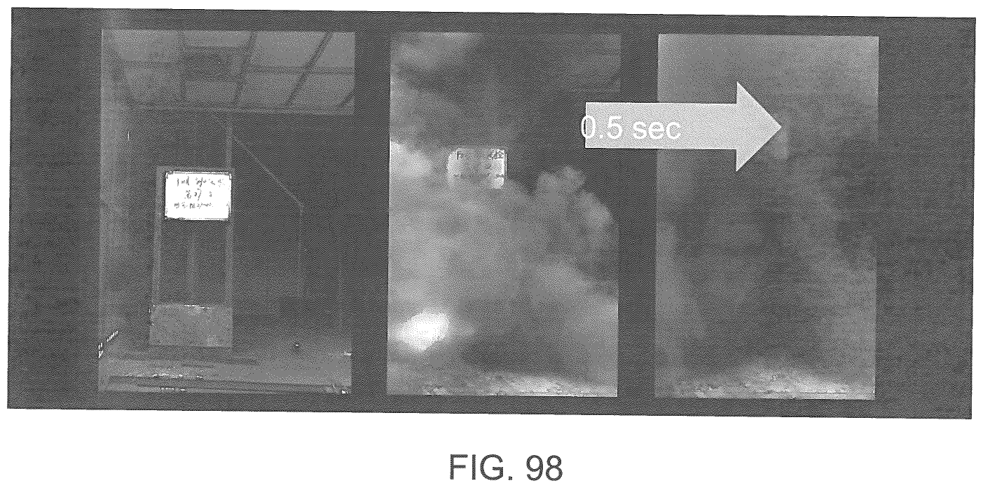

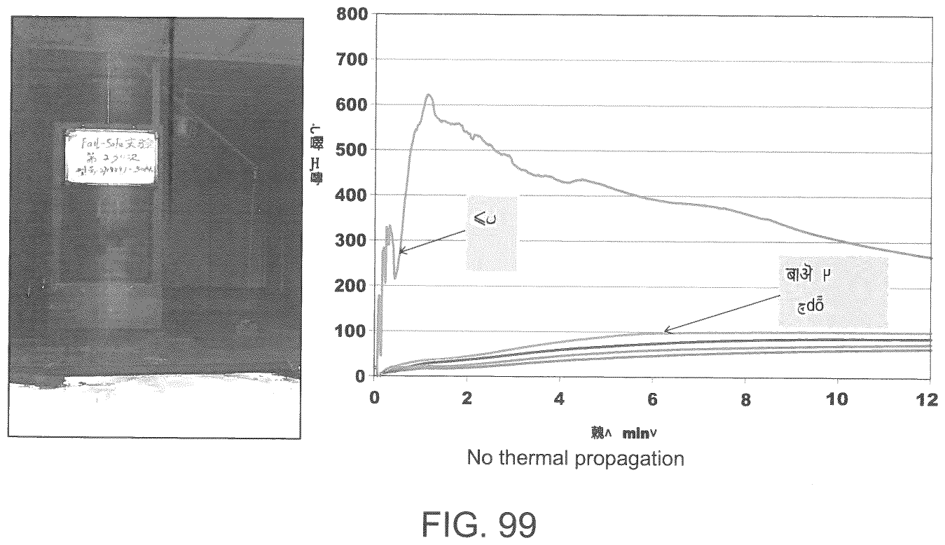

FIGS. 97-99 include photos of a nail penetration test showing that proprietary chemicals used achieve non-flammable smoke when a cell undergoes thermal runaway.

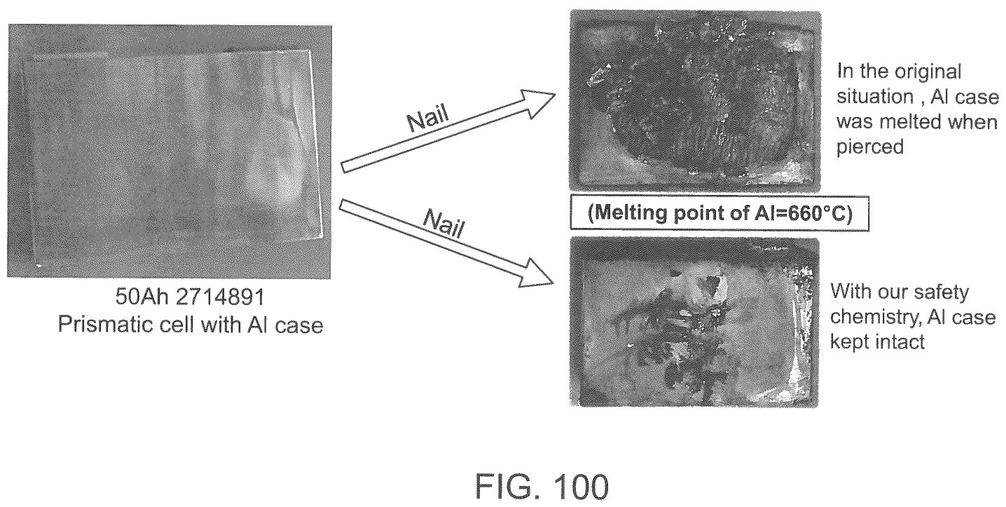

FIG. 100 illustrates the use of decreasing temperature wherein decreasing the cell temperature decreased the reaction intensity.

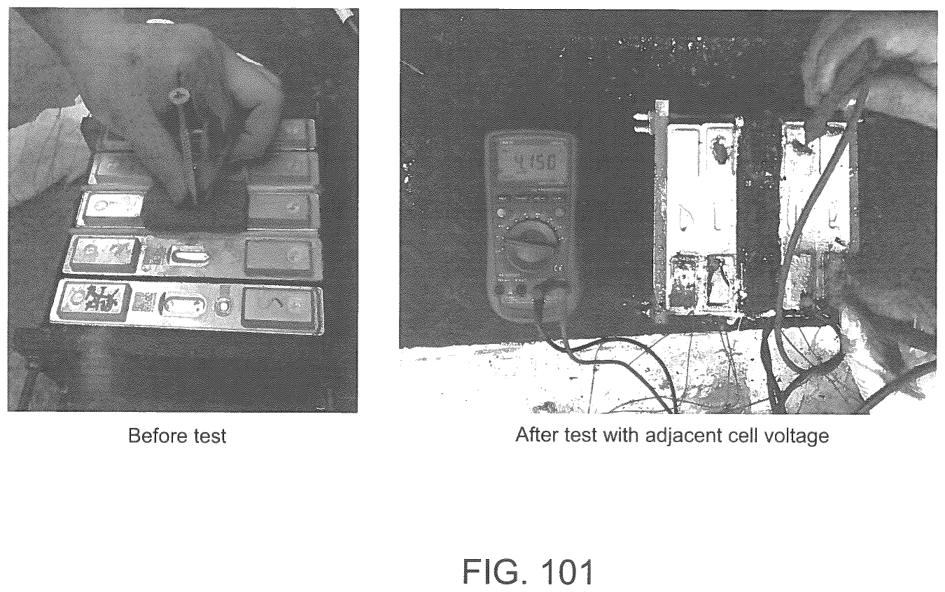

FIG. 101 illustrates a cell before and after screw penetration test.

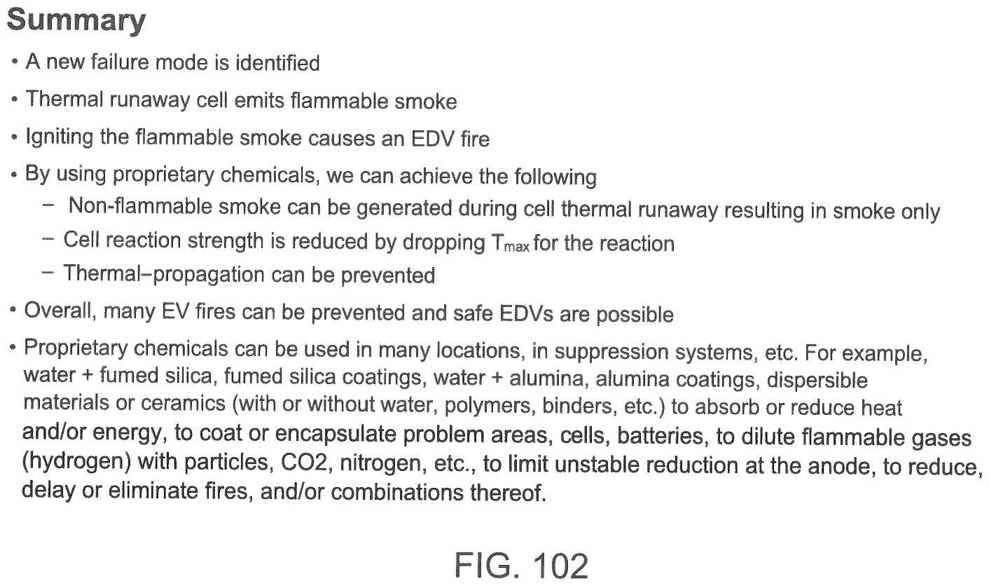

FIG. 102 discusses a new Li ion system failure mode.

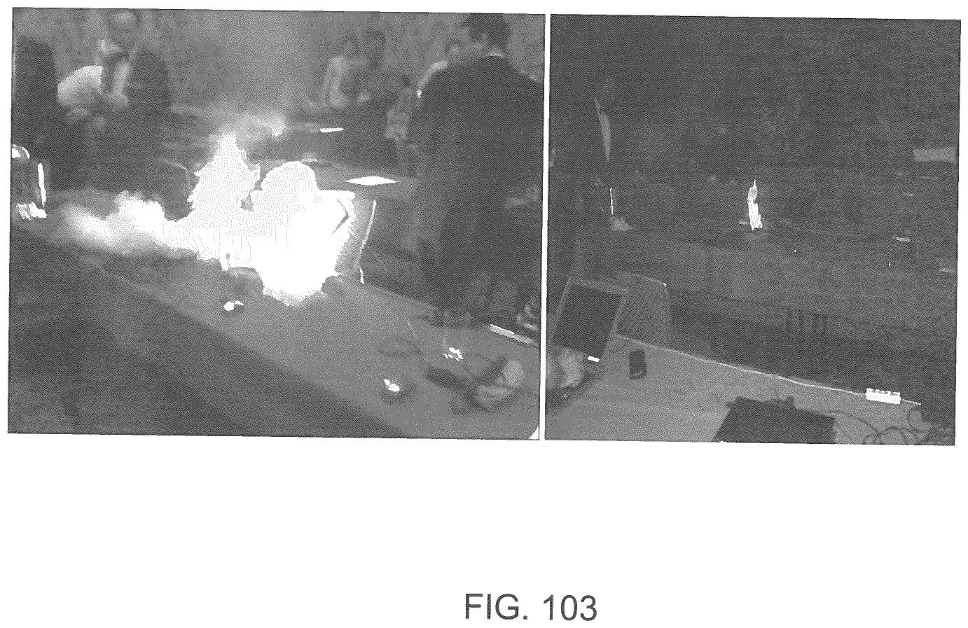

FIG. 103 are photos illustrating a laptop which exploded and caught on fire from a faulty Lithium ion battery at a conference.

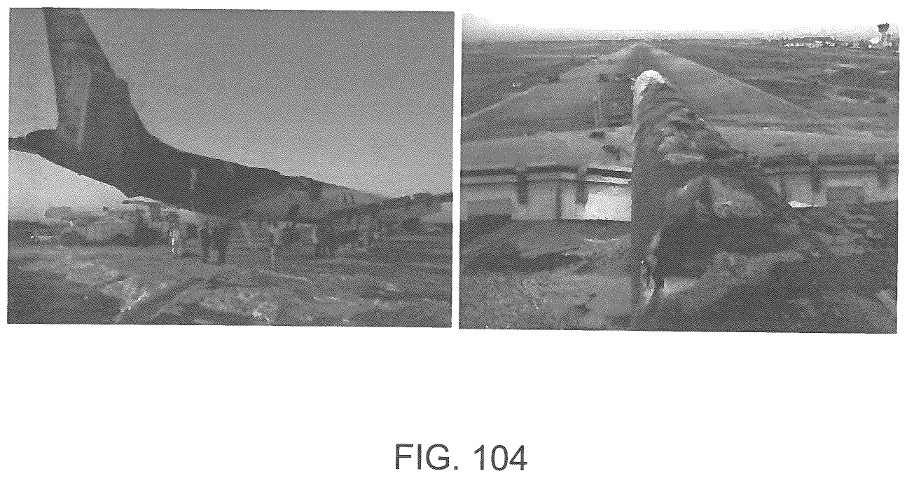

FIG. 104 are photos illustrating a UPS plane in Philadelphia which caught on fire wherein the fire may have been ignited by a faulty Lithium ion battery.

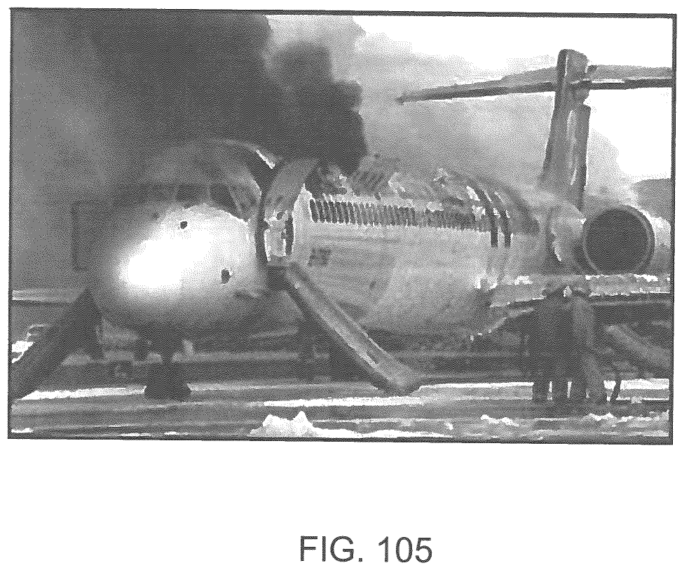

FIG. 105 is a photo of a plane on fire.

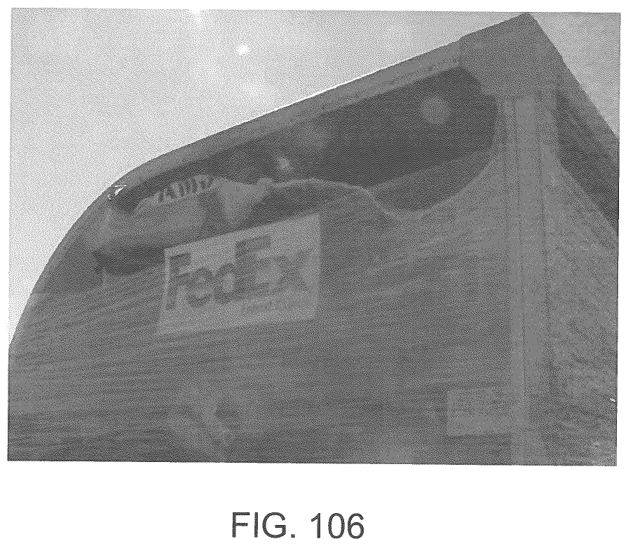

FIG. 106 is a photo of a damages unit load device (ULD) which may have been damages by a faulty Lithium ion battery.

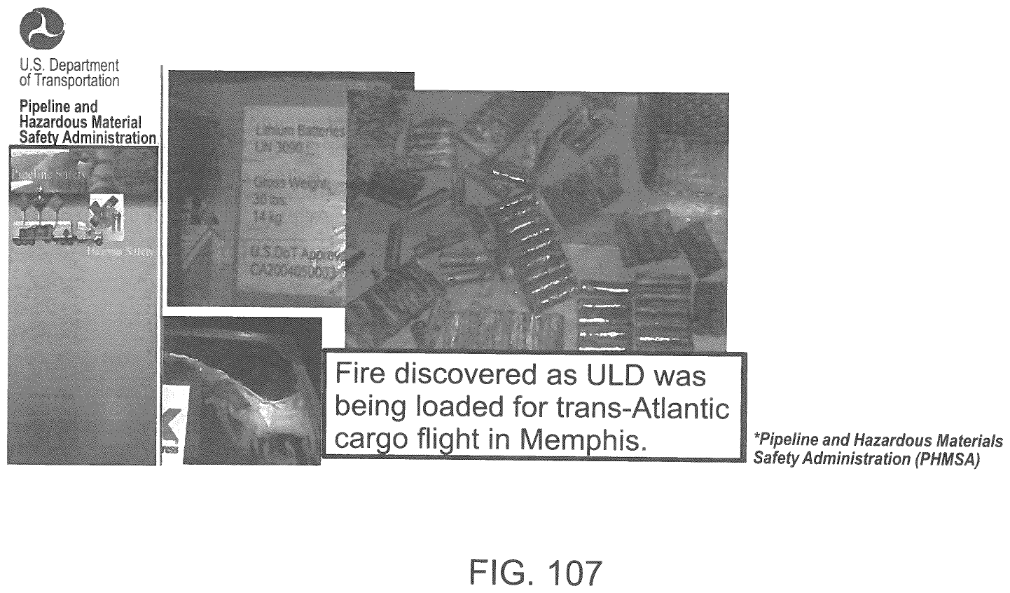

FIG. 107 is a photo illustrating damaged Lithium ion batteries in the ULD of FIG. 106, wherein a fire in the ULD which contained Lithium ion batteries was discovered as the ULD was being loaded for a trans-Atlantic cargo flight in Memphis, Tennessee, and wherein the shipper was a Pipeline and Hazardous Materials Safety Administration (PHMSA) approval holder.

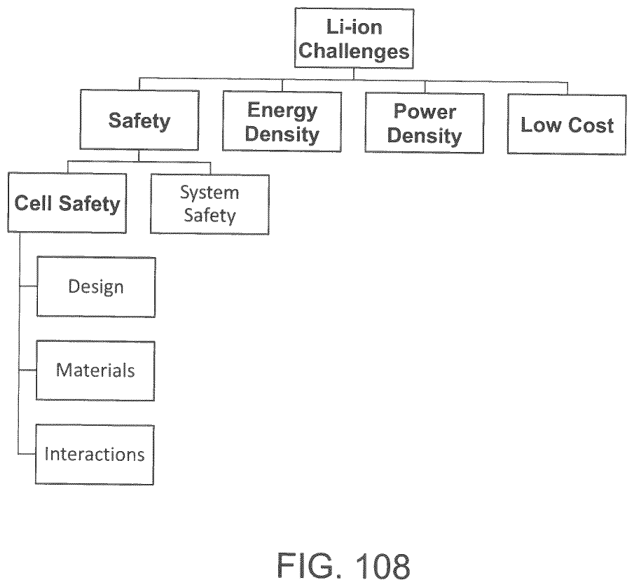

FIG. 108 is a chart partially illustrating Lithium ion battery challenges.

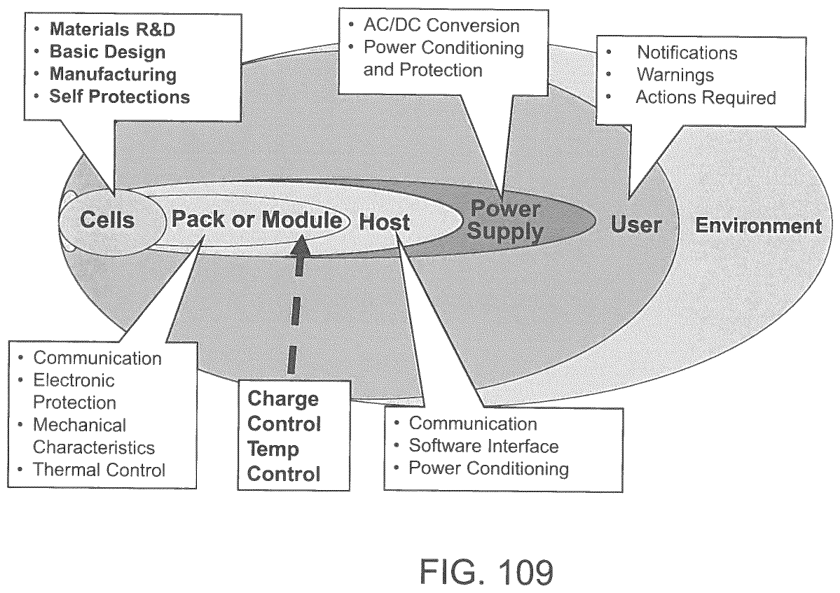

FIG. 109 is a graphic illustrating a system approach to Lithium-ion design and use (IEEE).

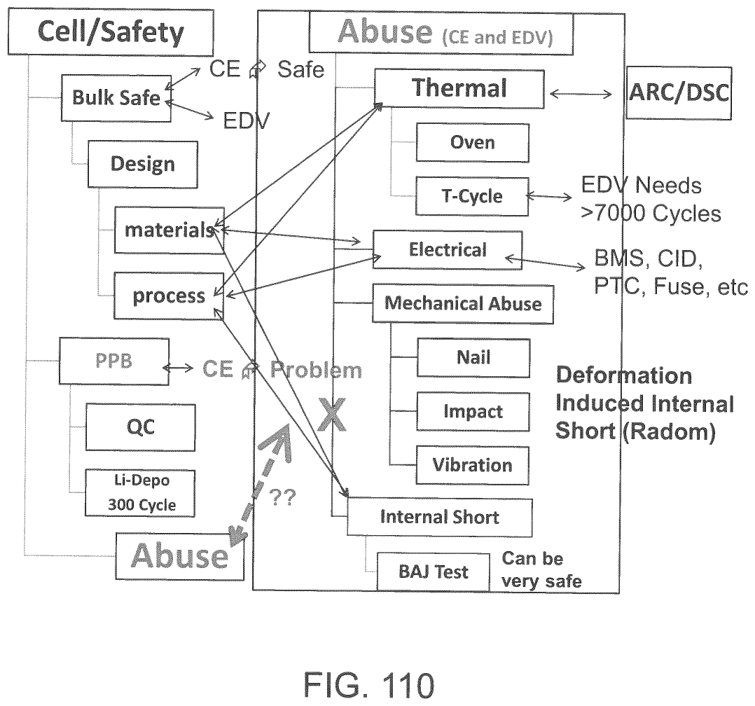

FIG. 110 is a flow chart illustrating the interplay between the Cell Safety prong of FIG. 108 with the types of abuse to which such batteries may be subjected.

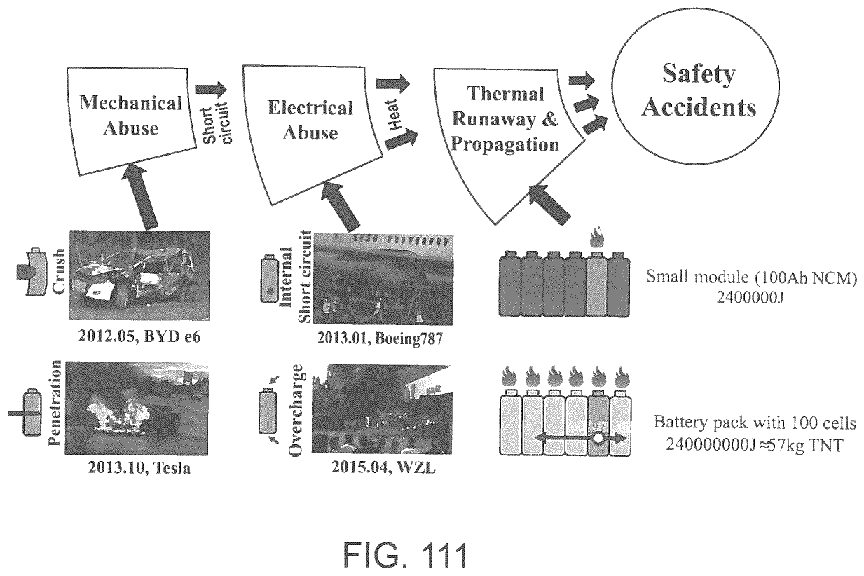

FIG. 111 is a graphic illustrating that the core problem of electric vehicle (EV) or electric drive vehicle (EDV) safety accidents involve battery thermal runaway.

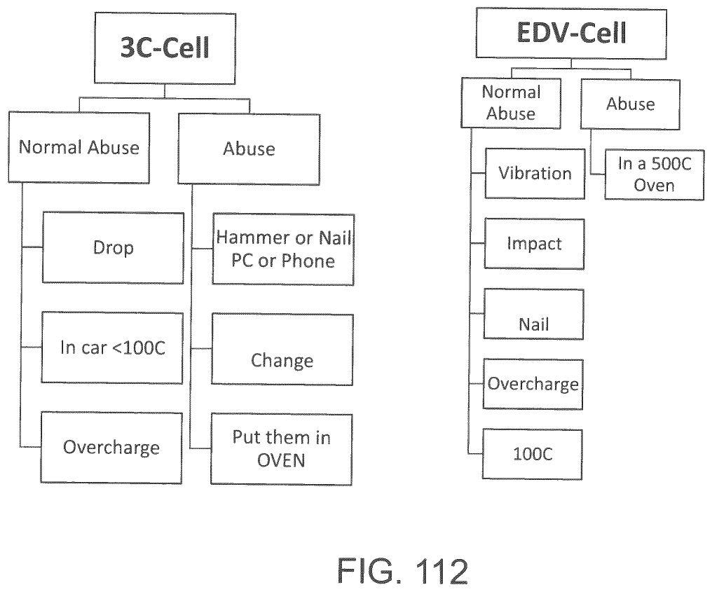

FIG. 112 is a graphic illustrating safety concerns for 3C Cell batteries and EDV batteries.

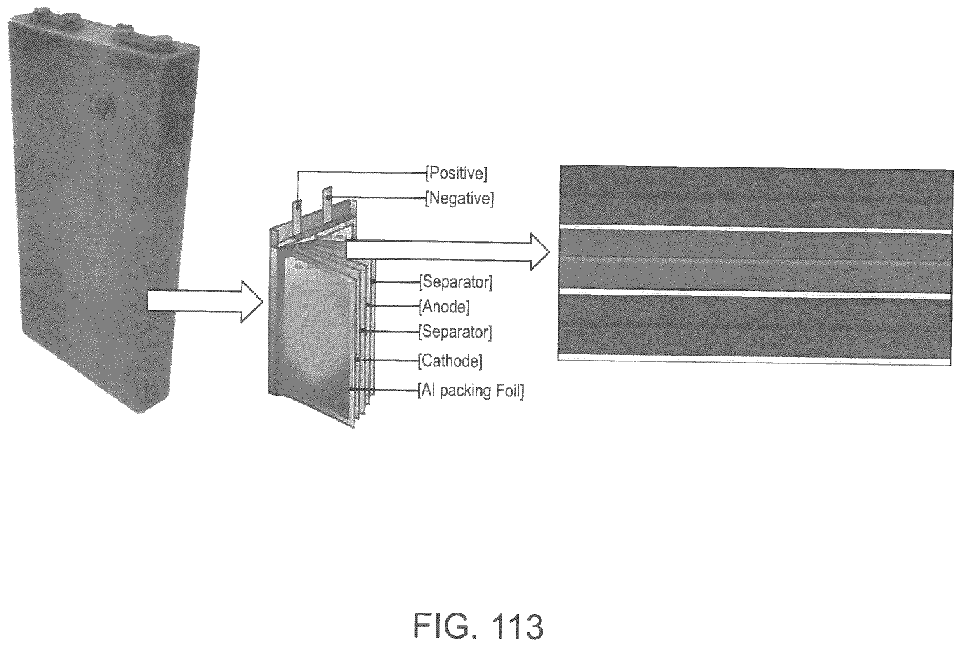

FIG. 113 is a graphic illustrating the internal structure of an EDV battery.

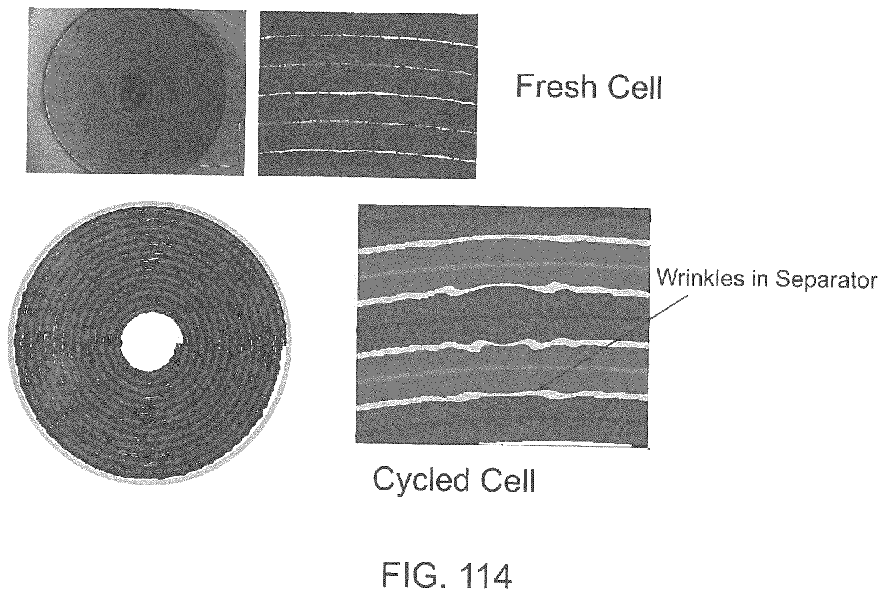

FIG. 114 is a graphic illustrating the internal structure of a new 3C battery and following cycling illustrating wrinkles in the battery separator.

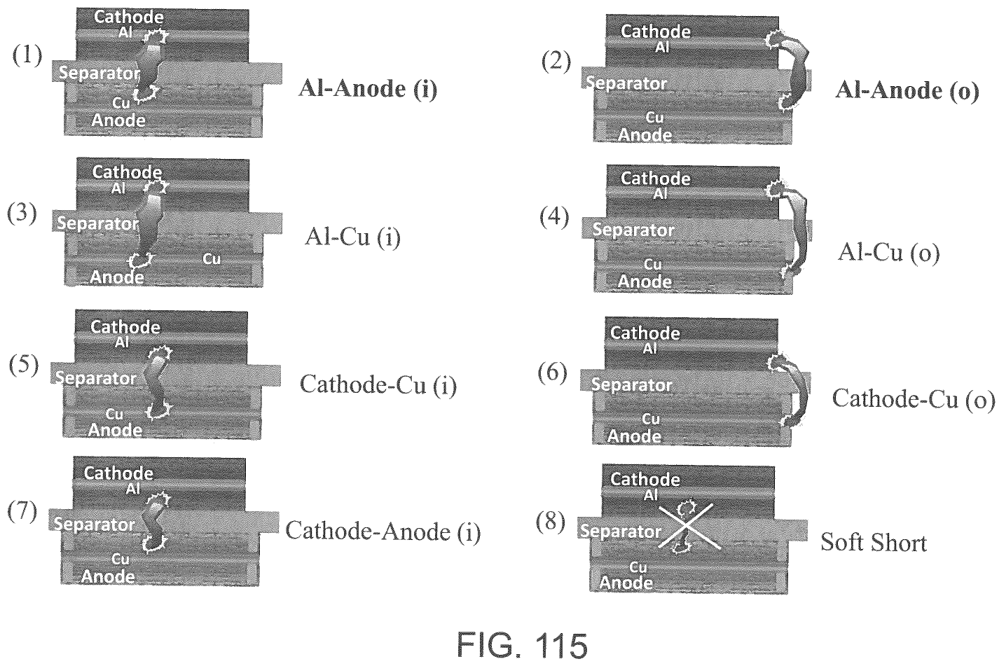

FIG. 115 is a graphic illustrating various cases of internal shorts in a lithium ion battery.

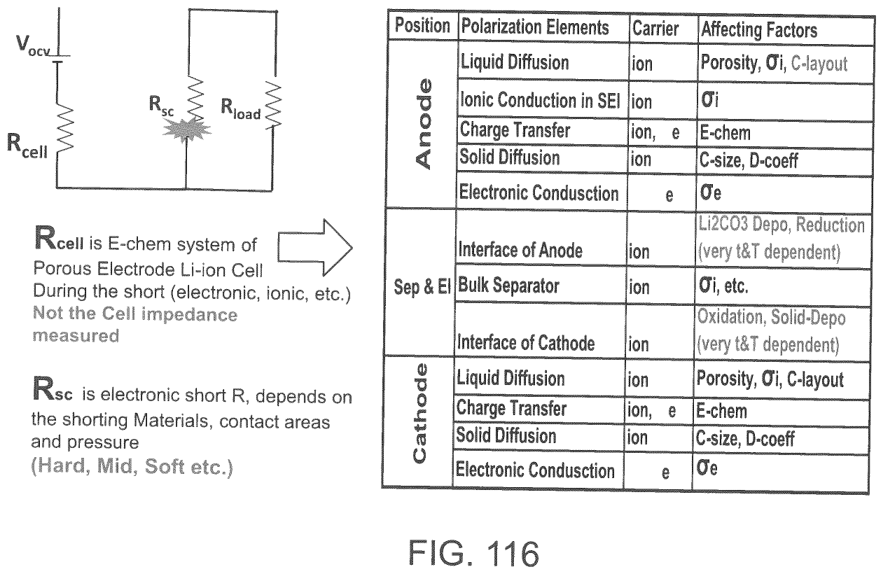

FIG. 116 is a graphic describing what an internal short in a lithium ion battery is and factors affecting internal shorts.

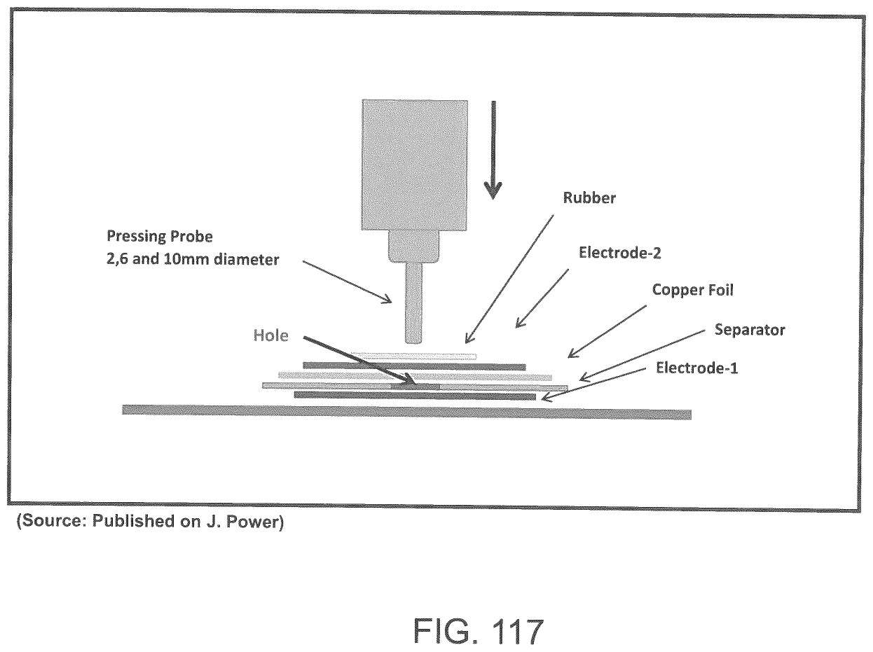

FIG. 117 is a graphic illustrating Rsc setup (Wet Charged Electrodes).

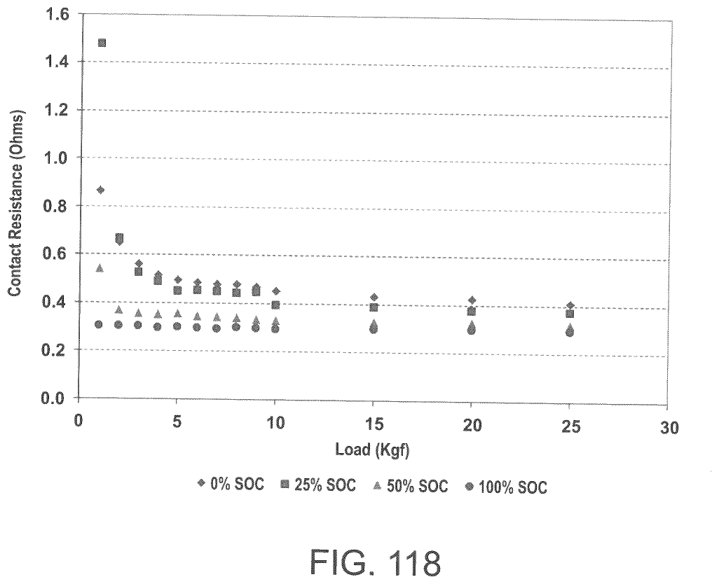

FIG. 118 is a graph of contact resistance versus load for a Anode-Cu (Al Rev to Li) battery at various states of charge (SOC).

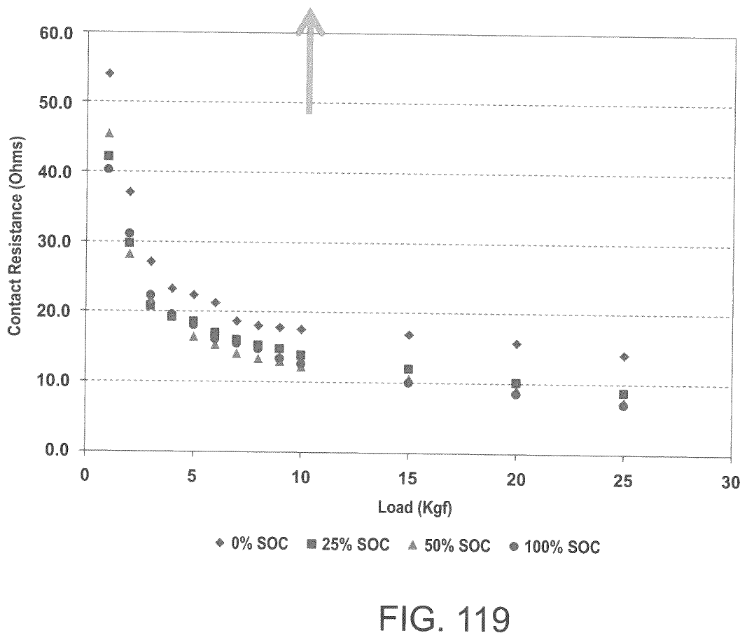

FIG. 119 is a graph of contact resistance versus load for a Anode-Cu-Cathode battery at various SOC.

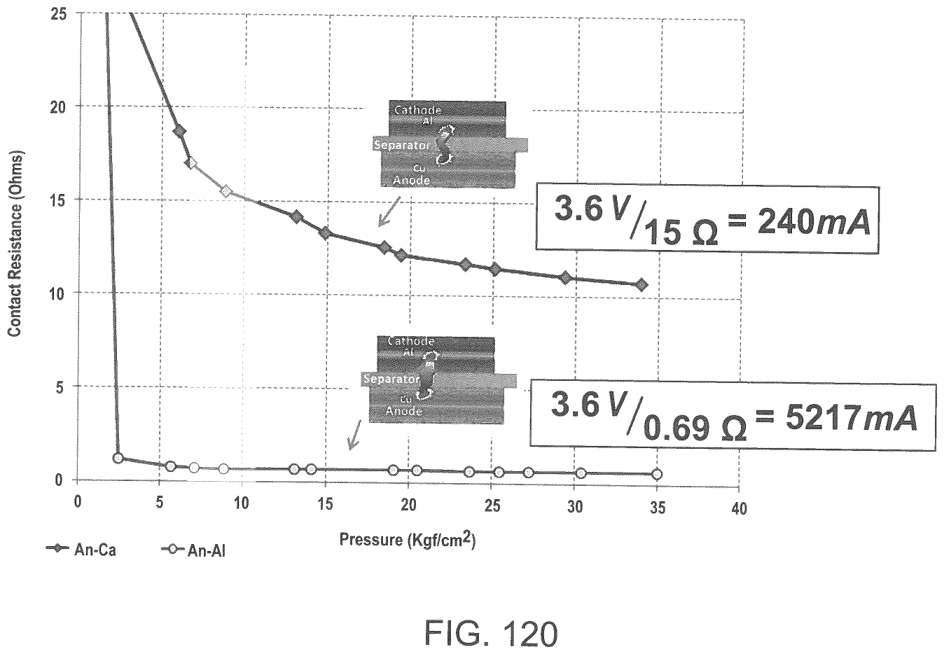

FIG. 120 is a graph of contact resistance versus pressure and possible short results for An-Ca and An-Al batteries.

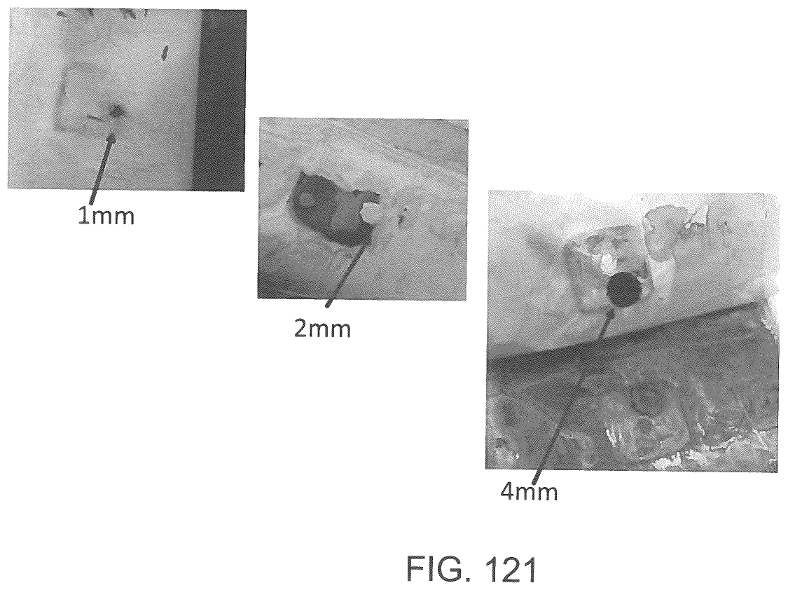

FIG. 121 are photos showing the growth of an Anode/Cathode Direct Short.

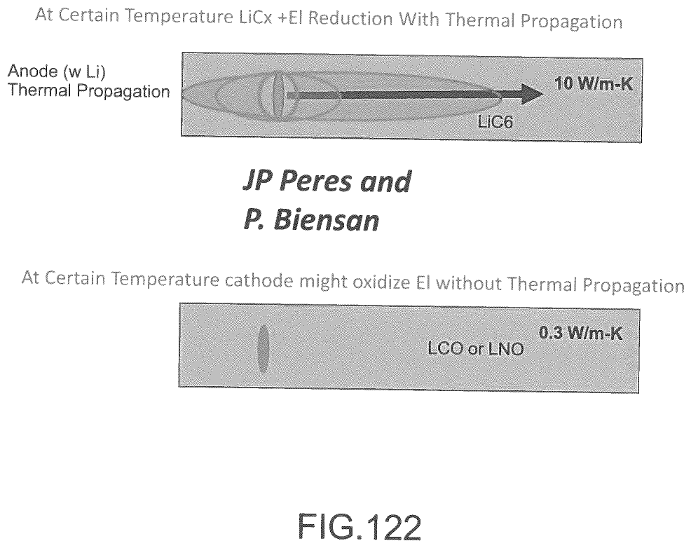

FIG. 122 is a graphic illustrating the use of laser induced point heat on electrodes to simulate an internal short (anode vs. cathode).

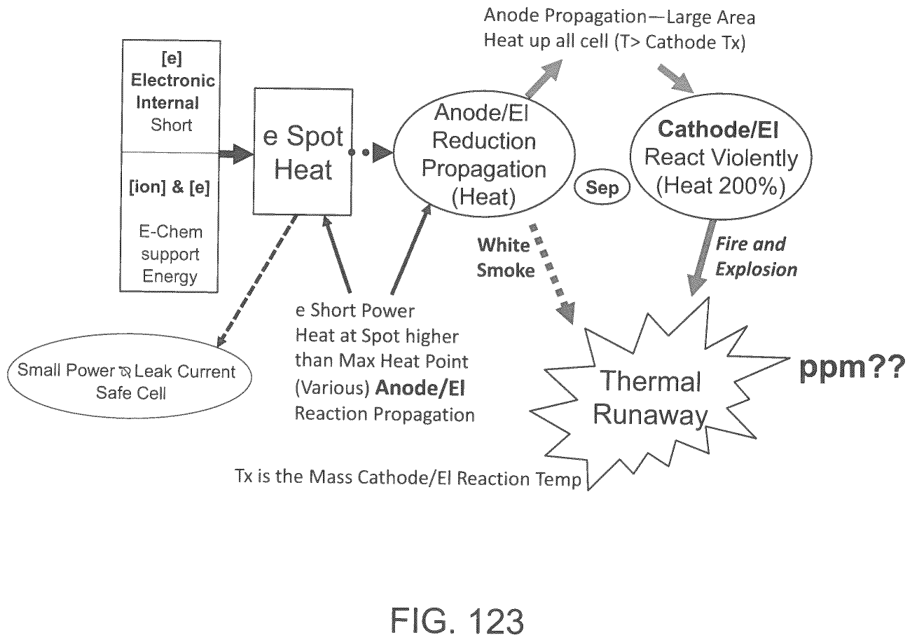

FIG. 123 is a graphic illustrating how an internal short can lead to thermal runaway.

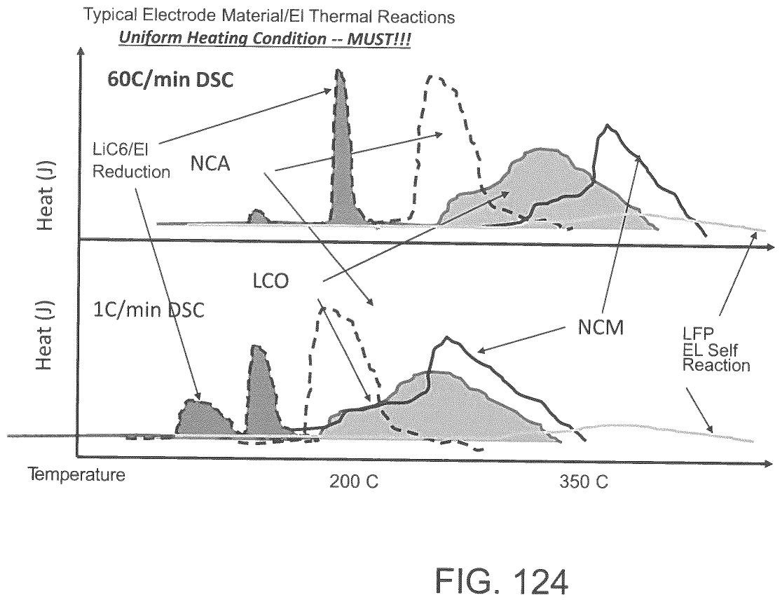

FIG. 124 illustrates Typical Electrode Material versus EI Thermal Reactions.

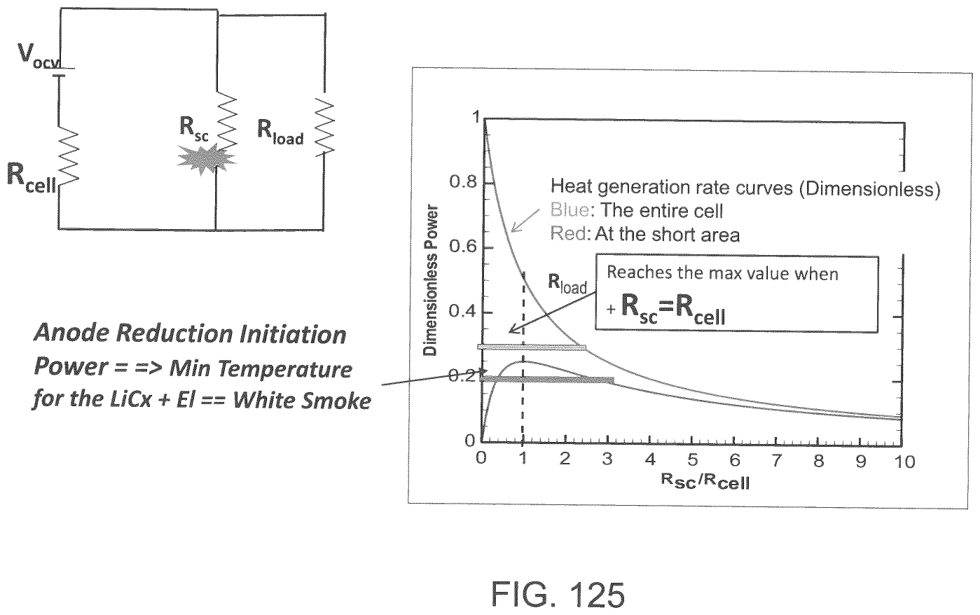

FIG. 125 illustrates heat generation at an internal short area or potential highest T at short spot.

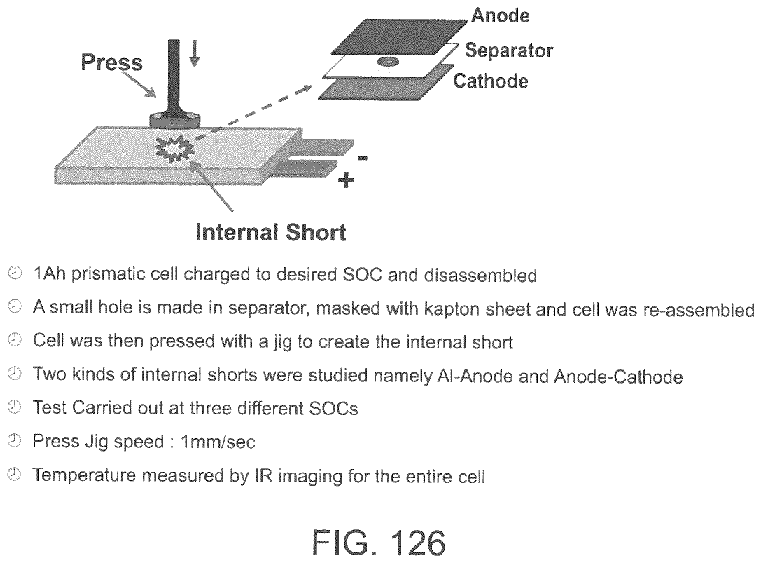

FIG. 126 illustrates a Controlled Internal Short test.

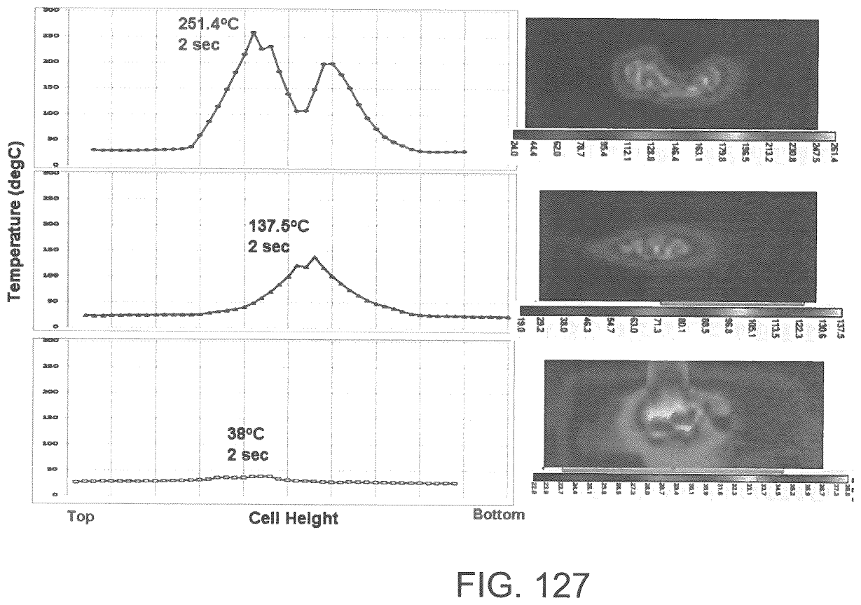

FIG. 127 illustrates thermal conduction across the cell (2 sec after internal short) by use of temperature versus cell height graphs.

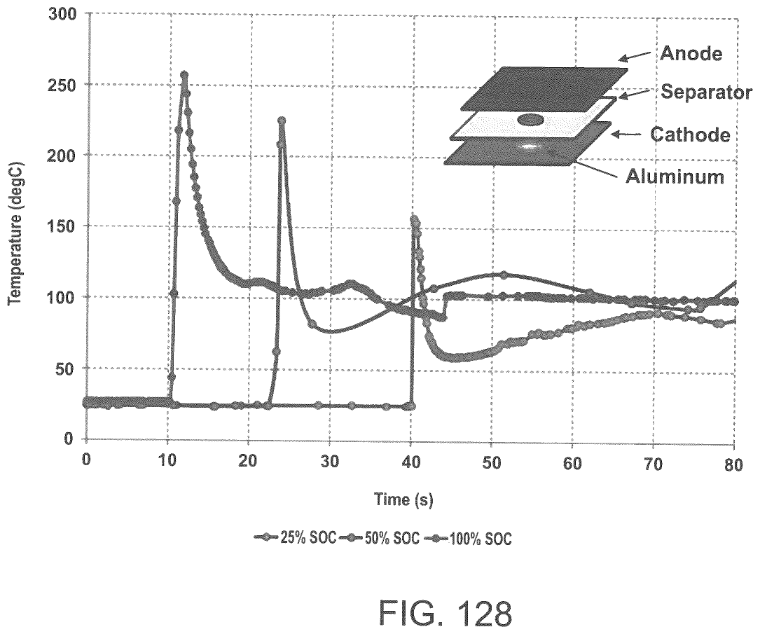

FIG. 128 is a graph of temperature versus time for an aluminum-anode battery short at different SOCs.

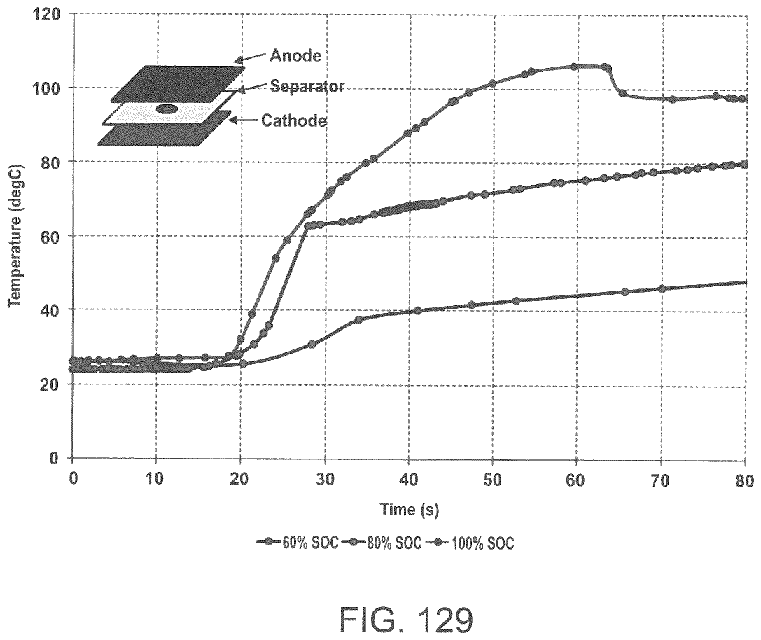

FIG. 129 is a graph of temperature versus time for an anode-cathode short at different SOCs.

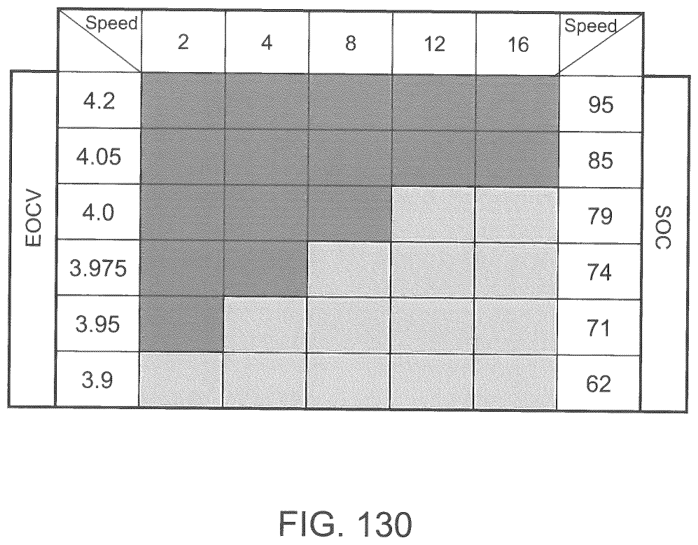

FIG. 130 is a graph illustrating 2.2Ah 18650 Cell Ball Test (EOCV, SOC vs Speed).

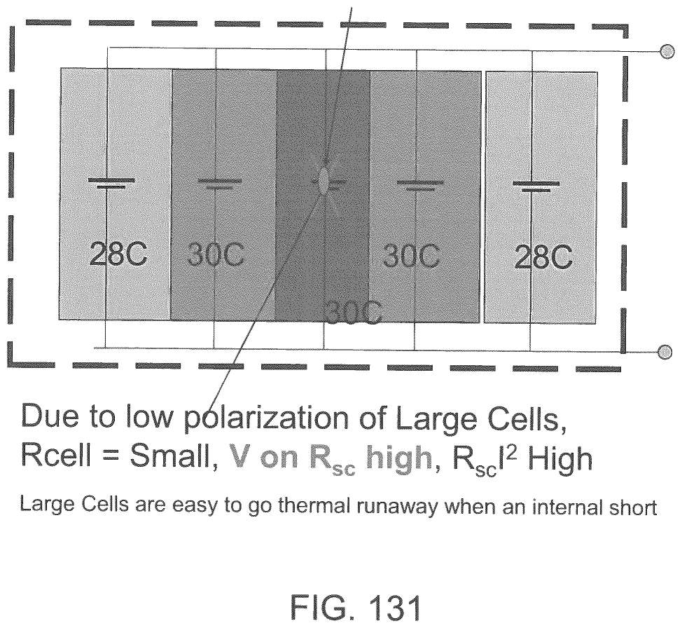

FIG. 131 is a graph illustrating internal e-Hard-SHORTED Large Cells.

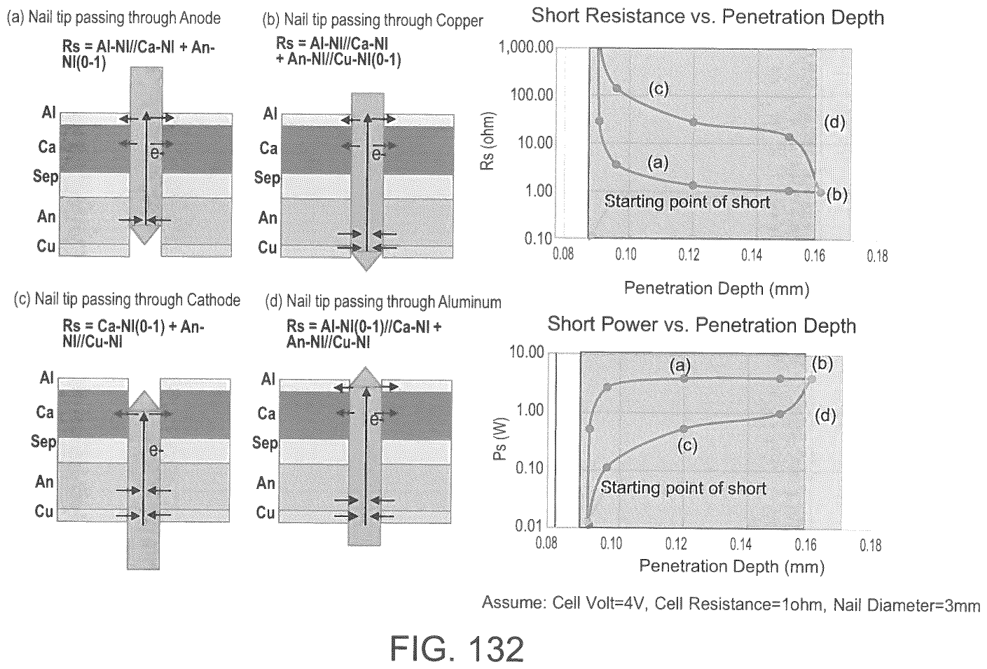

FIG. 132 is a graphic illustrating four basic modes of nail penetration.

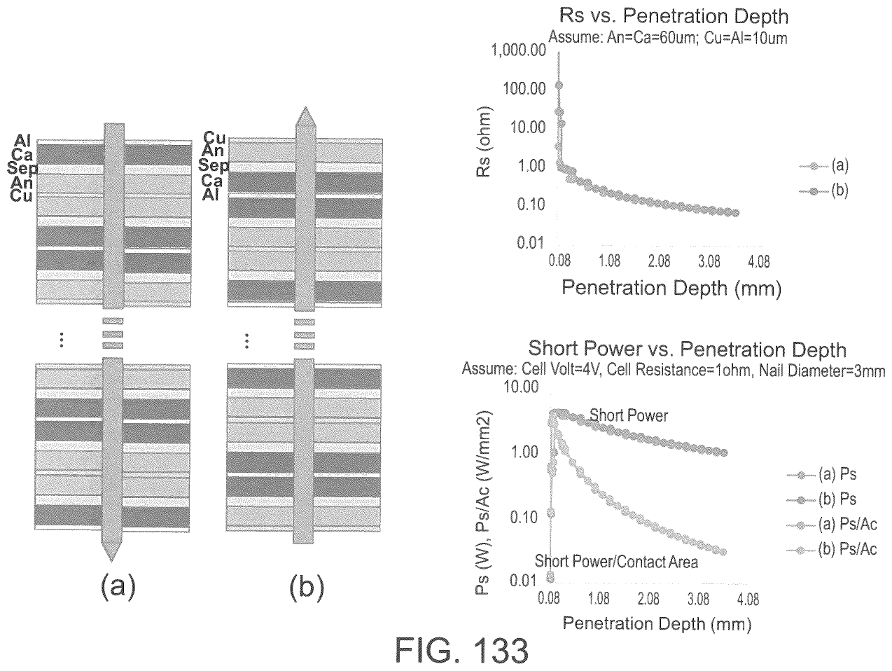

FIG. 133 is a graphic illustrating effects of nail penetration depth.

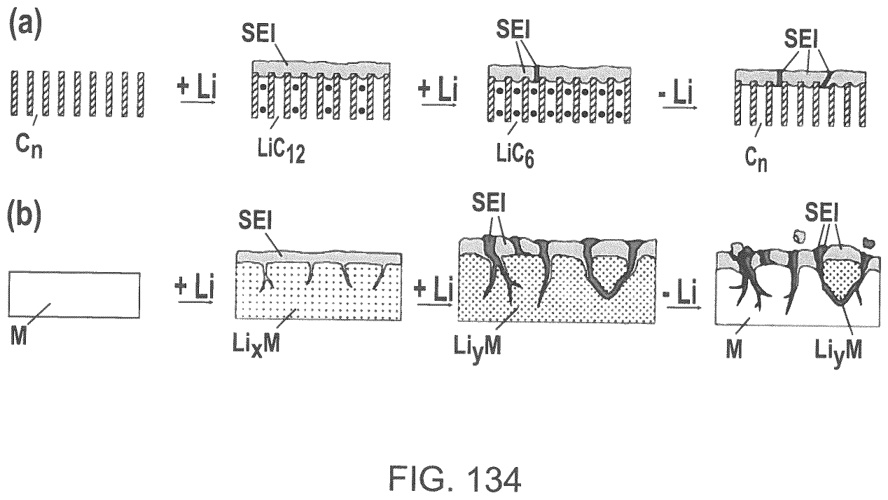

FIG. 134 is a graphic illustrating effects of lithium deposition.

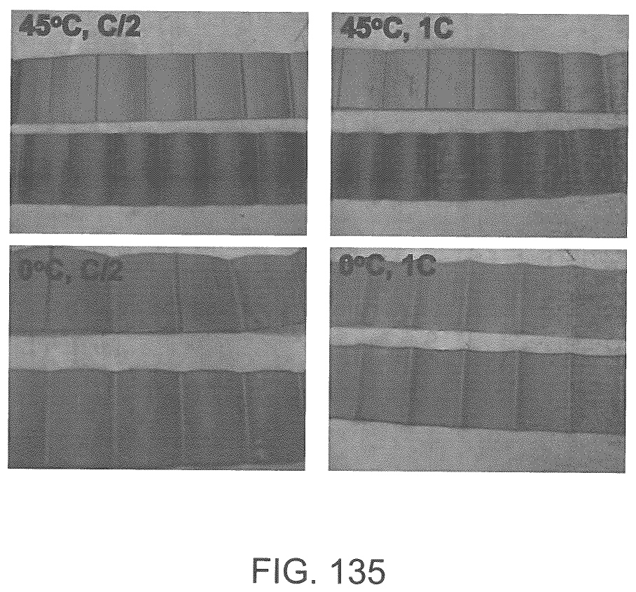

FIG. 135 are photos illustrating the effect of charge rate (cycling) and temperature on battery separators.

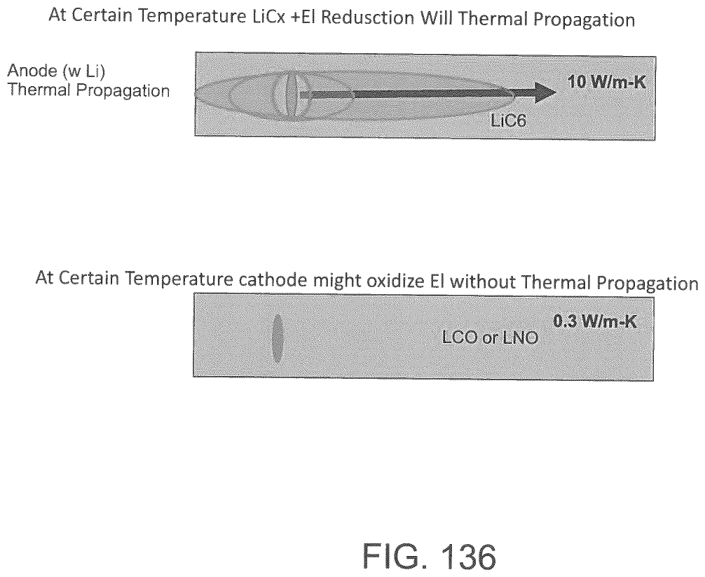

FIG. 136 is a graphic illustrating laser induced point heat on electrodes to simulate internal short (anode vs. cathode).

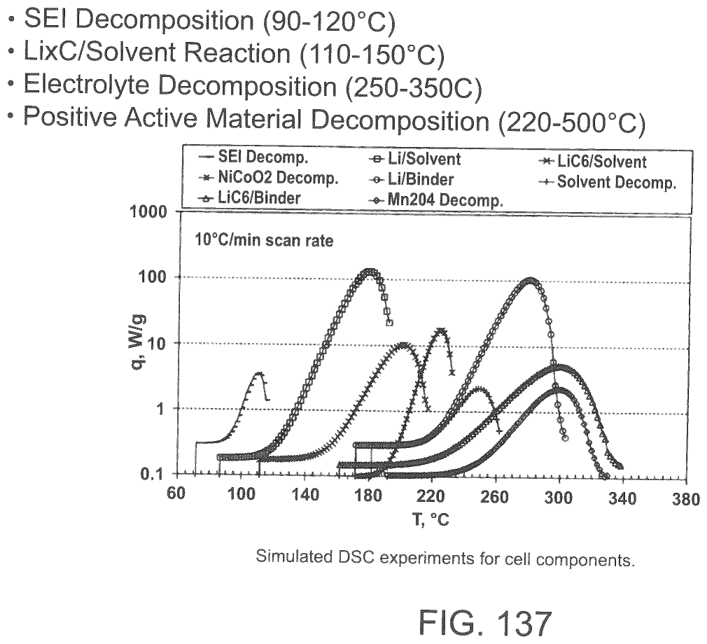

FIG. 137 is a graphic illustrating exothermic reactions considered in the simulation of FIG. 136.

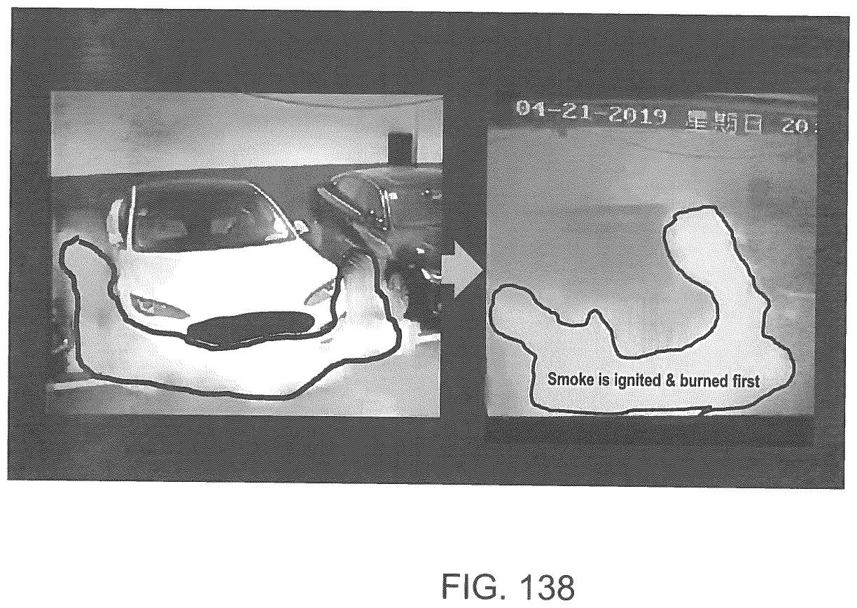

FIG. 138 includes a photo and temperature scan illustrating results of flammable smoke wherein the smoke is ignited and burned first.

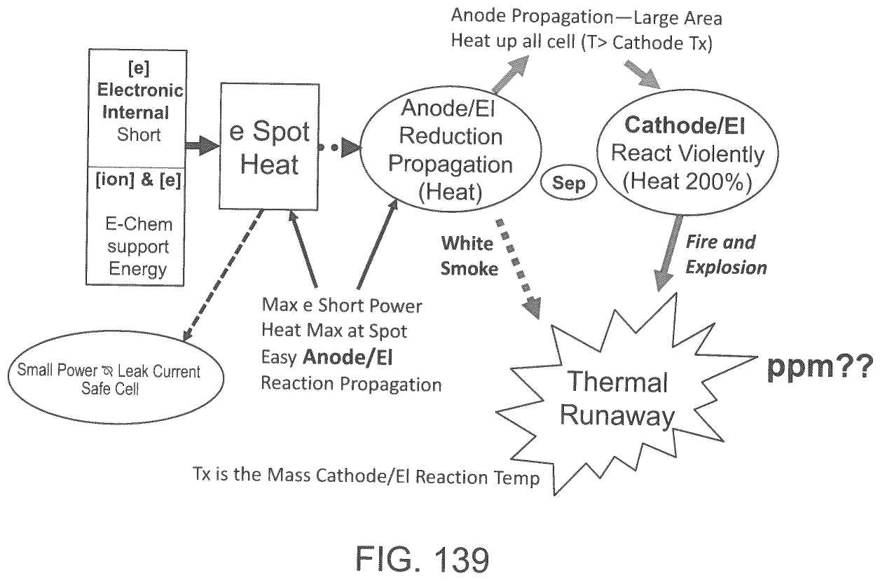

FIG. 139 is a graphic illustrating how an internal short can lead to thermal runaway.

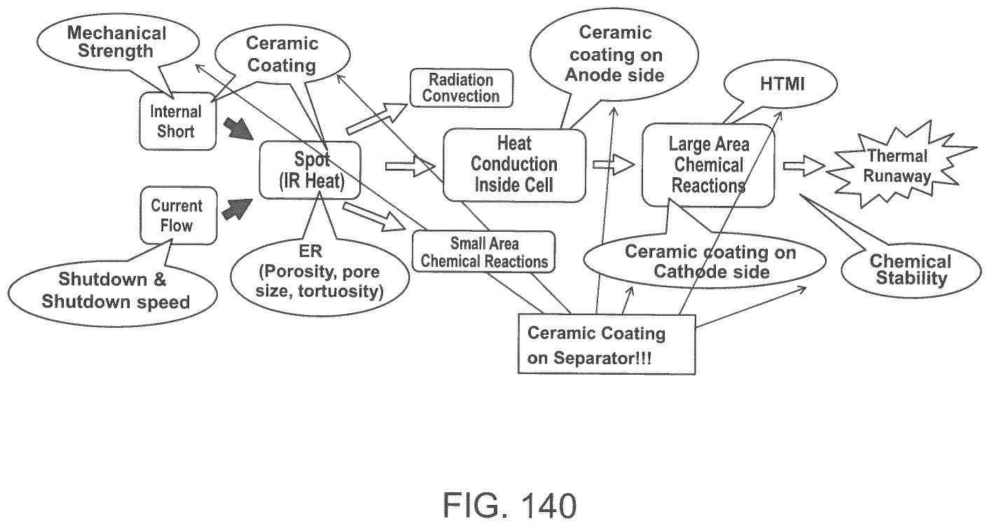

FIG. 140 is a graphic illustrating ceramic coated separator and internal short scenarios.

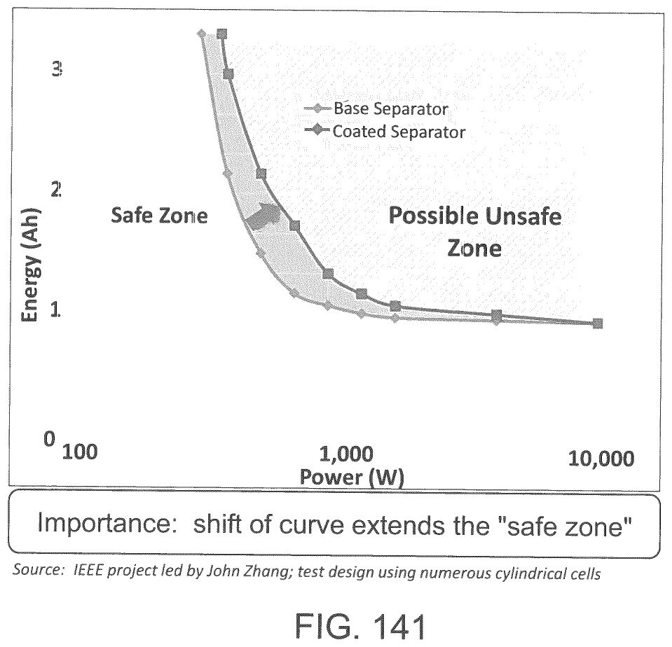

FIG. 141 is a graph of energy versus power showing BAJ test simulates nail tests on ceramic coated separator.

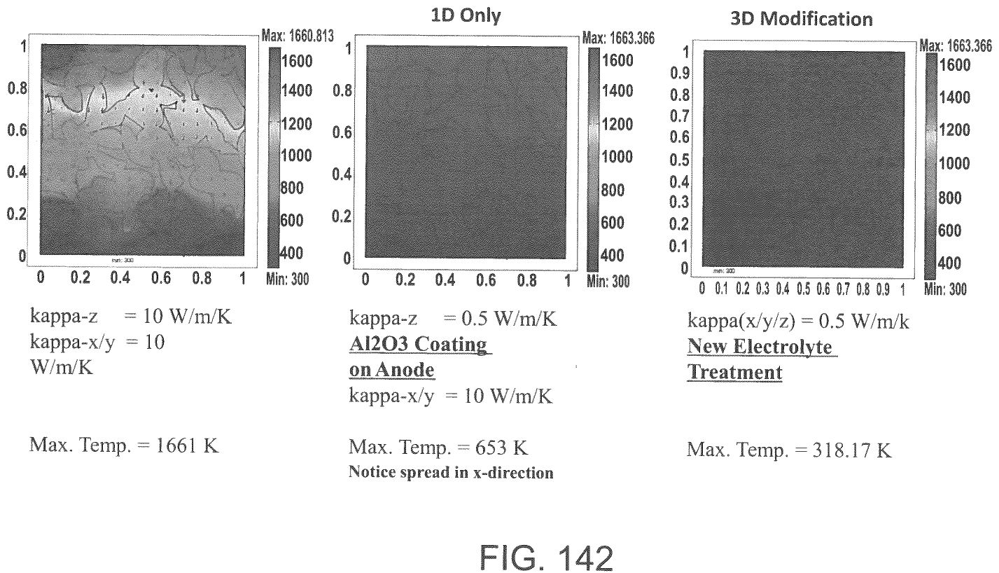

FIG. 142 is a graphic illustrating whether thermal conduction can reduce thermal propagation.

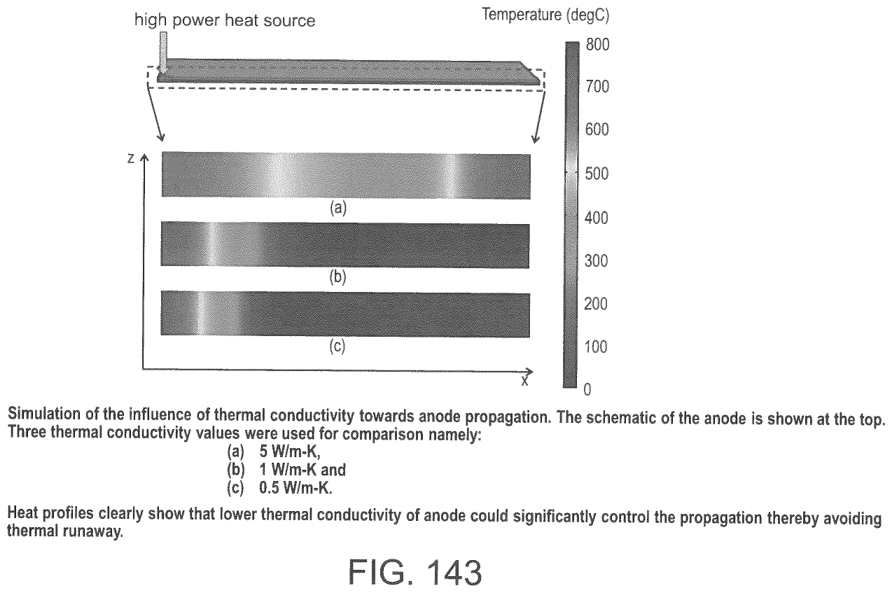

FIG. 143 is a graphic illustrating that ceramic coating on a separator is a much easier way to reduce anode propagation (facing anode or cathode). Simulation of the influence of thermal conductivity towards anode propagation. The schematic of the anode is shown at the top. Three thermal conductivity values were used for comparison namely: (a) 5 W/m-K, (b) 1 W/m-K and (c) 0.5 W/m-K. Heat profiles clearly show that lower thermal conductivity of anode could significantly control the propagation thereby avoiding thermal runaway.

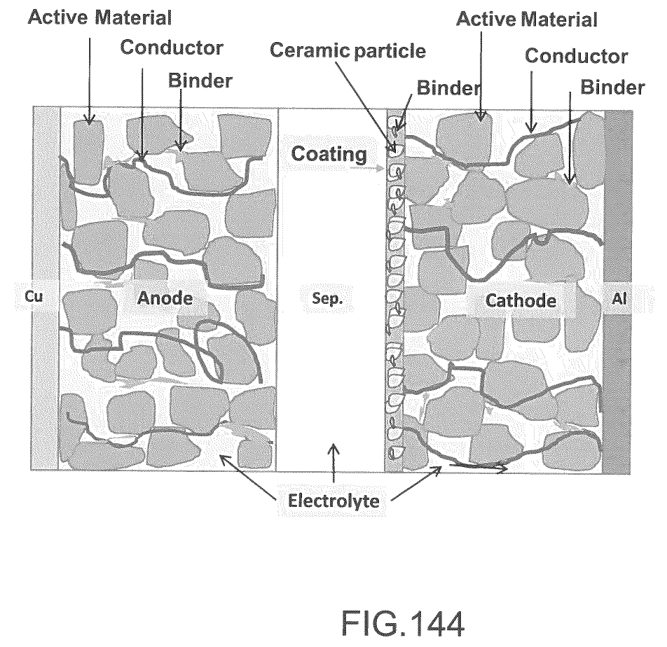

FIG. 144 is a graphic showing ceramic coating on separator/cathode-thin and oxidation resistive to cathode/separator interface.

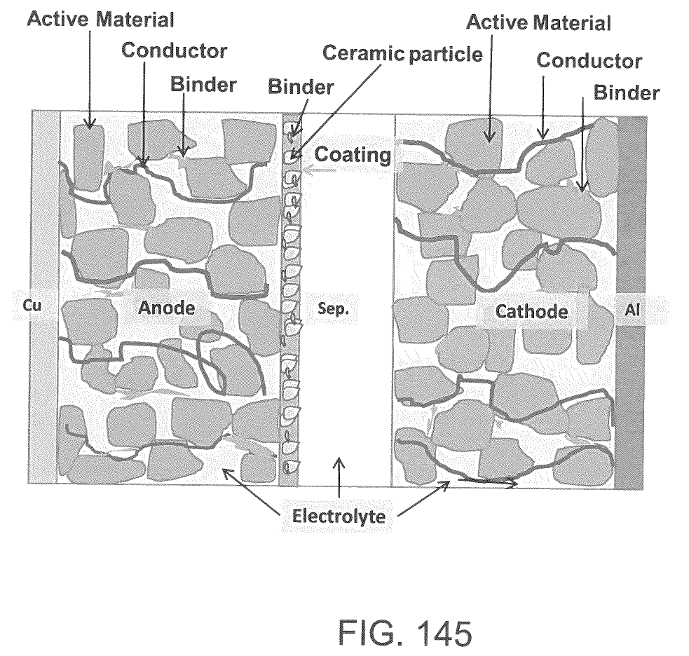

FIG. 145 is a graphic showing ceramic coating on separator/cathode-thin and lesser possibility of anode thermal propagation.

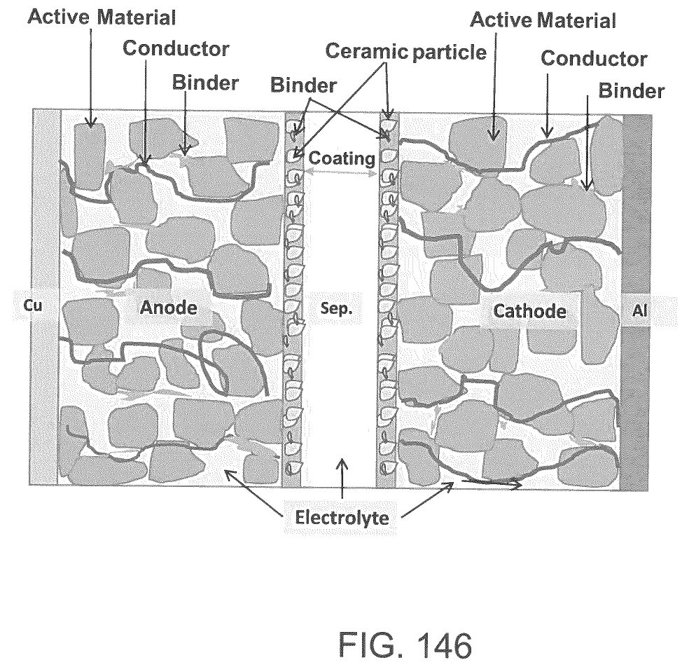

FIG. 146 is a graphic showing ceramic coating on both interfaces-oxidation resistance to cathode/separator interface and lesser anode propagation and possibly higher thickness and high ceramic cost.

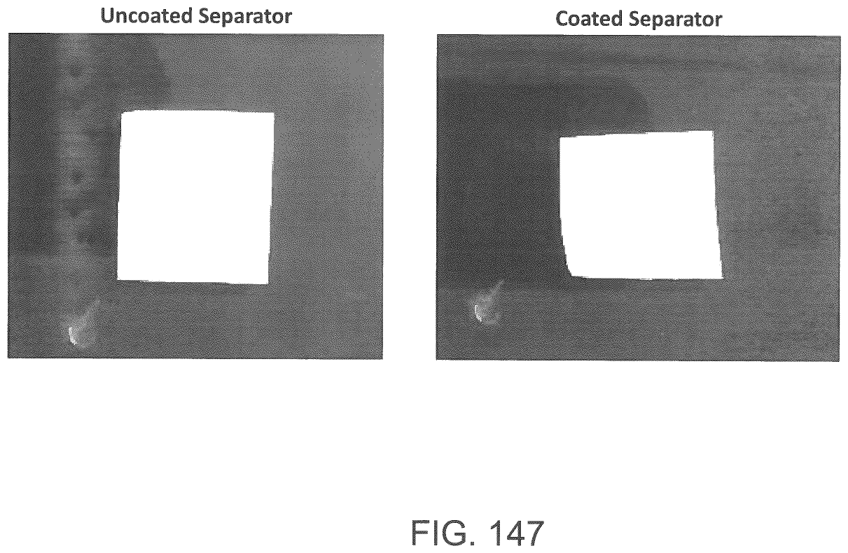

FIG. 147 includes photos illustrating the wettability of an uncoated separator versus a ceramic coated separator.

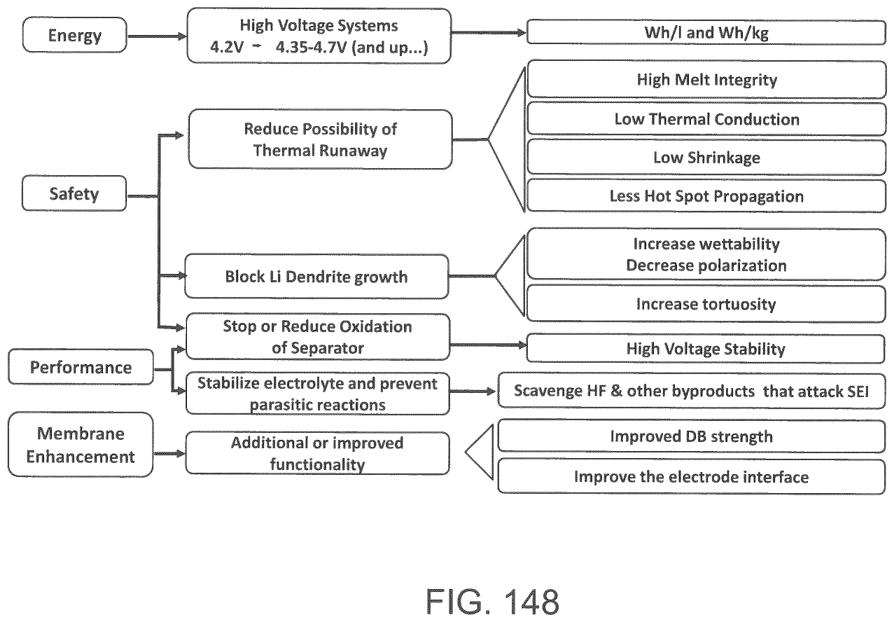

FIG. 148 illustrates the benefits on energy, safety, performance and membrane enhancement of ceramic coating on separators.

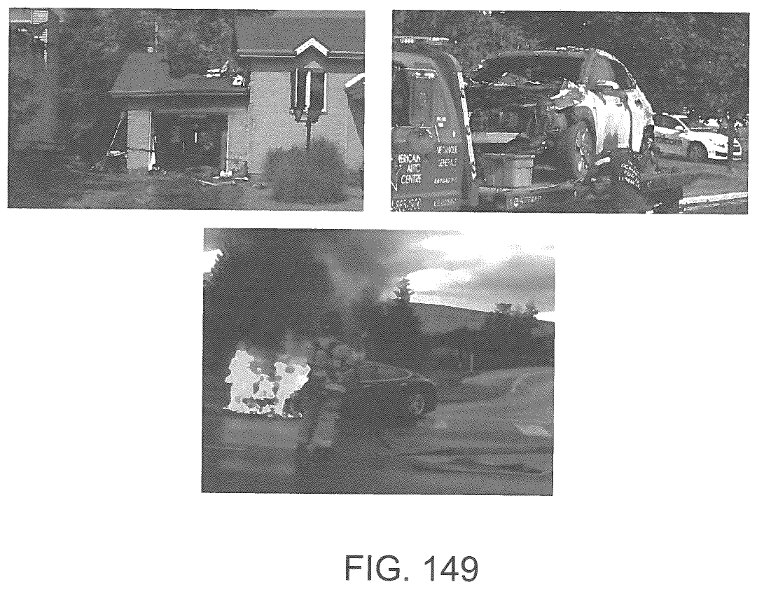

FIG. 149 are photos showing Canadian Kona explosion in a garage due to an th XYZ Li-ion battery.

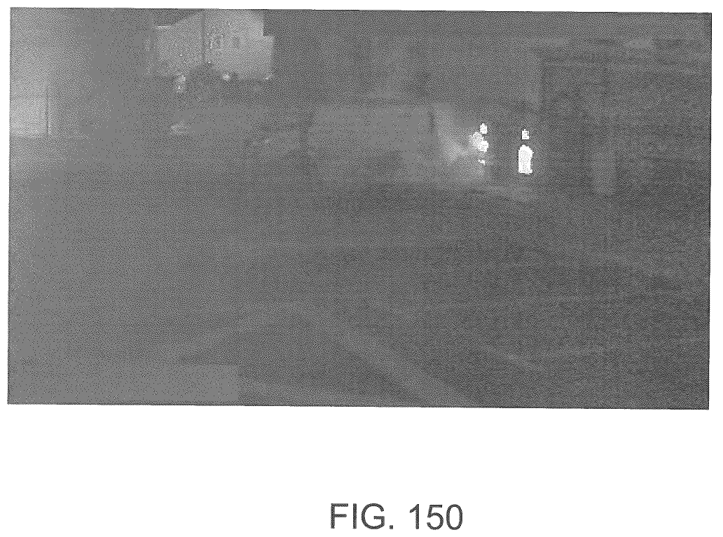

FIG. 150 is a photo showing EDV explosion and fire during battery charging.

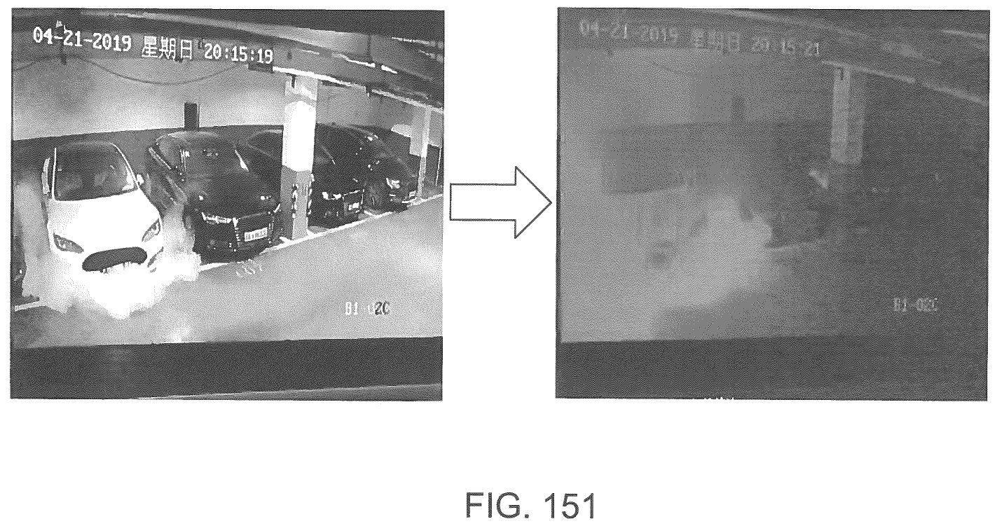

FIG. 151 are photos and a temperature scan showing EDV self-explosion and fire with white smoke-explosion and fire are located in the same area with white smoke.

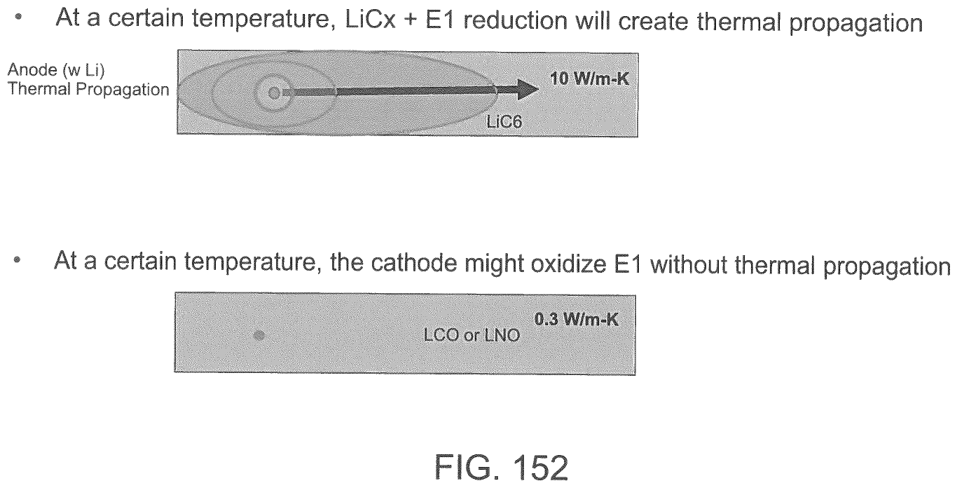

FIG. 152 illustrates laser induced point heat on electrodes to simulate internal short (Anode vs. Cathode) and showing that at a certain temperature, LiCx+E1 reduction will create thermal propagation and that at a certain temperature, the cathode might oxidize E1 without thermal propagation.

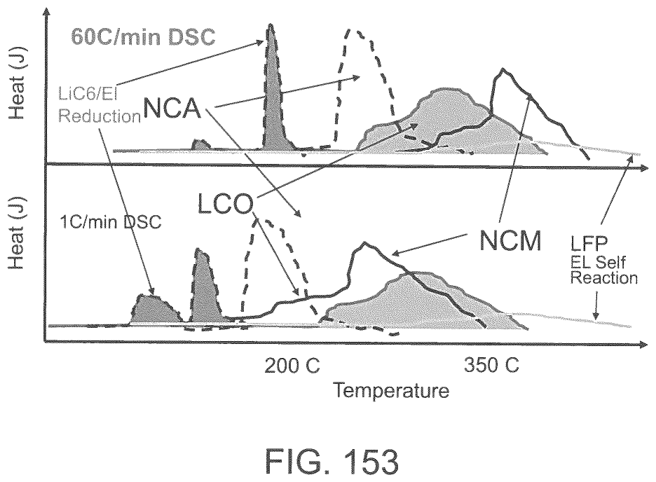

FIG. 153 are heat versus temperature graphs of typical electrode material E1 thermal reactions DSC or ARC showing uniform heating is required to prevent an internal short.

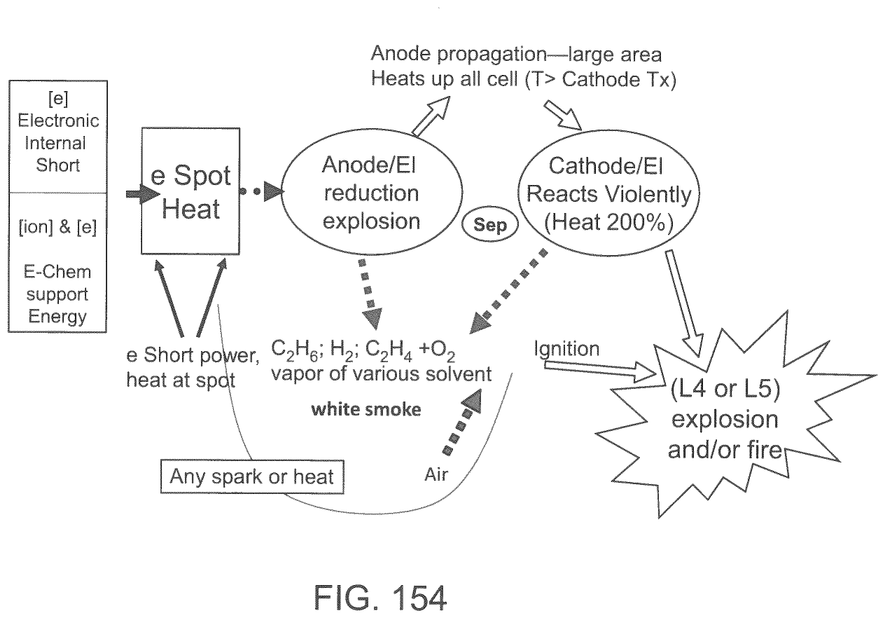

FIG. 154 is a graphic illustrating how an Internal Short of Normal Cell can lead to (L4 or L5) explosion and/or fire.

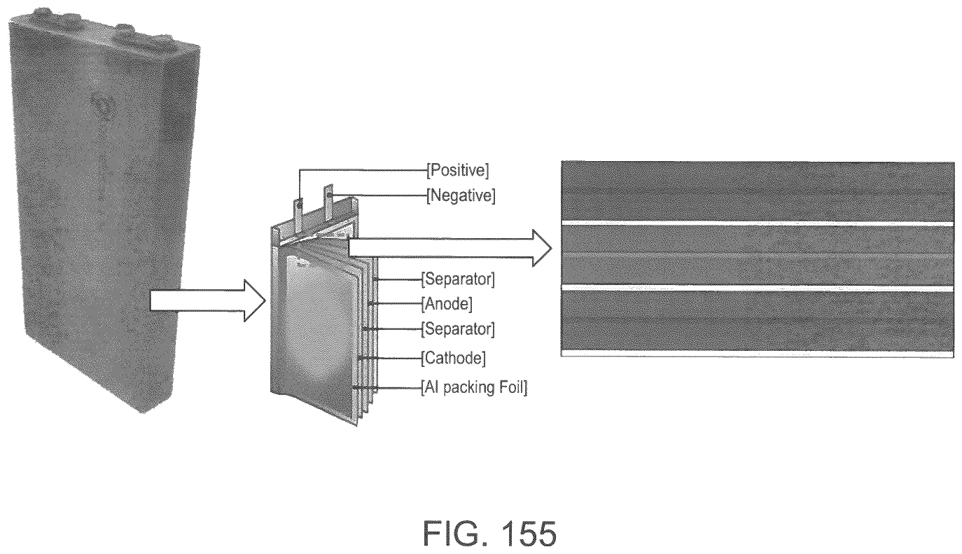

FIG. 155 illustrates the internal structure of a battery having a coated separator of the claimed invention.

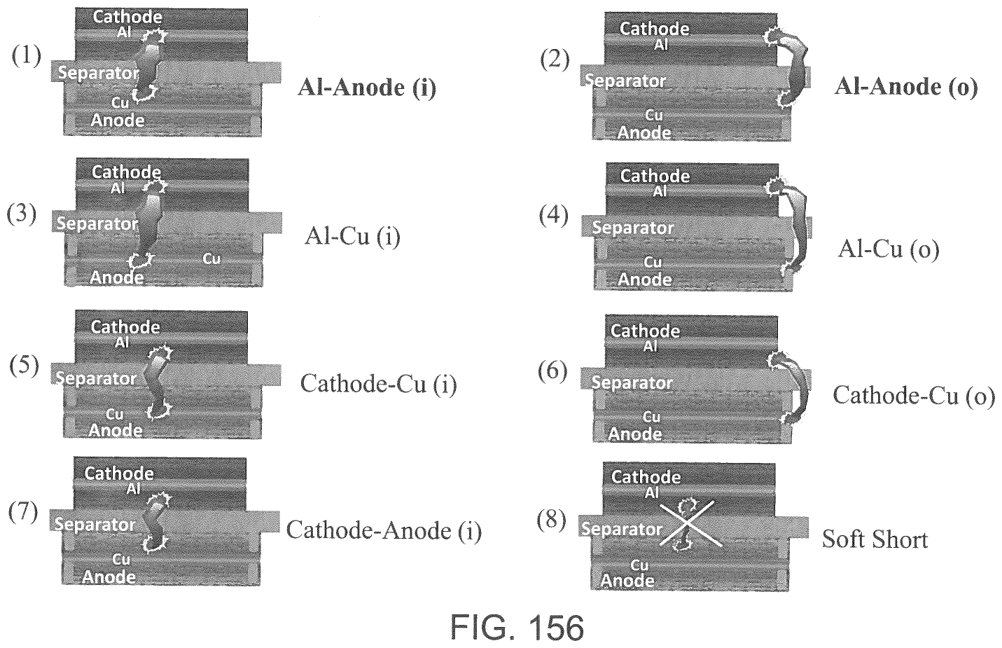

FIG. 156 illustrates various internal short scenarios.

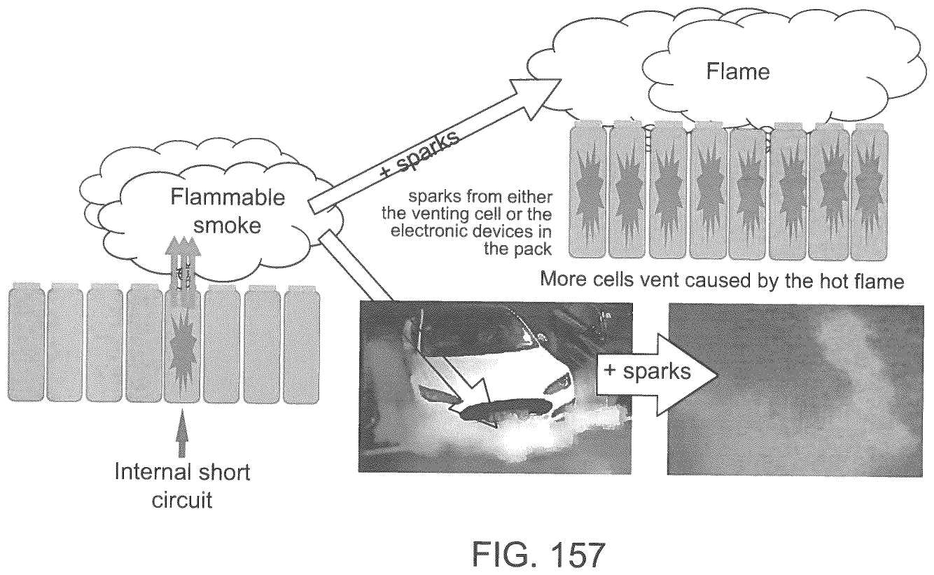

FIG. 157 is a graphic illustrating the failure mode of an internal short.

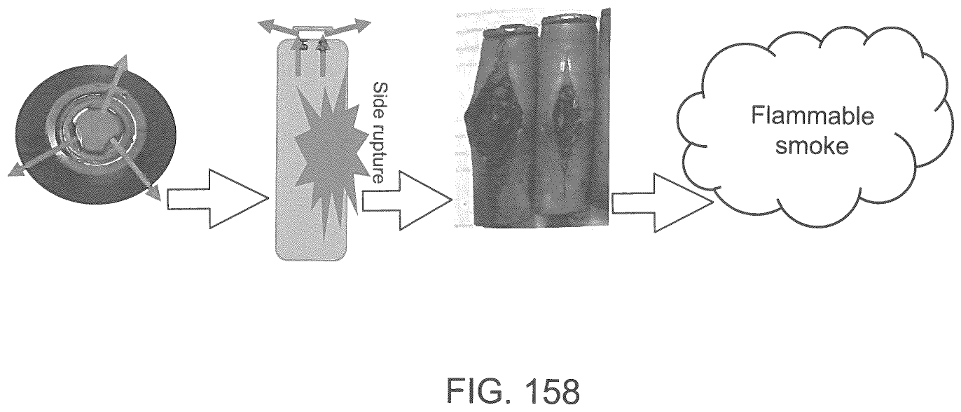

FIG. 158 includes photos and graphics illustrating smoke production in an 18650 battery.

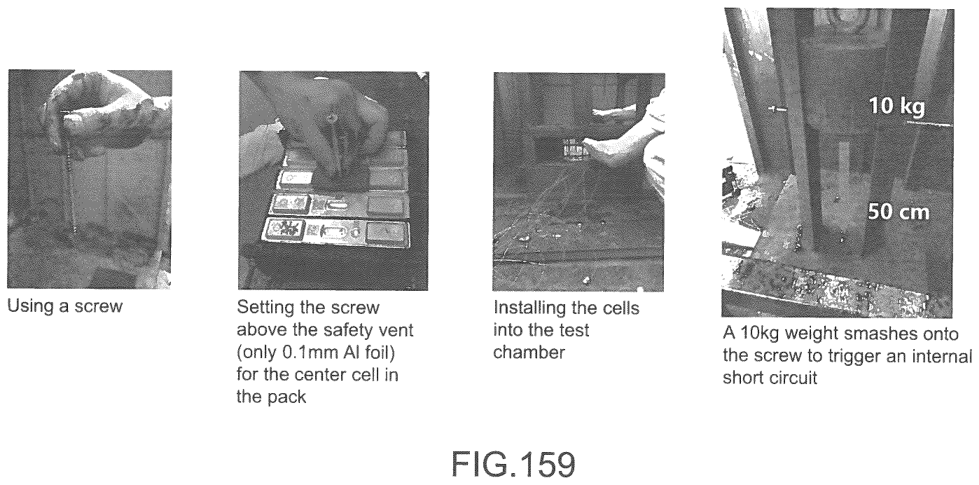

FIG. 159 illustrates use of a screw trigger to create an internal short circuit in a 5-cell pack.

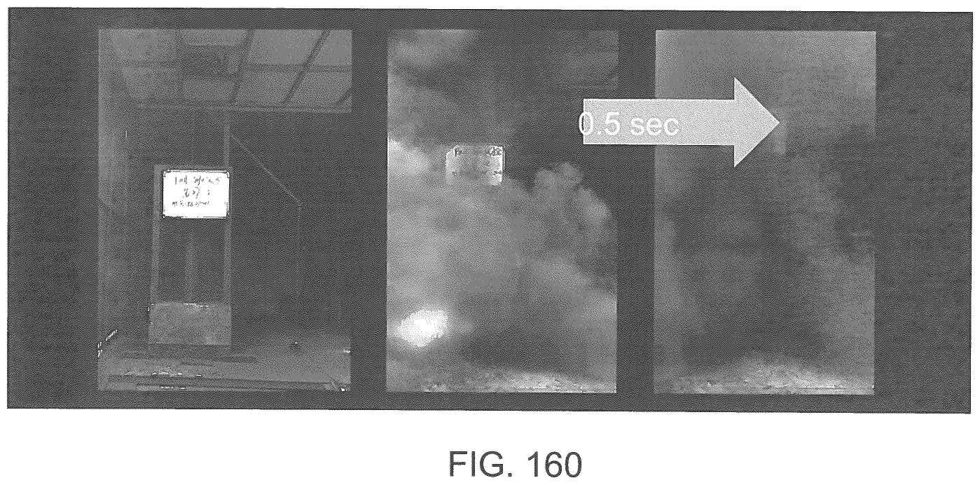

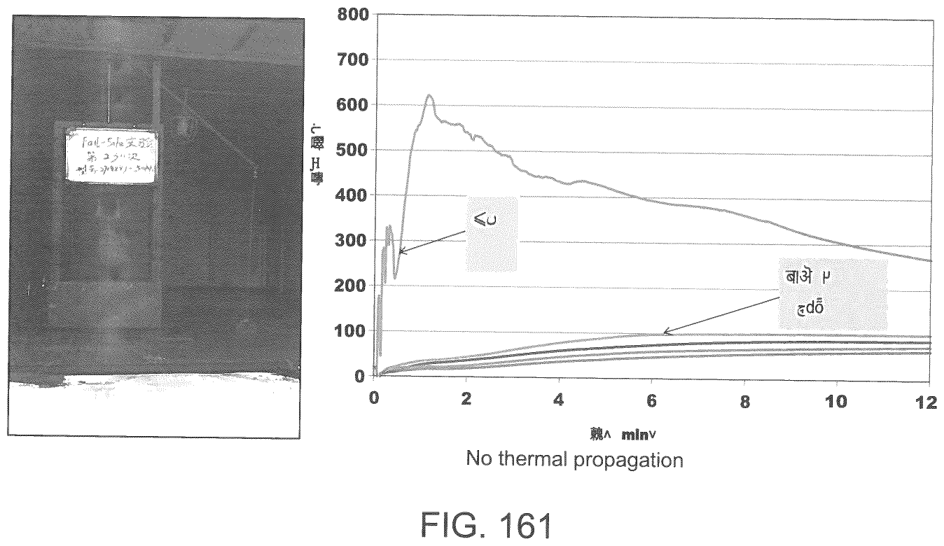

FIGS. 160 and 161 include photos of a nail penetration test showing that proprietary chemicals used achieve non-flammable smoke when a cell undergoes thermal runaway.

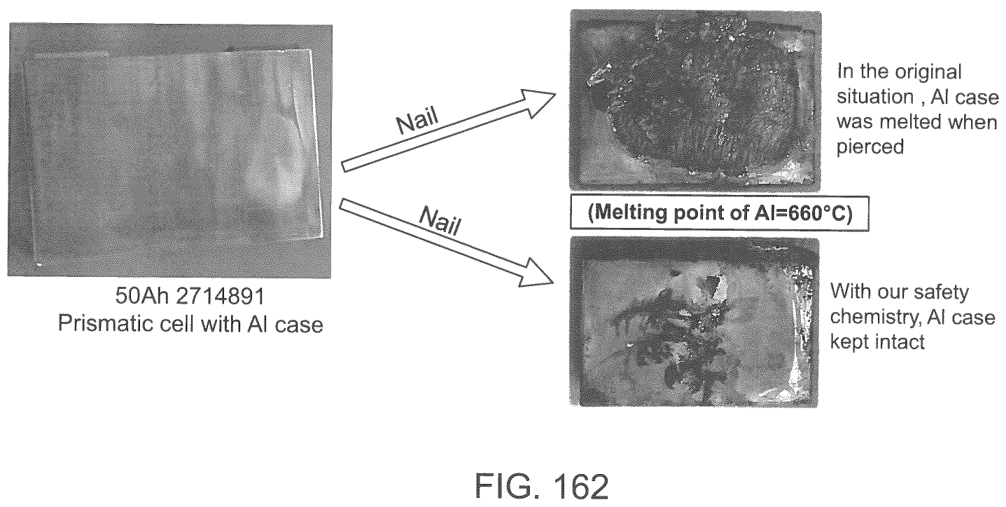

FIG. 162 illustrates the use of decreasing temperature wherein decreasing the cell temperature decreased the reaction intensity.

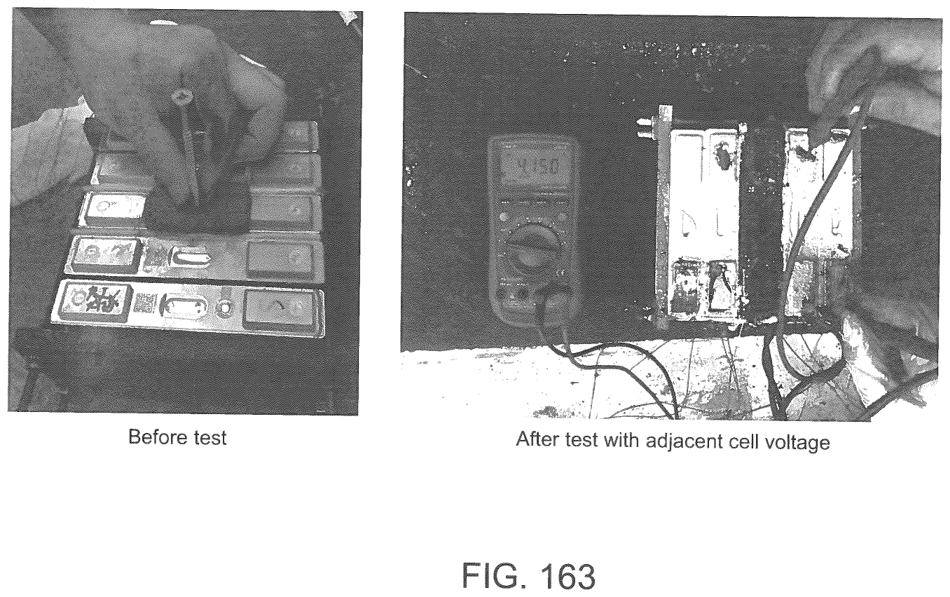

FIG. 163 illustrates a cell before and after screw penetration test.

The invention includes the following embodiments.

New or improved equipment or methods as provided, described or shown, for addressing the failure mode that thermal runaway cell emits flammable smoke; igniting the flammable smoke causes an EDV fire; and providing new or proprietary solutions, components, materials or chemicals, to achieve the following: non-flammable smoke can be generated during cell thermal runaway resulting in smoke only, cell reaction strength is reduced by dropping Tmax for the reaction, and/or thermal-propagation can be prevented, whereby many EDV and ESS fires may be prevented and safe EDVs and ESSs may be possible.

The new equipment or method for addressing the failure mode wherein said solutions, components, materials or chemicals can be used in many locations, in suppression systems, or both.

The new equipment or method for addressing the failure mode wherein said solutions, components, materials or chemicals, may comprise: water+fumed silica, fumed silica coatings, water+alumina, alumina coatings, dispersible materials or ceramics (with or without water, polymers, binders, etc.) to absorb or reduce heat and/or energy, to coat or encapsulate problem areas, cells or batteries, to dilute flammable gases (hydrogen) with particles, CO₂, or nitrogen, to limit unstable reduction at the anode, to reduce, delay or eliminate fires, and/or combinations thereof.

The new equipment or method for addressing the failure mode wherein said solutions, components, materials or chemicals can be used in many locations, in batteries, on batteries, in battery packs (above, below or around the cells), in suppression or extinguishing systems, devices, or components, to prevent or suppress EDV or ESS lithium battery or lithium ion battery fires and/or explosions, pack design for spark suppression, flammable gas dilution, hot gas heat removal or dissipation, and/or combinations thereof.

The new equipment or method for addressing the failure mode wherein said solutions, components, materials or chemicals, may comprise: a lithium battery fire extinguisher or suppression system and may include an aqueous composition or solution of water+fumed silica, fumed silica coatings, water+alumina solution, alumina coatings, dispersible materials or ceramics (with or without water, polymers, or binders) to absorb or reduce heat and/or energy, to coat or encapsulate problem areas, cells, or batteries, to dilute flammable gases (such as hydrogen containing gases produced by unstable reduction at the anode) with particles, CO₂, or nitrogen, to avoid combustion, to reduce, delay or eliminate fires, to extinguish or suppress fires, to avoid explosions, and/or combinations thereof.

The new equipment or method for addressing the failure mode wherein said solutions, components, materials or chemicals, may comprise: an improved fire extinguisher or fire suppression system is filled with a gel, mixture or solution under pressure, such as a fumed silica, water, and CO₂ solution, mixture or gel. When sprayed on a hot, smoking, or sparking area, or on a fire area on batteries, cells, device, or vehicle, the silica gel covers the problem area, isolates it from O₂, reduces the heat, dilutes the flammable gas, prevents fire, extinguishes fire, and/or the like.

The new equipment or method for addressing the failure mode wherein said solutions, components, materials or chemicals, may achieve: non-flammable smoke can be generated during cell thermal runaway resulting in smoke only; cell reaction strength is reduced by dropping Tmax for the reaction, and thermal-propagation can be prevented.

New or improved separators (or SSE) can be coated, treated, or manufactured to have iodine (I) or lithium iodide (LiI) at the surface adjacent at least one electrode or adjacent both electrodes, such as vapor deposition can be used to put iodine on Li Iodine on at least one separator surface adjacent the anode, such may be especially helpful with Li metal anodes, Li alloy anodes, Li sulfur anodes, or graphite anodes, the Iodine can react with lithium to form LiI layer or SEI to protect the SSE, or electrolyte, from the anode (especially at μA higher than stability), and/or such layers, thin films or coatings can be used adjacent the cathode, such as by using these proprietary layers or treatments, can avoid generation of flammable gasses (or at least combustible levels of such gases), heat, fires, and/or the like, and many EDV and ESS fires may be prevented and safe EDVs and ESSs may be possible.

New or improved separators (or SSE) can be coated, treated, or manufactured to have iodine (I), lithium iodide (LiI), Li halide, Li oxide, LiOxF, silver iodide, LiMgOx, LiMgOxF, AgILiMgO4S+, solid state electrolyte materials or particles, or other ceramic coating or thin film adjacent the cathode and/or the anode, such as vapor deposition can be used to put the coating, treatment, or thin film on the separator or SSE surface.

New or improved equipment, materials or chemicals can be used in many locations, in suppression systems, and/or the like, such as in a battery pack a layer of Si oxide, silica gel, water+fumed silica, fumed silica coatings, water+alumina, alumina coatings, Al gel, dispersible materials or ceramics (with or without water, polymers, or binders), nitrogen producing materials, CO₂ producing materials, heat absorbing materials, and/or the like can be placed below the cells or batteries, over the cells or batteries, and/or around the cells or batteries for spark suppression, to absorb or reduce heat and/or energy, to dry out the gel, to evaporate water, to coat or encapsulate problem areas, cells, batteries, to dilute flammable gases (hydrogen) with particles, CO₂, or nitrogen, to isolate the cells or batteries from O₂, to reduce, delay or eliminate fires or explosions, and/or combinations thereof. The invention also includes the following embodiments.

New or improved equipment or methods as provided, described or shown, for addressing the failure mode that thermal runaway cell emits flammable smoke; igniting the flammable smoke causes an EDV fire; and providing new or proprietary solutions, components, materials or chemicals, to achieve the following: non-flammable smoke can be generated during cell thermal runaway resulting in smoke only, cell reaction strength is reduced by dropping Tmax for the reaction, and/or thermal-propagation can be prevented, whereby many EDV and ESS fires may be prevented and safe EDVs and ESSs may be possible.

The new equipment or method for addressing the failure mode wherein said solutions, components, materials or chemicals can be used in many locations, in suppression systems, or both.

The new equipment or method for addressing the failure mode wherein said solutions, components, materials or chemicals, may comprise:water+fumed silica, fumed silica coatings, water+alumina, alumina coatings, dispersible materials or ceramics (with or without water, polymers, binders, etc.) to absorb or reduce heat and/or energy, to coat or encapsulate problem areas, cells or batteries, to dilute flammable gases (hydrogen) with particles, CO₂, or nitrogen, to limit unstable reduction at the anode, to reduce, delay or eliminate fires, and/or combinations thereof.

The new equipment or method for addressing the failure mode wherein said solutions, components, materials or chemicals can be used in many locations, in batteries, on batteries, in battery packs (above, below or around the cells), in suppression or extinguishing systems, devices, or components, to prevent or suppress EDV or ESS lithium battery or lithium ion battery fires and/or explosions, pack design for spark suppression, flammable gas dilution, hot gas heat removal or dissipation, and/or combinations thereof.

The new equipment or method for addressing the failure mode wherein said solutions, components, materials or chemicals, may comprise: a lithium battery fire extinguisher or suppression system and may include an aqueous composition or solution of water+fumed silica, fumed silica coatings, water+alumina solution, alumina coatings, dispersible materials or ceramics (with or without water, polymers, or binders) to absorb or reduce heat and/or energy, to coat or encapsulate problem areas, cells, or batteries, to dilute flammable gases (such as hydrogen containing gases produced by unstable reduction at the anode) with particles, CO₂, or nitrogen, to avoid combustion, to reduce, delay or eliminate fires, to extinguish or suppress fires, to avoid explosions, and/or combinations thereof.

The new equipment or method for addressing the failure mode wherein said solutions, components, materials or chemicals, may comprise: an improved fire extinguisher or fire suppression system is filled with a gel, mixture or solution under pressure, such as a fumed silica, water, and CO₂ solution, mixture or gel. When sprayed on a hot, smoking, or sparking area, or on a fire area on batteries, cells, device, or vehicle, the silica gel covers the problem area, isolates it from O₂, reduces the heat, dilutes the flammable gas, prevents fire, extinguishes fire, and/or the like.

The new equipment or method for addressing the failure mode wherein said solutions, components, materials or chemicals, may achieve: non-flammable smoke can be generated during cell thermal runaway resulting in smoke only; cell reaction strength is reduced by dropping Tmax for the reaction, and thermal—propagation can be prevented.

New or improved separators (or SSE) can be coated, treated, or manufactured to have iodine (I) or lithium iodide (LiI) at the surface adjacent at least one electrode or adjacent both electrodes, such as vapor deposition can be used to put iodine on Li Iodine on at least one separator surface adjacent the anode, such may be especially helpful with Li metal anodes, Li alloy anodes, Li sulfur anodes, or graphite anodes, the Iodine can react with lithium to form LiI layer or SEI to protect the SSE, or electrolyte, from the anode (especially at μA higher than stability), and/or such layers, thin films or coatings can be used adjacent the cathode, such as by using these proprietary layers or treatments, can avoid generation of flammable gasses (or at least combustible levels of such gases), heat, fires, and/or the like, and many EDV and ESS fires may be prevented and safe EDVs and ESSs may be possible.

New or improved separators (or SSE) can be coated, treated, or manufactured to have iodine (I), lithium iodide (LiI), Li halide, Li oxide, LiOxF, silver iodide, LiMgOx, LiMgOxF, AgILiMgO4S+, solid state electrolyte materials or particles, or other ceramic coating or thin film adjacent the cathode and/or the anode, such as vapor deposition can be used to put the coating, treatment, or thin film on the separator or SSE surface.

New or improved equipment, materials or chemicals can be used in many locations, in suppression systems, and/or the like, such as in a battery pack a layer of Si oxide, silica gel, water+fumed silica, fumed silica coatings, water+alumina, alumina coatings, Al gel, dispersible materials or ceramics (with or without water, polymers, or binders), nitrogen producing materials, CO₂ producing materials, heat absorbing materials, and/or the like can be placed below the cells or batteries, over the cells or batteries, and/or around the cells or batteries for spark suppression, to absorb or reduce heat and/or energy, to dry out the gel, to evaporate water, to coat or encapsulate problem areas, cells, batteries, to dilute flammable gases (hydrogen) with particles, CO₂, or nitrogen, to isolate the cells or batteries from O₂, to reduce, delay or eliminate fires or explosions, and/or combinations thereof.

In accordance with at least selected embodiments, objects, and/or aspects of the present invention, there is provided new or improved separators (or SSE) coated, treated, or manufactured to have iodine (I), lithium iodide (LiI), Li halide, Li oxide, LiOxF, silver iodide, LiMgOx, LiMgOxF, AgILiMgO4S+, solid state electrolyte materials or particles, or other ceramic coating or thin film adjacent the cathode and/or the anode, such as vapor deposition can be used to put the coating, treatment, or thin film on the separator or SSE surface.

In accordance with at least selected embodiments, objects, and/or aspects of the present invention, there is provided improved batteries, cells, anodes, separators, fire prevention and/or fire suppression systems, chemicals, and/or the like as shown and/or described herein; improved lithium ion batteries, cells, electrodes, separators, and/or similar batteries incorporating the same, and/or safer batteries, anodes, separators, fire prevention and/or fire suppression systems, chemicals, and/or the like as shown and/or described herein; and/or novel lithium ion batteries, cells, electrodes, separators, and/or similar batteries incorporating the same as shown, claimed, and/or described herein.

In accordance with at least selected embodiments, objects, and/or aspects of the present invention, there is provided improved equipment, materials or chemicals in or as fire prevention and/or fire suppression systems, and/or the like, including without limitation improved equipment, materials or chemicals in or as fire prevention and/or fire suppression systems such as in a battery pack a layer of Si oxide, silica gel, water+fumed silica, fumed silica coatings, water+alumina, alumina coatings, Al gel, dispersible materials or ceramics (with or without water, polymers, or binders), nitrogen producing materials, CO₂ producing materials, heat absorbing materials, and/or the like located below the cells or batteries, over the cells or batteries, and/or around the cells or batteries for spark suppression, to absorb or reduce heat and/or energy, to dry out the gel, to evaporate water, to coat or encapsulate problem areas, cells, batteries, to dilute flammable gases (hydrogen) with particles, CO₂, or nitrogen, to isolate the cells or batteries from O₂, to reduce, delay or eliminate fires or explosions, and/or combinations thereof as shown, claimed, or described herein.

What is claimed is:

1. New or improved equipment or methods as provided, described or shown, for addressing the failure mode that
thermal runaway cell emits flammable smoke; or
igniting the flammable smoke causes an EDV fire;
and providing new or proprietary solutions, components, materials or chemicals, to achieve the following:
non-flammable smoke can be generated during cell thermal runaway resulting in smoke only;
cell reaction strength is reduced by dropping Tmax for the reaction, and/or thermal-propagation can be prevented;
whereby many EDV and ESS fires may be prevented and safe EDVs and ESSs may be possible.

2. The new equipment or method for addressing the failure mode of claim 1 wherein said solutions, components, materials or chemicals can be used in many locations, in suppression systems, or both.

3. The new equipment or method for addressing the failure mode of claim 2 wherein said solutions, components, materials or chemicals, may comprise:
water+fumed silica, fumed silica coatings, water+alumina, alumina coatings, dispersible materials or ceramics (with or without water, polymers, binders, etc.) to absorb or reduce heat and/or energy or to coat or encapsulate problem areas, cells or batteries, to dilute flammable gases, (hydrogen) with particles, CO₂, or nitrogen, to limit unstable reduction at the anode or to reduce, delay or eliminate fires, and/or combinations thereof.

4. The new equipment or method for addressing the failure mode of claim 1 wherein said solutions, components, materials or chemicals can be used in many locations, in batteries, on batteries, in battery packs (above, below or around the cells), in suppression or extinguishing systems, devices, or components, to prevent or suppress EDV or ESS lithium battery or lithium ion battery fires and/or explosions, pack design for spark suppression, flammable gas dilution, hot gas heat removal or dissipation, and/or combinations thereof.

5. The new equipment or method for addressing the failure mode of claim 4 wherein said solutions, components, materials or chemicals, may comprise:
a lithium battery fire extinguisher or suppression system and may include an aqueous composition or solution of water+fumed silica, fumed silica coatings, water+alumina solution, alumina coatings, dispersible materials or ceramics (with or without water, polymers, or binders) to absorb or reduce heat and/or energy, to coat or encapsulate problem areas, cells, or batteries, to dilute flammable gases (such as hydrogen containing gases produced by unstable reduction at the anode) with particles, CO₂, or nitrogen, to avoid combustion, to reduce, delay or eliminate fires, to extinguish or suppress fires, to avoid explosions, and/or combinations thereof.

6. The new equipment or method for addressing the failure mode of claim 1 wherein said solutions, components, materials or chemicals, may comprise:
an improved fire extinguisher or fire suppression system is filled with a gel, mixture or solution under pressure, such as a fumed silica, water, and CO₂ solution, mixture or gel. When sprayed on a hot, smoking, or sparking area, or on a fire area on batteries, cells, device, or vehicle, the silica gel covers the problem area, isolates it from O₂, reduces the heat, dilutes the flammable gas, prevents fire, extinguishes fire, and/or the like.

7. The new equipment or method for addressing the failure mode of claim 1 wherein said solutions, components, materials or chemicals, may achieve:
non-flammable smoke can be generated during cell thermal runaway resulting in smoke only;
cell reaction strength is reduced by dropping Tmax for the reaction, and/or thermal-propagation can be prevented.

8. New or improved separators (or SSE) can be coated, treated, or manufactured to have Iodine (I) or Lithium Iodide (LiI) at the surface adjacent at least one electrode or adjacent both electrodes, such as vapor deposition can be used to put Iodine on Li Iodine on at least one separator surface adjacent the Anode, such may be especially helpful with Li Metal Anodes, Li Alloy Anodes, Li Sulfur Anodes, or Graphite Anodes, the Iodine can react with Lithium to form LiI layer or SEI to protect the SSE, or electrolyte, from the Anode (especially at μA higher than stability), and/or such layers, thin films or coatings can be used adjacent the Cathode, such as by using these proprietary layers or treatments, can avoid generation of flammable gasses (or at least combustible levels of such gases), heat, fires, and/or the like, and many EDV and ESS fires may be prevented and safe EDVs and ESSs may be possible.

9. New or improved Separators (or SSE) can be coated, treated, or manufactured to have Iodine (I), Lithium Iodide (LiI), Li Halide, Li Oxide, LiOxF, Silver Iodide, LiMgOx, LiMgOxF, AgILiMgO4S+, solid state electrolyte materials or particles, or other ceramic coating or thin film adjacent the Cathode and/or the Anode, such as vapor deposition can be used to put the coating, treatment, or thin film on the separator or SSE surface.

10. New or improved equipment, materials or chemicals can be used in many locations, in suppression systems, and/or the like, such as in a battery pack a layer of Si Oxide, Silica gel, water+fumed silica, fumed silica coatings, water+alumina, alumina coatings, Al gel, dispersible materials or ceramics (with or without water, polymers, or binders), nitrogen producing materials, CO₂ producing materials, heat absorbing materials, and/or the like can be placed below the cells or batteries, over the cells or batteries, and/or around the cells or batteries for spark suppression, to absorb or reduce heat and/or energy, to dry out the gel, to evaporate water, to coat or encapsulate problem areas, cells, batteries, to dilute flammable gases (hydrogen) with particles, CO₂, or nitrogen, to isolate the cells or batteries from O₂ to reduce, delay or eliminate fires or explosions, and/or combinations thereof.

11. Novel or improved batteries, anodes, separators, solutions on li-ion battery fires, and/or fire suppression systems, chemicals and the like; in addition, exemplary embodiments disclosed herein are directed to novel or improved lithium ion batteries, cells, electrodes, separators, and/or similar batteries incorporating the same, and/or related methods of manufacturing and/or of using the same, and/or combinations thereof; improvements or solutions as shown and/or described herein.

12. New or improved equipment or methods as provided, described or shown, for addressing the failure mode that
thermal runaway cell emits flammable smoke
igniting the flammable smoke causes an EDV fire
and providing new or proprietary solutions, components, materials or chemicals, to achieve the following:
non-flammable smoke can be generated during cell thermal runaway resulting in smoke only,
cell reaction strength is reduced by dropping Tmax for the reaction, and/or thermal-propagation can be prevented,
whereby many EDV and ESS fires may be prevented and safe EDVs and ESSs may be possible.

13. The new equipment or method for addressing the failure mode of claim 12 wherein said solutions, components, materials or chemicals can be used in many locations, in suppression systems, or both.

14. The new equipment or method for addressing the failure mode of claim 13 wherein said solutions, components, materials or chemicals, may comprise:water+fumed silica, fumed silica coatings, water+alumina, alumina coatings, dispersible materials or ceramics (with or without water, polymers, binders, etc.) to absorb or reduce heat and/or energy, to coat or encapsulate problem areas, cells or batteries, to dilute flammable gases (hydrogen) with particles, CO₂, or nitrogen, to limit unstable reduction at the anode, to reduce, delay or eliminate fires, and/or combinations thereof.

15. The new equipment or method for addressing the failure mode of claim 12 wherein said solutions, components, materials or chemicals can be used in many locations, in batteries, on batteries, in battery packs (above, below or around the cells), in suppression or extinguishing systems, devices, or components, to prevent or suppress EDV or ESS lithium battery or lithium ion battery fires and/or explosions, pack design for spark suppression, flammable gas dilution, hot gas heat removal or dissipation, and/or combinations thereof.

16. The new equipment or method for addressing the failure mode of claim 15 wherein said solutions, components, materials or chemicals, may comprise:
a lithium battery fire extinguisher or suppression system and may include an aqueous composition or solution of water+fumed silica, fumed silica coatings, water+alumina solution, alumina coatings, dispersible materials or ceramics (with or without water, polymers, or binders) to absorb or reduce heat and/or energy, to coat or encapsulate problem areas, cells, or batteries, to dilute flammable gases (such as hydrogen containing gases produced by unstable reduction at the anode) with particles, CO₂, or nitrogen, to avoid combustion, to reduce, delay or eliminate fires, to extinguish or suppress fires, to avoid explosions, and/or combinations thereof.

17. The new equipment or method for addressing the failure mode of claim 12 wherein said solutions, components, materials or chemicals, may comprise:
an improved fire extinguisher or fire suppression system is filled with a gel, mixture or solution under pressure, such as a fumed silica, water, and CO₂ solution, mixture or gel. When sprayed on a hot, smoking, or sparking area, or on a fire area on batteries, cells, device, or vehicle, the silica gel covers the problem area, isolates it from O₂, reduces the heat, dilutes the flammable gas, prevents fire, extinguishes fire, and/or the like.

18. The new equipment or method for addressing the failure mode of claim 12 wherein said solutions, components, materials or chemicals, may achieve:
non-flammable smoke can be generated during cell thermal runaway resulting in smoke only; cell reaction strength is reduced by dropping Tmax for the reaction, and thermal-propagation can be prevented.

19. New or improved separators (or SSE) can be coated, treated, or manufactured to have iodine (I) or lithium iodide (LiI) at the surface adjacent at least one electrode or adjacent both electrodes, such as vapor deposition can be used to put iodine on Li Iodine on at least one separator surface adjacent the anode, such may be especially helpful with Li metal anodes, Li alloy anodes, Li sulfur anodes, or graphite anodes, the Iodine can react with lithium to form LiI layer or SEI to protect the SSE, or electrolyte, from the anode (especially at μA higher than stability), and/or such layers, thin films or coatings can be used adjacent the cathode, such as by using these proprietary layers or treatments, can avoid generation of flammable gasses (or at least combustible levels of such gases), heat, fires, and/or the like, and many EDV and ESS fires may be prevented and safe EDVs and ESSs may be possible.

20. New or improved separators (or SSE) can be coated, treated, or manufactured to have iodine (I), lithium iodide (LiI), Li halide, Li oxide, LiOxF, silver iodide, LiMgOx, LiMgOxF, AgILiMgO4S+, solid state electrolyte materials or particles, or other ceramic coating or thin film adjacent the cathode and/or the anode, such as vapor deposition can be used to put the coating, treatment, or thin film on the separator or SSE surface.

21. New or improved equipment, materials or chemicals can be used in many locations, in suppression systems, and/or the like, such as in a battery pack a layer of Si oxide, silica gel, water+fumed silica, fumed silica coatings, water+alumina, alumina coatings, Al gel, dispersible materials or ceramics (with or without water, polymers, or binders), nitrogen producing materials, CO₂ producing materials, heat absorbing materials, and/or the like can be placed below the cells or batteries, over the cells or batteries, and/or around the cells or batteries for spark suppression, to absorb or reduce heat and/or energy, to dry out the gel, to evaporate water, to coat or encapsulate problem areas, cells, batteries, to dilute flammable gases (hydrogen) with particles, CO₂, or nitrogen, to isolate the cells or batteries from O₂, to reduce, delay or eliminate fires or explosions, and/or combinations thereof.

22. Improved batteries, cells, anodes, separators, fire prevention and/or fire suppression systems, chemicals, and/or the like as shown and/or described herein; improved lithium ion batteries, cells, electrodes, separators, and/or similar batteries incorporating the same, and/or safer batteries, anodes, separators, fire prevention and/or fire suppression systems, chemicals, and/or the like as shown and/or described herein; and/or novel lithium ion batteries, cells, electrodes, separators, and/or similar batteries incorporating the same as shown, claimed, and/or described herein.

23. Improved equipment, materials or chemicals in or as fire prevention and/or fire suppression systems, and/or the like, including without limitation improved equipment, materials or chemicals in or as fire prevention and/or fire suppression systems such as in a battery pack a layer of Si oxide, silica gel, water+fumed silica, fumed silica coatings, water+alumina, alumina coatings, Al gel, dispersible materials or ceramics (with or without water, polymers, or binders), nitrogen producing materials, CO₂ producing materials, heat absorbing materials, and/or the like located below the cells or batteries, over the cells or batteries, and/or around the cells or batteries for spark suppression, to absorb or reduce heat and/or energy, to dry out the gel, to evaporate water, to coat or encapsulate problem areas, cells, batteries, to dilute flammable gases (hydrogen) with particles, CO₂, or nitrogen, to isolate the cells or batteries from O₂, to reduce, delay or eliminate fires or explosions, and/or combinations thereof as shown, claimed, or described herein.
